(19) United States
(12) Patent Application Publication
(10) Pub. No.: US 2013/0199724 A1
(43) Pub. Date: Aug. 8, 2013

(54) CURATIVES FOR EPOXY COMPOSITIONS

(71) Applicant: Designer Molecules, Inc., San Diego, CA (US)

(72) Inventor: Stephen M. Dershem, San Diego, CA (US)

(73) Assignee: Designer Molecules, Inc., San Diego, CA (US)

(21) Appl. No.: 13/840,611

(22) Filed: Mar. 15, 2013

Related U.S. Application Data
(63) Continuation-in-part of application No. 12/595,505, filed on Oct. 9, 2009.
Application No. 12/595,505 is a continuation of application No. 12/815,896, filed on Jun. 15, 2010, now Pat. No. 8,431,655.
Application No. 12/815,896 is a continuation-in-part of application No. 13/794,784, filed on Mar. 11, 2013.

(51) Int. Cl. C08G 59/44; C08G 59/42; C08G 59/40; C08G 59/14

(52) U.S. Cl. CPC C08G 59/44; C08G 59/1477; C08G 59/4223; C08G 59/4042; C08G 59/423
USPC 156/330; 525/523; 525/472; 525/529; 525/512; 525/327.3; 523/400; 523/468; 523/466; 556/419; 560/193; 560/194; 548/461; 548/520; 556/440

(57) ABSTRACT

The invention provides epoxy and oxetane compositions including the novel acyloxy and N-acyl curing agents described herein. Use of invention curing agents result in cured adhesive compositions with remarkably increased adhesion and reduced hydrophilicity when compared to resins cured with other types of curing agents. Furthermore, the curatives of this invention do not interfere with free-radical cure and are thus suited for use in hybrid cure thermoset compositions.

### CROSS REFERENCE TO RELATED APPLICATIONS

This application is a Continuation-in-Part under 35 USC §120 of U.S. patent application Ser. No. 13/794,784, filed Mar. 14, 2011, which claims the benefit of priority under 35 USC §119(e) of U.S. Provisional Application Ser. No. 61/186,894, filed, Jun. 15, 2009, and is a Continuation-in-Part of U.S. patent application Ser. No. 12/595,505, filed Oct. 9, 2009, which is in turn a U.S. National Phase under 35 U.S.C. §371 of PCT/US08/59804, filed Apr. 9, 2008, which in turn claims the benefit of priority to U.S. Provisional Application Ser. Nos. 60/922,412, filed Apr. 9, 2007 and 60/835,684, filed Aug. 4, 2006 the entire disclosures of which are incorporated herein by reference.

### FIELD OF THE INVENTION

The present invention relates to thermosetting and thermoplastic compositions, methods of preparation and uses therefor. In particular, the present invention relates to thermosetting and thermoplastic compounds and compositions containing epoxy and oxetane resins, and acetoxy, acyloxy, and N-acyl curatives therefor.

### BACKGROUND

The properties of cured epoxy resins are often influenced by the curing agent that is added to the formulation. Accordingly, much research effort has been directed towards developing curing agents that can enhance the properties of the cured resin. Phenols, anhydrides, thiols and amines have generally been used as curing agents in epoxy resins. While useful, these curing agents are not without certain drawbacks. Thus, a continuing need exists for new epoxy curing agents.

### SUMMARY OF THE INVENTION

The present invention provides curative compounds that impart outstanding properties for epoxy and oxetane cure. More specifically, acetoxy, acyloxy, and N-acyl curatives are described, as well as epoxy and oxetane resin compositions that include these curatives. The resulting thermosets can have reduced hydrophilicity, decreased viscosity, increased thermal resistance, and increased hydrolytic stability. In contrast to phenolic curatives, the acetoxy, acyloxy, and N-acyl curatives described herein do not substantially interfere with free-radical cure chemistry. This feature expands opportunities for hybrid cures, i.e. those that combine ring opening addition cures of epoxies and/or oxetanes with any of the free-radically curable monomers.

When an N-acyl compound of the invention is used as a curative, an N-acylated imide co-cure with an epoxy resins resulting in polyimides, which are considered to be one of the highest performance resins with respect to thermal resistance. Certain compounds of this invention, therefore, provide a means of converting epoxy monomers into polyimide resins.

One desirable feature of the N-acyl curatives described herein that is their high level of reactivity. They can, for example, be used to cure aliphatic and cycloaliphatic epoxies. Anhydrides have previously been the only class of curatives available for the aliphatic and cycloaliphatic epoxies. The N-acyl compounds of this invention can be used to provide thermosets and thermoplastics with superior hydrolytic and thermal resistance compared to adhesives, coatings, encapsulants, or matrix resins that utilize anhydride curatives. Furthermore, the N-acyl curatives of this invention, unlike anhydrides, do not react with moisture at room temperature. This can be an important consideration for shelf-life and product performance in humid environments.

The compounds of the invention are useful for single lay-up, two stage cures. In certain of these embodiments, a di-functional epoxy or oxetane monomer may be cured with a di-functional acyloxy compound to form a thermoplastic intermediate. The initially formed polymer may then be cross-linked to a final thermoset in a second step. This chemistry is, therefore, the ideal platform for b-stageable adhesives.

The compounds of the invention are also useful in a variety of other applications. Invention compounds can be used in automotive, marine, and aerospace coatings and adhesives. The properties of certain invention compounds make these compounds suitable for use in dental matrix resins and adhesives. Invention compounds can also be used as components of matrix resins and composites used in sports equipment, automotive bodies, and boat construction, such as those incorporating carbon fiber and/or fiberglass reinforcements. The compounds of the present invention also have attractive properties for use in adhesives for diverse industrial applications, such as thread-lock materials and building materials. They are also well suited for use in electronic mold compounds and underfill.

In general, epoxies are known for their excellent adhesion, chemical and heat resistance, good to excellent mechanical properties and very good electrical insulating properties, but many of these properties can be modified. For example, although epoxies are typically electrically insulating, epoxies filled with silver or other metals can be electrically conductive.

The curatives of this invention can be used, for example, with aliphatic, cycloaliphatic, glycidyl ether, glycidyl ester, and glycidyl amine epoxies, as well as with combinations thereof. Furthermore, these compounds may be used as curatives for oxetane monomers. In many instances the compounds of this invention may be used as the sole curatives for epoxy or oxetane monomers. The curatives of this invention, for example, do not interfere with free radical co-cures and are therefore are useful as the sole curatives in hybrid cure systems that also contain free radical monomers. However, for epoxy- or oxetane-based resin compositions that do not contain free radical monomers it may be desirable to combine the compounds of this invention with other curatives, such as phenols, anhydrides, thiols, etc.

The curatives of this invention may be either liquids or solids. It is desirable, however, for many applications that they are in liquid form, or at least completely soluble in other reactive components in the formulation. Lower melting compounds are generally more compatible with other formulation components. Epoxy curatives that either liquid at room temperature or low melting are, therefore, desirable. It has been found that mixed acyloxy functionality can be used advantageously to depress the melting points of these curatives. The use of more than one acyloxy functional group in the synthesis of phenyl ester curatives results in a mixture of compounds. Thus, the reaction of a diphenol with one-half equivalent each of acetic anhydride and propionic anhydride would result in a 1:2:1 product distribution of the acetate-acetate:acetate-propionate:propionate:propionate ester compounds. This mixed phenyl ester product will have a lower melting point than could be obtained from the use of a single acylating agent. The benefit of this approach, however, is not limited to only diphenol starting materials or the combination that include just two acylating agents.

One category of acyloxy curatives of that are within the scope of this invention are those derived from diphenol-terminated, low molecular weight, polyphenylene ether resins. These diphenol compounds are noted for their relatively high glass transition temperatures, low solution viscosities, and solubility in a number of organic solvents and/or monomers. An example of this class of polymeric diphenol-terminated compound is a compound offered for sale by Sabic Corporation under the trade name Noryl SA90, shown below, which is marketed as an epoxy curative as the free phenol and is described in U.S. patent application Ser. No. 11/532,135 filed Sep. 15, 2006.

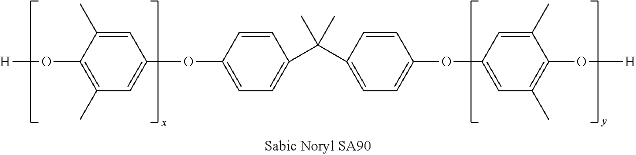

Such diphenol compounds may be converted to the corresponding diacyloxy curatives using either anhydride or acyl halide acylating agents. Thus, the acyloxy curatives of the following structure are contemplated as epoxy and/or oxetane curatives according to the instant invention:

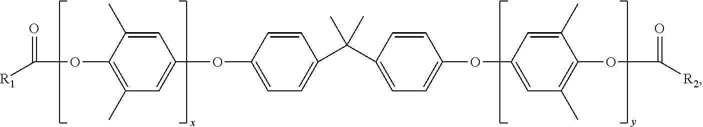

wherein each of R₁ and R₂ is independently a lower alkyl or a substituted or an unsubstituted aryl.

The conversion from free phenol to acyloxy versions of these polyphenylene ether compounds imparts lower viscosity, reduced moisture uptake, and compatibility with (i.e. they do not poison) hybrid cures that include free radical monomer chemistries.

It should be noted that one diacyloxy compound derived from the Noryl SA90 is already offered for sale by Sabic. This compound is the corresponding dimethacrylate and is offered under the trade name Noryl SA9000:

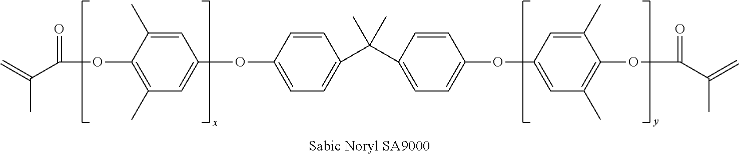

This class of materials is fully described in U.S. Ser. No. 11/532,135. The Noryl SA9000 is not offered for sale as an epoxy or oxetane monomer curative, although it may be used as such.

Another category of acyloxy curatives include those produced from commercially available telechelic polybutadiene oligomers. These compounds can be made by condensing the commercial diols with either 4-hydroxybenzoic acid via direct esterification or via transesterification using methyl 4-hydroxybenzoate, followed by conversion of the resulting diphenol ester to the corresponding phenyl ester via acylation. For example, the Poly Bd® R-45HTLO, available from Cray Valley, can be converted to the following phenyl ester curative:

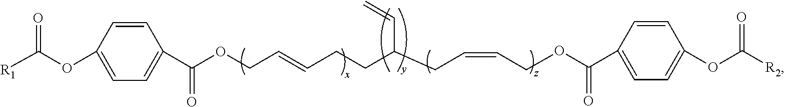

wherein the sum of x, y and z is equal to, or less than, about 130, and each of R₁ and R₂ is independently a lower alkyl or a substituted or an unsubstituted aryl. This kind of liquid phenyl ester curative is suited to create very low modulus, hydrophobic thermoplastic and/or thermoset products when cured with epoxy or oxetane monomers.

A related rubber type of acyloxy curative may be prepared from hydrogenated, dihydroxy-terminated polybutadiene products that are also available from Cray Valley. These dihydroxy-terminated, saturated hydrocarbon oligomers are offered under the trade names of Krasol HLBH P-2000 and P-3000. They can be converted to phenyl ester curatives according to the same method described above for the Poly Bd® R-45HTLO. The invention curative compounds thus formed approximately correspond to the following formula:

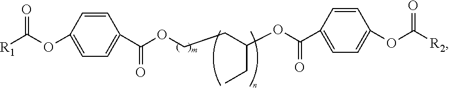

wherein the sum of m and n is equal to, or less than, about 300, and each of R1 and R2 is independently a lower alkyl or a substituted or an unsubstituted aryl.

Accordingly, the present invention provides curatives for epoxy or oxetane resins having the structure of Formula I or Formula II:

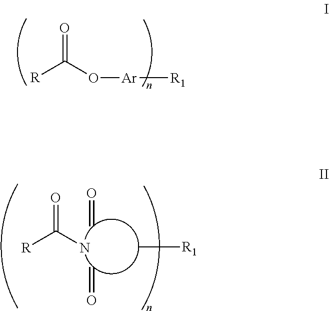

wherein each of R and R₁ is, independently, a substituted or an unsubstituted aliphatic, heteroaliphatic, aromatic, heteroaromatic, siloxane, acrylate, methacrylate, maleimido, cinnamyl moiety; Ar is a substituted or an unsubstituted aryl or heteroaryl having from 6 to about 20 carbon atoms; and n is an integer having the value between 1 and about 11. In certain embodiments, each of R and R₁ is, independently, a substituted or an unsubstituted alkyl, cycloalkyl, alkenyl, aryl, or heterocyclic moiety. In other embodiments, Ar is a substituted or an unsubstituted C₆ to about C₁₁ aryl or heteroaryl. In certain aspects of the invention, n is an integer having the value between 1 and about 11, for example, having the value between 2 and 11, between 3 and 11, between 4 and 11, or between 5 and 11. In certain other aspects of the invention, n is an integer having the value between 1 and about 6, for example, having the value between 2 and 6, between 3 and 6, between 4 and 6, or between 5 and 6. In certain embodiments, the curatives of the present invention are liquids at room temperature.

In some aspects of the invention each R and R₁ is the same. In other embodiments R₁ is different than at least on R. For example, R₁ can be different than the R at the terminus of the compound (terminal R group) or R₁ can be different than an internal R.

Some specific examples of curatives provided by the present invention include, but are not limited to, any of the following compounds:

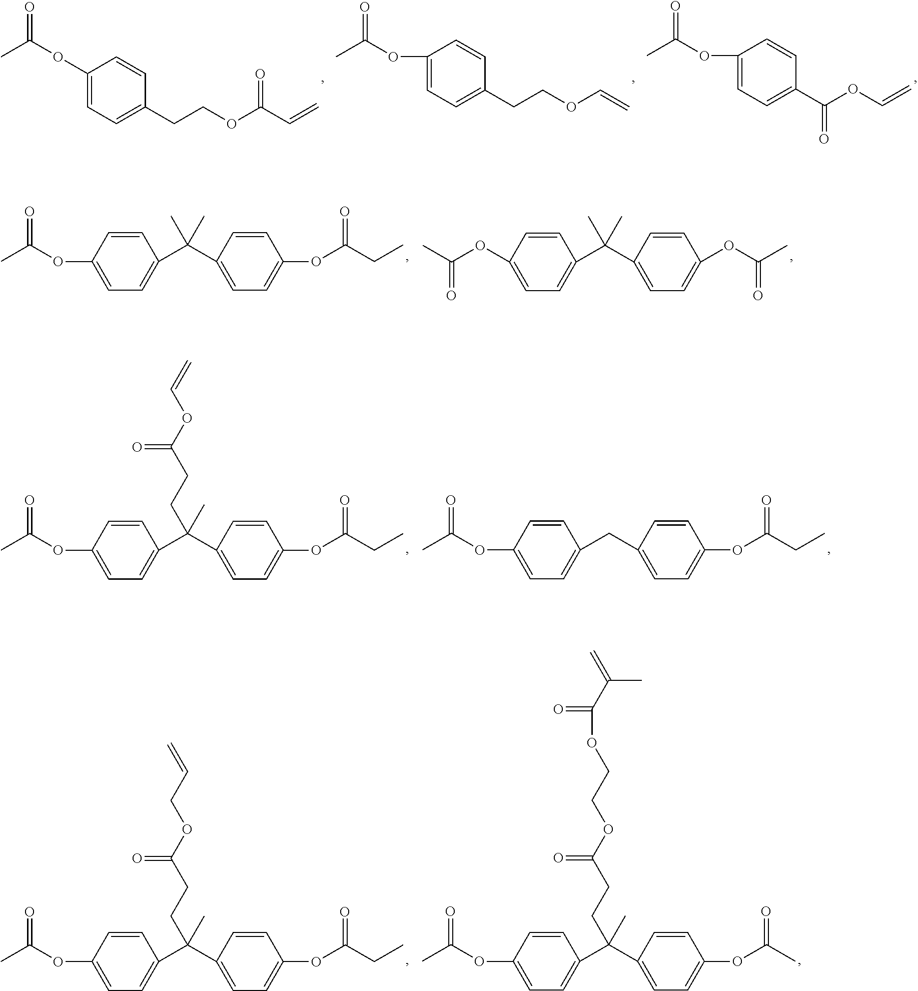

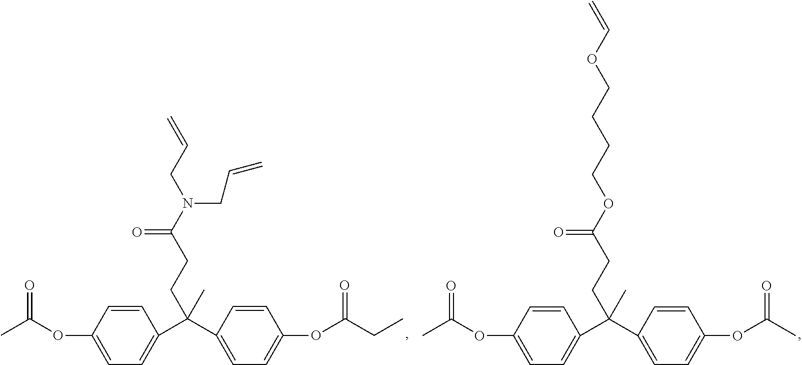

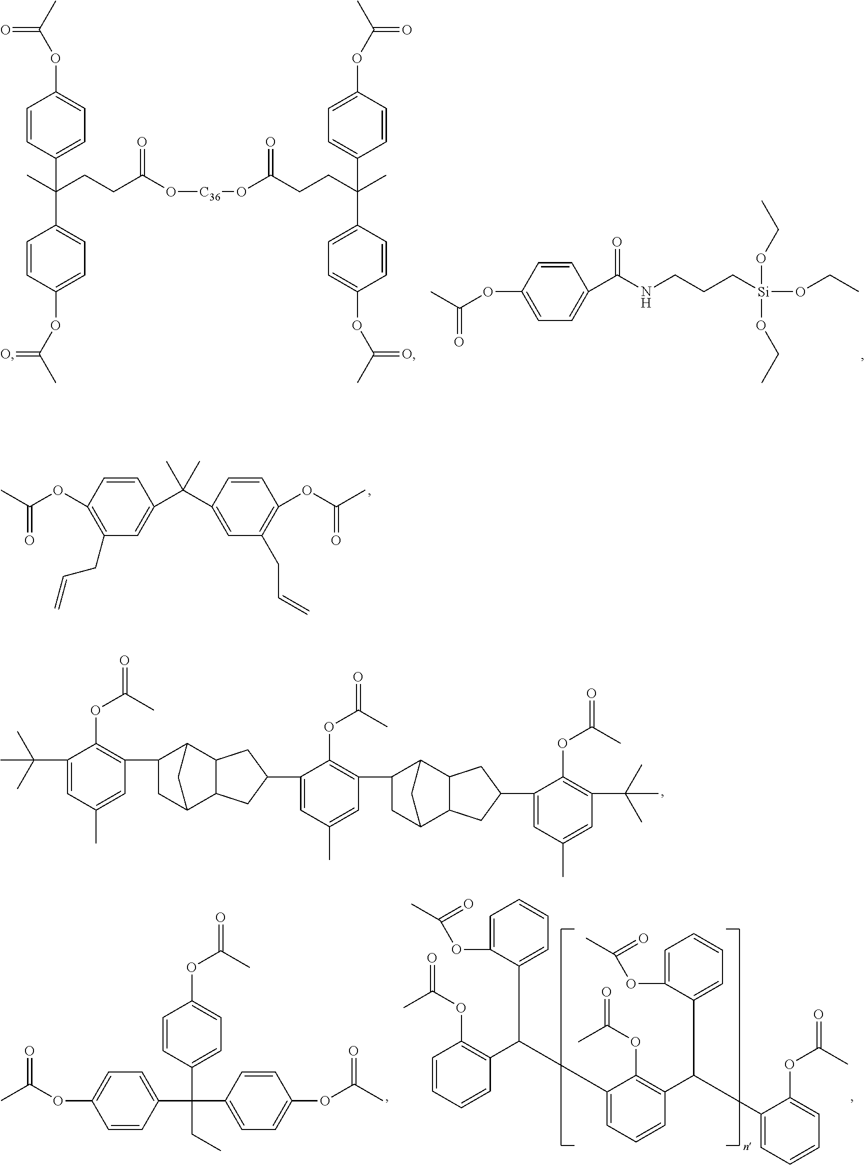

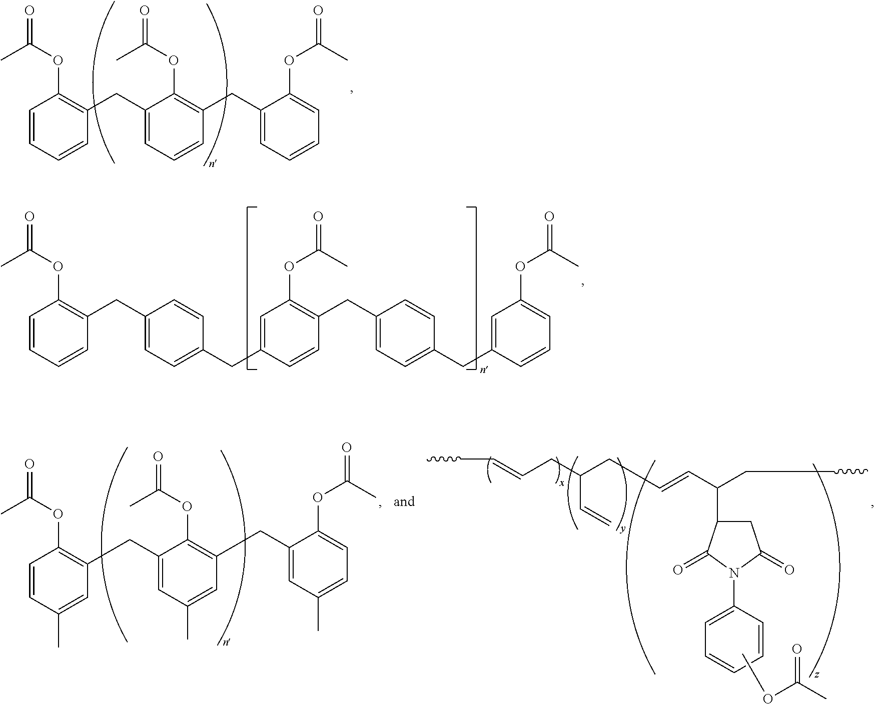

wherein each of n′, x, y and z is an integer, independently having the following values: n′ between 0 and 10, each of x and y between 4 and about 50, and z between 2 and about 40.

The present invention also provides poly-N-acyl curatives, including:

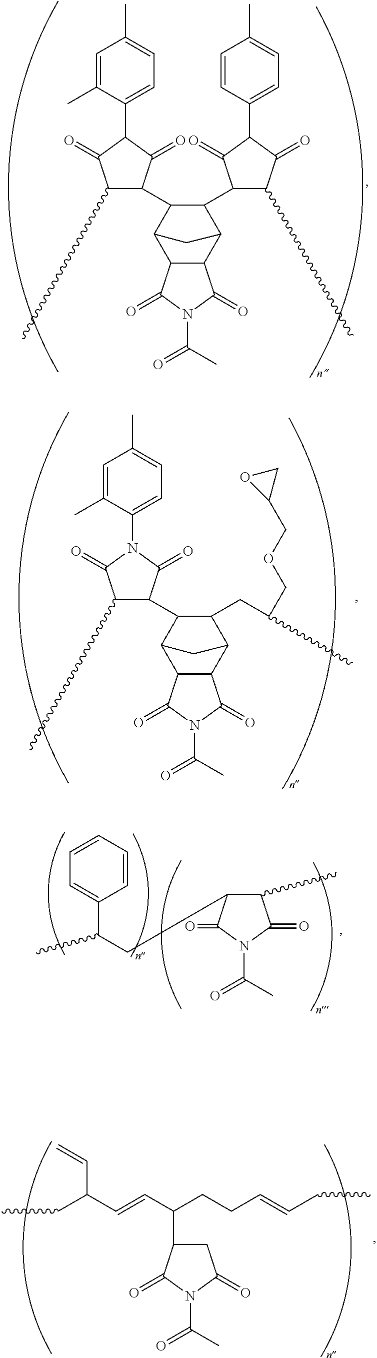

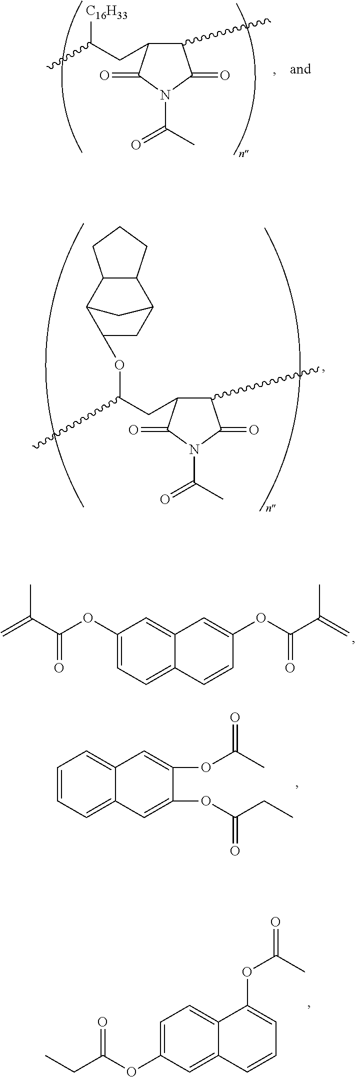

wherein each of n″ and n′″ is an integer independently having the value between 1 and about 10.

In addition, curatives according to the embodiments of the invention also include, but not limited to, the following compounds:

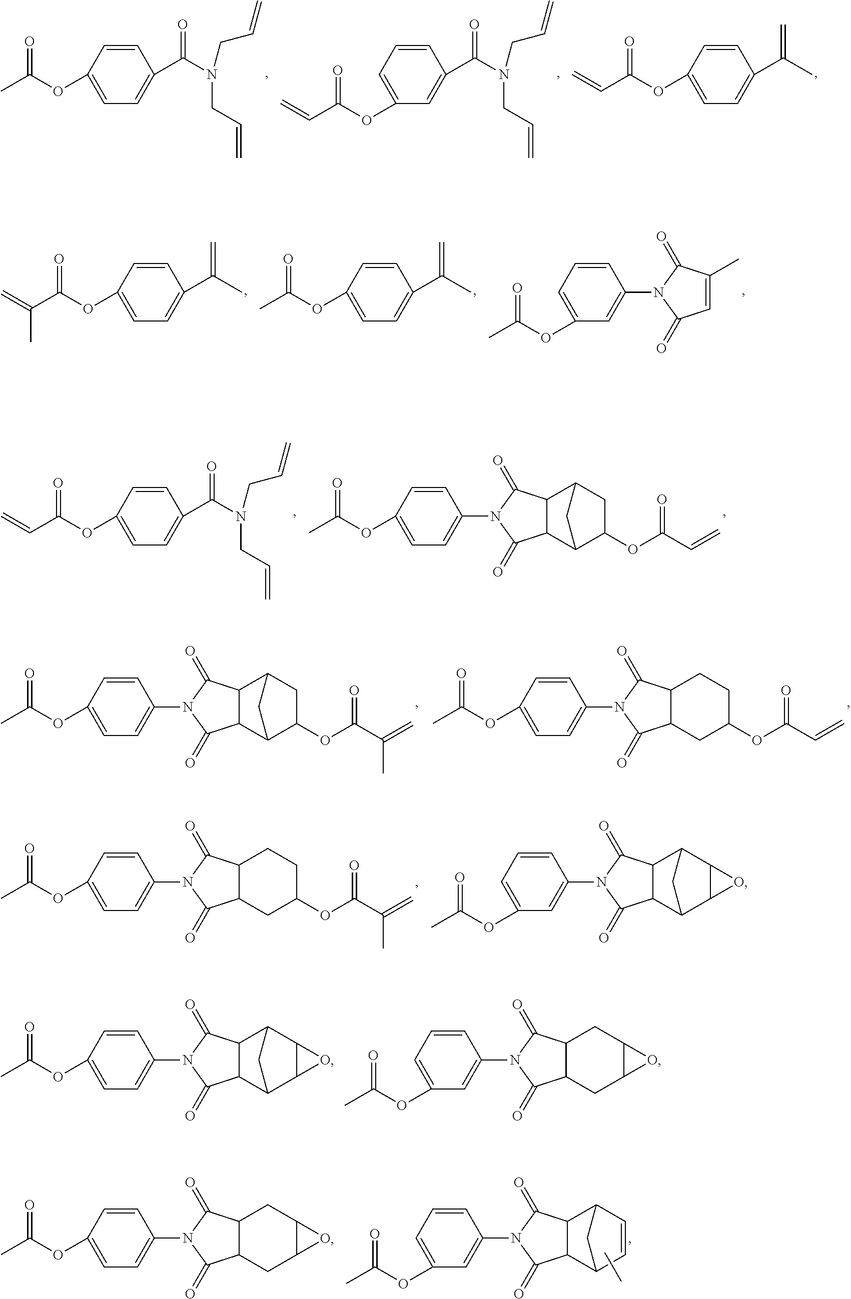

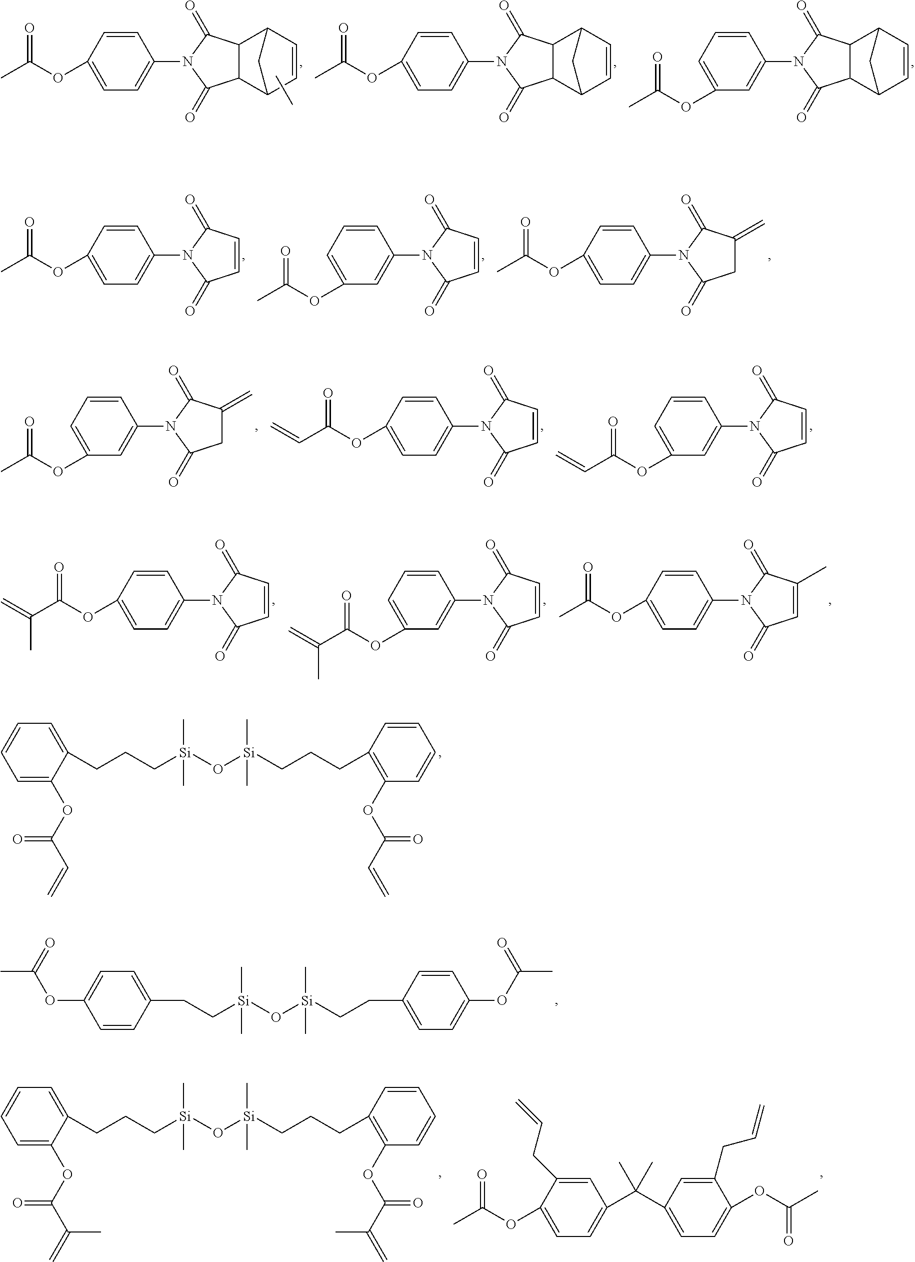

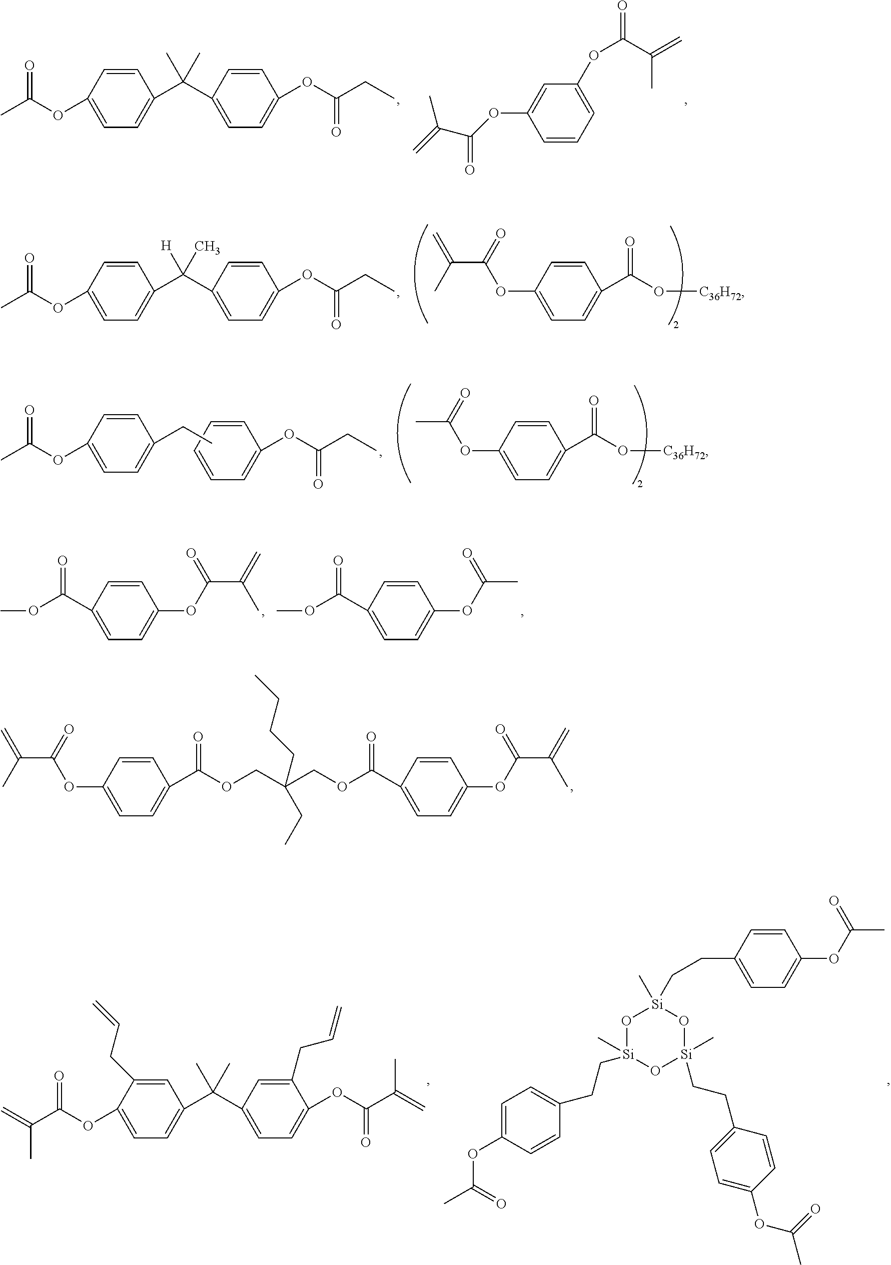

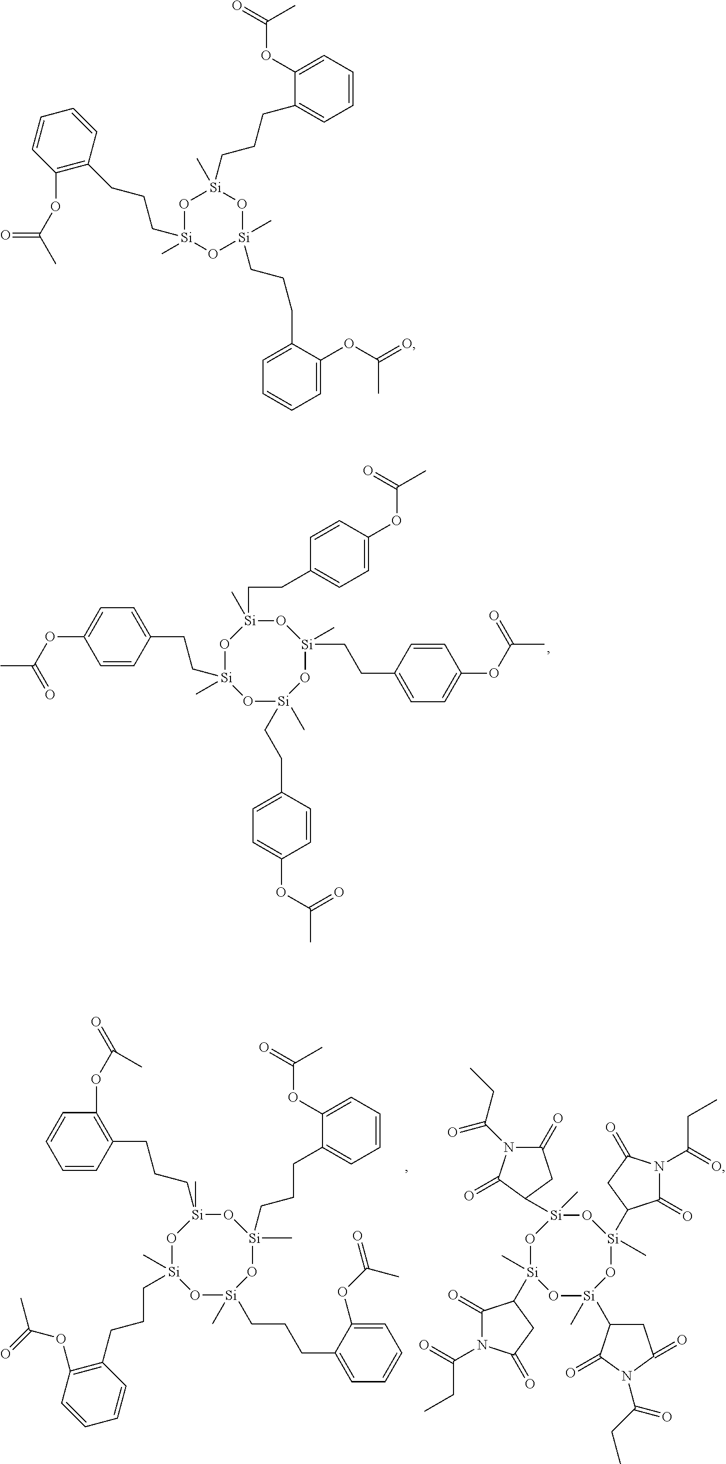

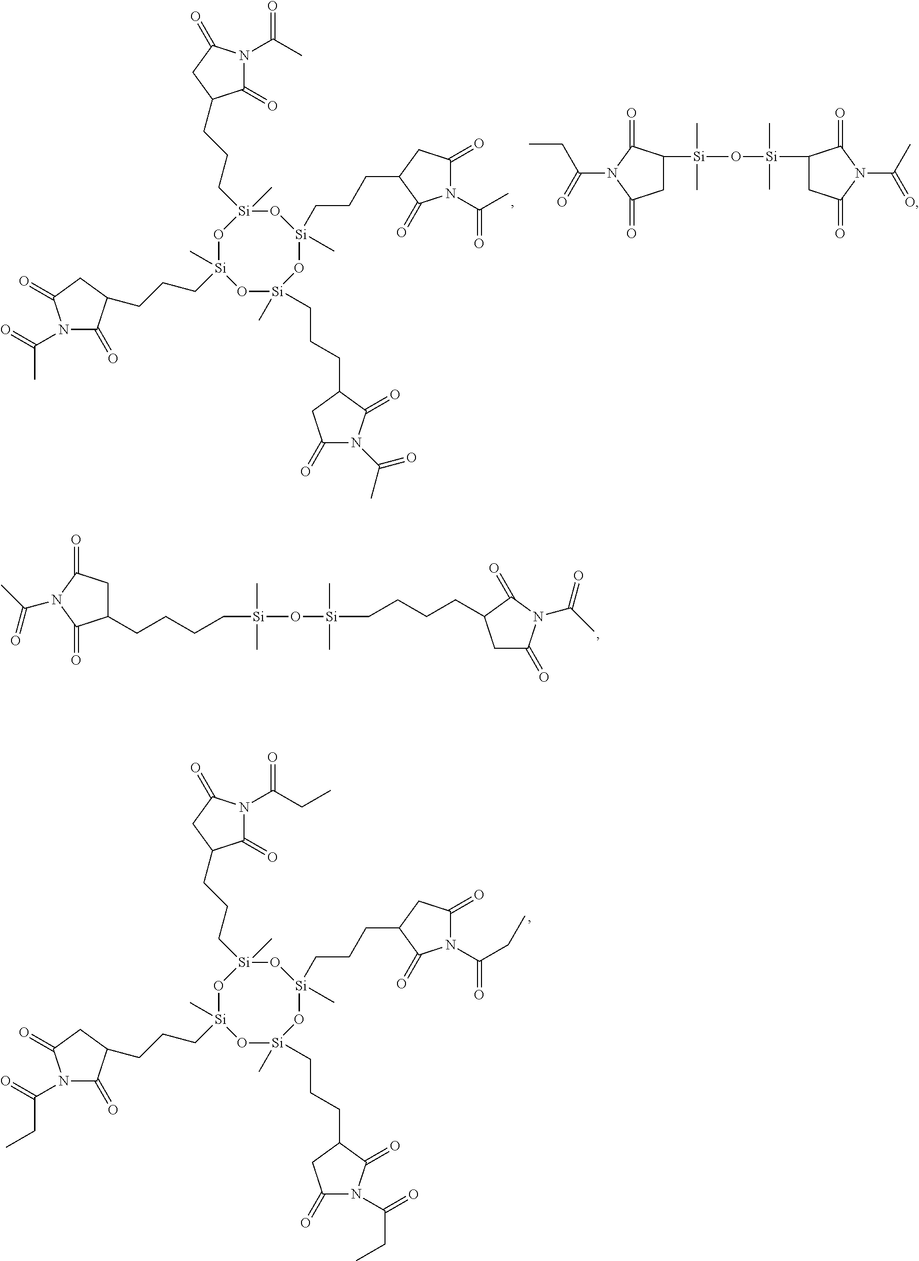 [SMILES: CC(=O)N1C(=O)CC(CCC[Si]2(C)O[Si](C)(CCCC3CC(=O)N(C(C)=O)C3=O)O[Si](C)(CCCC3CC(=O)N(C(C)=O)C3=O)O[Si](C)(CCCC3CC(=O)N(C(C)=O)C3=O)O2)C1=O ; CCC(=O)N1C(=O)CC([Si](C)(C)O[Si](C)(C)C2CC(=O)N(C(C)=O)C2=O)C1=O ; CC(=O)N1C(=O)CC(CCCC[Si](C)(C)O[Si](C)(C)CCCCC2CC(=O)N(C(C)=O)C2=O)C1=O ; CCC(=O)N1C(=O)CC(CCC[Si]2(C)O[Si](C)(CCCC3CC(=O)N(C(=O)CC)C3=O)O[Si](C)(CCCC3CC(=O)N(C(=O)CC)C3=O)O[Si](C)(CCCC3CC(=O)N(C(=O)CC)C3=O)O2)C1=O]

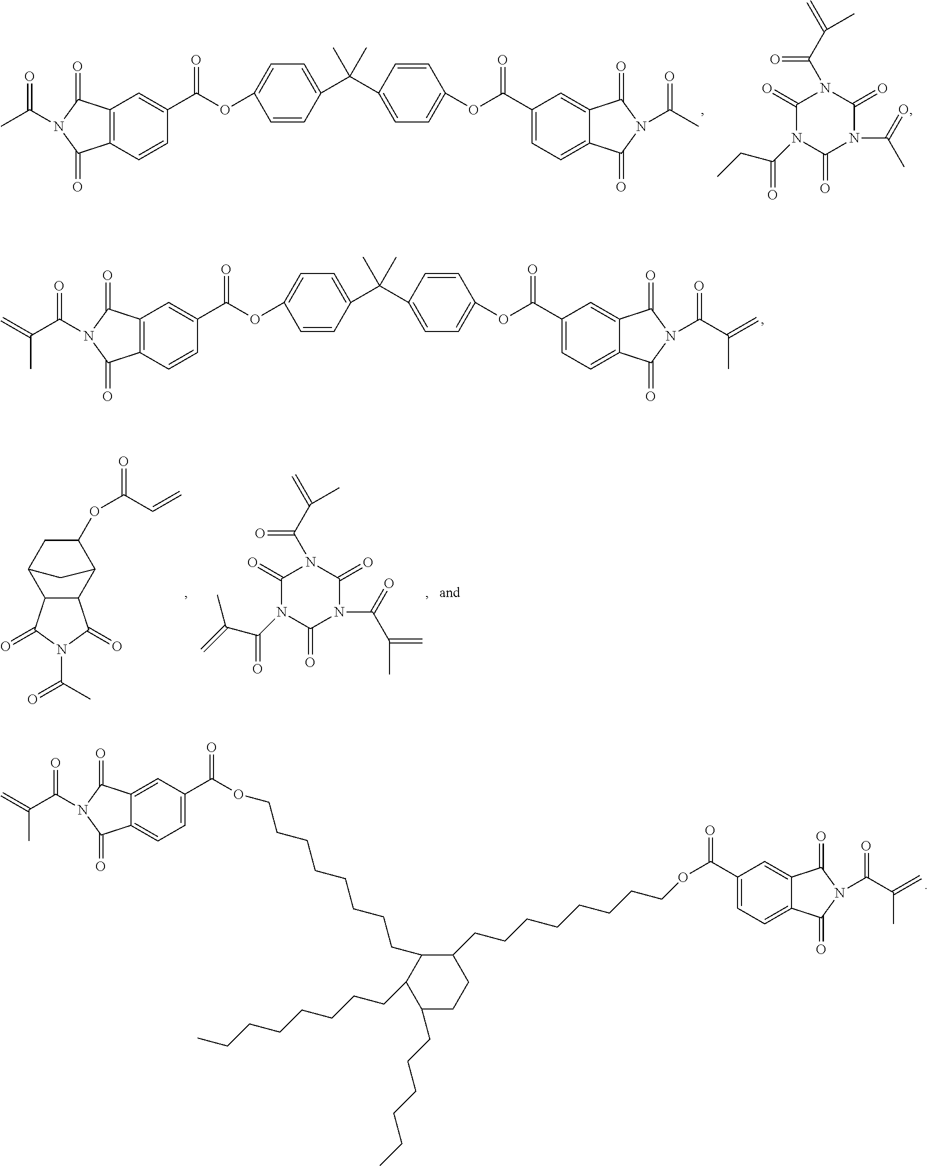

Additional curatives that can be used according to the embodiments of the invention also include, but not limited to, the following compounds:

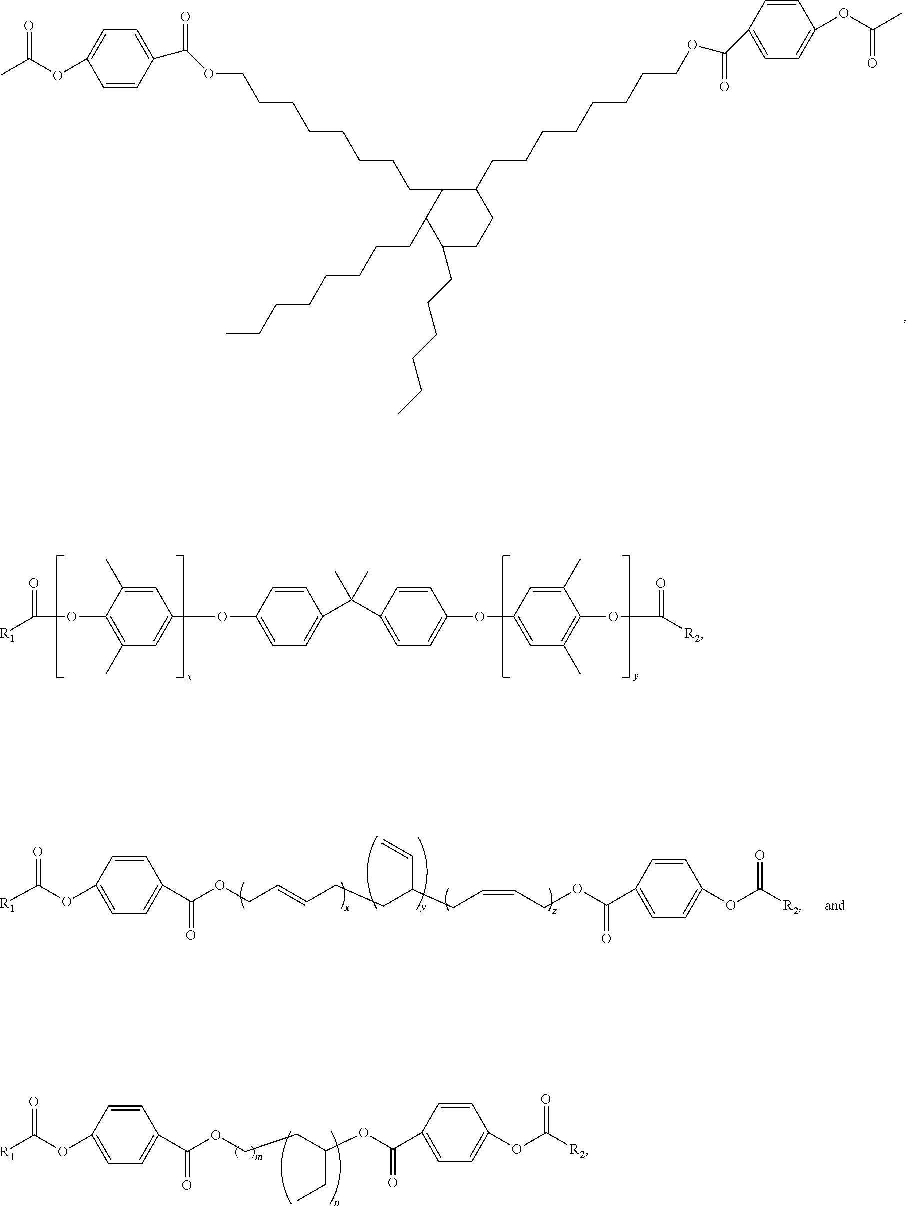

wherein the sum of x, y and z is equal to, or less than, about 130, the sum of m and n is equal to, or less than, about 300, and each of R₁ and R₂ is independently a lower alkyl or a substituted or an unsubstituted aryl.

In addition, any of the following “chain stopper” curatives can be used according to the embodiments of the invention:

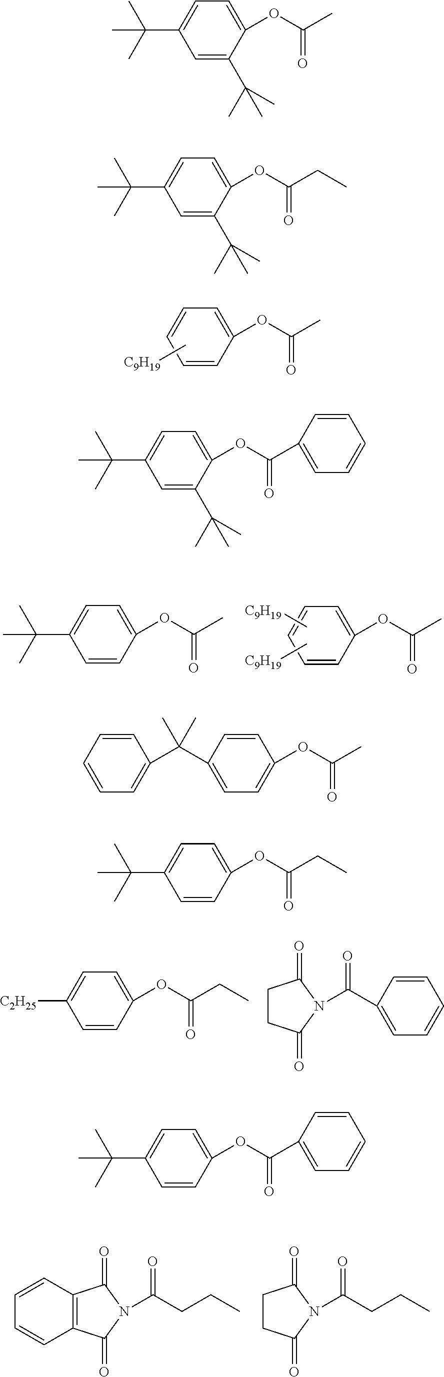

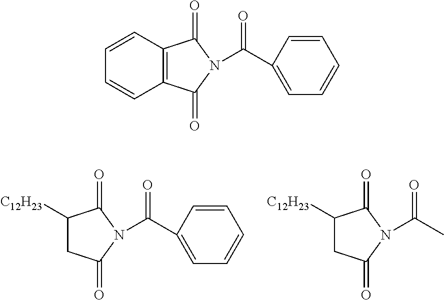

The present invention also provides compositions that include an epoxy or oxetane resin and one or more of the curatives described above. In certain embodiments, the epoxy includes at least one of a glycidyl ether epoxy, a cycloaliphatic epoxy, and an aliphatic epoxy. The glycidyl ether epoxy can be, for example, a glycidyl ether of a phenol, an amine, an alcohol, or an isocyanurate; a trisglycidyl ether of a phenolic compound; a glycidyl ether of a cresol formaldehyde condensate; a glycidyl ether of a phenol formaldehyde condensate; a glycidyl ether of a cresol dicyclopentadiene addition compound; a glycidyl ether of a phenol dicyclopentadiene addition compound; a glycidyl ether of a fused ring polyaromatic phenol; a diglycidyl ether; a glycidyl ether of an aliphatic alcohol; a glycidyl ether of a polyglycol; a glycidyl derivative of an aromatic amine; an ester linked epoxy; a phenyl glycidyl ether; a cresol glycidyl ether; a nonylphenyl glycidyl ether; a p-tert-butylphenyl glycidyl ether; a diglycidyl ether or a trisglycidyl ether of bisphenol A, bisphenol F, ethylidinebisphenol, dihydroxydiphenyl ether, N,N′-disalicylal-ethylenediamine, triglycidyl-p-aminophenol, N,N,N′,N′-tetraglycidyl-4,4′-diphenylmethane, triglycidyl isocyanurate, bis(4-hydroxyphenyl)sulfone, bis(hydroxyphenyl)sulfide, 1,1-bis(hydroxyphenyl)cyclohexane, 9,19-bis(4-hydroxyphenyl)fluorene, 1,1,1-tris(hydroxyphenyl)ethane, tetrakis(4-hydroxyphenyl)ethane, trihydroxytritylmethane, 4,4′-(1-alpha-methylbenzylidene)bisphenol, 4,4′-(1,3-componentthylethylene)diphenol, componentthylstilbesterol, 4,4′-dihyroxybenzophenone, resorcinol, catechol, or tetrahydroxydiphenyl sulfide; a glycidyl ether of a dihydroxy naphthalene, 2,2′-dihydroxy-6,6′-dinaphthyl disulfide, or 1,8,9-trihydroxyanthracene; a diglycidyl ether of 1,4 butanediol; a diglycidyl ether of diethylene glycol; a diglycidyl ether of neopentyl glycol; a diglycidyl ether of cyclohexane dimethanol; a diglycidyl ether of tricyclodecane dimethanol; a trimethyolethane triglycidyl ether; a glycidyl ether; a trimethyol propane triglycidyl ether; a glycidyl ether of Heloxy 84™; a glycidyl ether of Heloxy 32™; a polyglycidyl ether of castor oil; polyoxypropylene diglycidyl ether; Heloxy 71; and/or glycidyl methacrylate.

In certain embodiments, the cycloaliphatic epoxy ether can include a cyclohexene oxide; a 3-vinylcyclohexene oxide; a vinylcyclohexene dioxide; a dicylcopentadiene dioxide; a tricyclopentadiene dioxide; a tetracyclopentadiene dioxide; a norbornadiene dioxide; a bis(2,3-epoxycyclopentyl)ether; a limonene dioxide; 3′,4′-epoxycyclohexamethyl-3,4-epoxycyclohexanecarboxylate; a 3,4-epoxycyclohexyloxirane; a 2(3′,4′-epoxycyclohexyl)-5,1″-spiro-3″,4″-epoxycyclohexane-1,3-dioxane; and/or a bis(3,4-epoxycyclohexamethyl)adipate.

In other embodiments, the aliphatic epoxy can include an epoxidized polybutadiene; an epoxidized polyisoprene; an epoxidized poly(1,3-butadiene—acrylonitrile); an epoxized soybean oil; an epoxidized castor oil; a dimethylpentane dioxide; a divinylbenzene dioxide; a butadiene dioxide; and/or a 1,7-octadiene dioxide.

The compositions of the invention include compositions useful as adhesives, coatings, matrix resins and composite resins. In certain embodiments, the composition is a die attach paste adhesive that includes a filler. In other embodiments, the composition is an encapsulant such as electronic mold compound or underfill that includes a filler. In other embodiments, the composition is an industrial or marine coating or adhesive that includes a filler, an extender and/or a pigment.

Also contemplated by the invention are compositions including industrial, marine, automotive, airline, aerospace, sporting goods, medical and dental matrix resins. In yet other aspects of the invention, the compositions can be composite resins that include for example, carbon fiber, fiberglass and/or silica.

Certain compositions of the invention, such as adhesives, can also include additional compounds such as acrylates, methacrylates, maleimides, vinyl ethers, vinyl esters, styrenic compounds, allyl functional compounds, phenols, anhydrides, benzoxazines, and oxazolines.

The present invention also provides assemblies that include a first article adhered to a second article by a cured aliquot of the adhesive composition described above. Also provided are articles of manufacture coated with a cured layer of one of the compositions described above, such as a watercraft, automobile or airplane parts. In other embodiments of the invention, articles of manufactures can be comprised of a cured amount of a composition described herein, such as an encapsulant, industrial, marine, automotive, airline, aerospace, sporting goods, medical or dental article. Such articles of manufacture can also include fillers, extenders, pigments and/or reinforcing materials along with the compositions disclosed herein.

Method for attaching a first article to a second article are also provided by the invention, including the steps of applying an adhesive composition as disclosed above to the first article, the second article, or both the first article and the second article; then contacting the first article and second article, such that the first article and the second article are separated only by the adhesive composition, which results in the formation of an assembly. Upon curing of the adhesive composition, the first article is adhesively attached to the second. In certain embodiments, the adhesive composition includes a free-radical curable monomer and curing is by a hybrid thermosetting and free-radical cure.

The present invention also provides methods for adhesively attaching a semiconductor die to a substrate including the steps of applying the adhesive composition of the invention to the substrate, the semiconductor die, or the substrate and the semiconductor die; contacting the substrate and the die, such that the substrate and the die are separated only by the adhesive composition, to form an assembly; and then curing the adhesive composition, which results in adhesively attaching the semiconductor die to the substrate. In certain embodiments, the adhesive composition includes a free-radical curable monomer and curing is by a hybrid thermosetting and free-radical cure.

In some embodiments of the invention the reactions of epoxy and/or oxetane monomers with the acyl curatives are used to form the cured organic matrix of thermal interface materials. These materials perform an important role in the proper functioning of modern electronic devices. The service life and performance of electronic components are reduced under high temperature operating conditions. The increasing complexity and packing density of today's electronic circuitry produces high heat density. Therefore, heat dissipation is required for these devices.

The specific mechanisms for the failures caused by overheating include dendrite or metal whisker formation between conductive traces on the microelectronic chip, particularly if moisture is also present. Metal whiskers or dendrites can cause electrical shorts to occur between the metal traces and are a cause of device failure. This is a problem that is becoming evermore acute because of the market driven demand for greater device performance results in ever closer line spacing in the microelectronic circuits. Furthermore, high temperatures produce higher electrical resistance in the conductive traces themselves, which, in turn, reduces the speed at which signals are transmitted in the device.

Heat sinks are usually attached to electronic components in order to reduce the operating temperature of the device. A low stress, compliant, thermally conductive material is required to effectively couple the device to the heat sink. The products that are most useful for this application as thermal interface materials (TIM) are usually either greases, waxes, or low modulus thermosets that are loaded with thermally conductive fillers. The grease and wax-based TIM products are particularly suited for applications where the heat sink may need to be removed and reattached at a later time. These types of TIM products usually require the use of mechanical fasteners to keep the heat sink locked in place during the operation of the device. Alternatively, low modulus adhesives can be used for this purpose. The thermoset adhesives do not require the use of mechanical fasteners. The adhesives are also resistant to the “pump-out” that can plague the grease and wax-based TIM products. Pump-out can occur with grease or wax-based TIM materials after repeated thermal cycles and results in the physical migration of the TIM away from the junction of the heat sink and device. Although the thermoset adhesive products resist pump-out, they also lack the ability to regenerate intimate contact between the heat sink and electronic device the way grease or wax-based TIM products can. Loss of intimate contact between a thermoset TIM and either the microelectronic device can occur after a mechanical shock or even from the kind of repeated expansion and contraction events that occur during thermal cycling of the devices under normal use. Loss of intimate contact results in the development of an air gap between the heat sink and electronic device. The development of this gap degrades the ability of the heat sink to keep the operating temperature of the device from getting too high.

The acyl curatives of this invention can be combined with epoxy and/or oxetane monomers to generate a new kind of TIM product. It has been determined that an approximately one to one equivalent mixture of a difunctional epoxy or oxetane with a difunctional acyl curative can be cured to produce a thermoplastic end product. Furthermore, it has been determined that these thermoplastic based TIM materials fill an important gap in current TIM product performance. Like the thermoset adhesives they are not subject to the pump-out problem that is a know issue for the grease and wax-based TIM products. Other advantages over the existing thermoset adhesive TIM products in that they are self healing during temperature cycling and therefore are not subject to loss of intimate contact. While not wishing to be bound by theory, it is believed that the cure of an approximately one to one equivalent mix of difunctional epoxy and/or oxetane monomers with difunctional acyl curatives of this invention results in the formation of thermoplastic oligomers and/or polymers that have higher viscosities at elevated temperature than the corresponding grease or wax-based TIM formulations and are therefore not subject to the same pump-out problems that these existing products are known to have by those familiar with the art.

The thermoplastic TIM materials are also believed to be self healing during thermal cycling because of the known property of thermoplastics to flow above their glass transition temperature. This is a property that is not found in the existing thermoset adhesive TIM products. Thus, a thermoplastic can reform intimate contact between a heat sink and the device upon heating whereas a thermoset, which does not have the ability to flow again, cannot.

As already noted, one useful equivalent ratio of acyl curative to epoxy and/or oxetane can be one to one. However, it is possible to move to either side of that ratio and still have a viable platform for use in TIM applications. If the mixture is cured to yield only the chain extension product of the acyl curative and epoxy or oxetane, then any excess of one or more of these components would remain in the polymerized matrix and would effectively act as a plasticizer for the thermoplastic phase. Any unincorporated monomer or curative would thus act to soften and lower the modulus of the thermoplastic. The excess of monomer or curative would also act as a chain stopper and would thereby skew the molecular weight of the thermoplastic downward—effectively shifting the molecular weight distribution more toward oligomer and/or low molecular polymer.

It may be desirable for some applications to have such off-stoichiometric ratios of monomer to curative. In some cases the excess of either monomer or curative can be about 50% greater than theory. In other cases the excess can be about 25% greater than theory. And in some cases the excess can be about 10% greater than theory. In some instances it may be desirable to include a mono-functional acyl curative chain stopper instead of simply using an excess of a difunctional acyl curative as a means of limiting the molecular weight of the cured thermoplastic product. Exemplary “chain stopper” acyl curatives have been provided above. The use of these chain stoppers would correspond to the reaction scheme illustrated in FIG. 1, wherein the mono-acyl curatives that bear additional polymerizable functional groups are replaced by mono-acyl curatives that do not bear moieties that may be polymerized in a secondary cure.

It may also be desirable in some instances to introduce a limited amount of functionally reactive end-groups into the cured thermoplastic. These end-groups could be used to lightly crosslink the initially formed thermoplastic in a second cure step. This approach is illustrated in FIGS. 1 and 2. The concentration of these independently polymerizable end-groups could be less than about ten equivalent percent of the total acyl curative functions present, such as less than about 5% of the total acyl curative functions present, for example, less than about 2% of the total equivalents of acyl curative functions present in the composition.

It should be especially noted that one of the backbones for the acyl curatives of this invention are based on commercial products derived from the dimerization of unsaturated fatty acids. An example of the dimerization of linoleic and oleic acids followed by hydrogenation to the corresponding dimer diol is shown below:

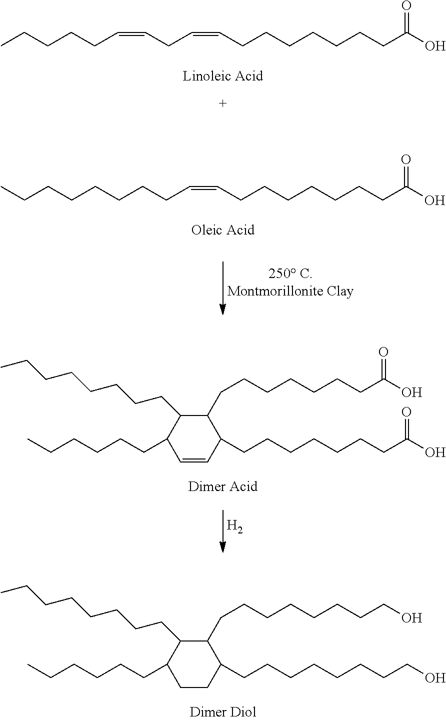 [SMILES: CCCCC/C=C\C/C=C\CCCCCCCC(=O)O ; CCCCCCCC/C=C\CCCCCCCC(=O)O ; CCCCCCCCC1C(CCCCCC)C=CC(CCCCCCCC(=O)O)C1CCCCCCCC(=O)O ; "H2" ; CCCCCCCCC1C(CCCCCC)CCC(CCCCCCCCO)C1CCCCCCCCO]

Thus, according to one representative reaction of this dimerization process, linoleic acid is first isomerized to the more stable conjugated diene. The conjugated double bond of the isomerized acid then adds via a Diels-Alder reaction to the double bond present in oleic acid. The resulting cyclohexenyl dimer acid may be selectively reduced to a tetrasubstituted cyclohexyl dimer acid or exhaustively hydrogenated to the dimer diol shown. Another acceptable alternative process option is the conversion of the dimer acid to the corresponding di-amide via reaction with ammonia. The resulting di-amide may then be reduced to produce the so called “dimer diamine” (not shown). Tetrasubstituted alicyclic compounds represent about 65% of the difunctional compounds that result from this dimerization as produced commercially. The balance of products that are produced, starting from the dimerized fatty acids comprise tetra-branched, difunctional aliphatic compounds, and tetra substituted, difunctional aromatic compounds. Collectively, the branched hydrocarbon moieties produced from the dimerization of fatty acids is sometimes abbreviated as:“—C₃₆H₇₂—” or even more simply: “—C₃₆—”.

The present invention also contemplates use of the acyl curatives described above in methods for increasing the adhesion, decreasing the viscosity, decreasing the modulus, reducing weight loss, and decreasing the hydrophilicity of an epoxy or oxetane resin, by combining an acyl curative of invention with the epoxy or oxetane resin.

### BRIEF DESCRIPTION OF THE DRAWINGS

FIG. 1 shows a scheme for the first step of a b-staging procedure represented by a chain extension and termination sequence.

FIG. 2 shows a scheme for the final step in a b-staging procedure, which involves a thermal cure to cross-link b-staged functional oligomers.

### DETAILED DESCRIPTION

Unless specific definitions are provided, the nomenclatures utilized in connection with, and the laboratory procedures and techniques of analytical chemistry, synthetic organic and inorganic chemistry described herein are those known in the art. Standard chemical symbols are used interchangeably with the full names represented by such symbols. Thus, for example, the terms “hydrogen” and “H” are understood to have identical meaning. Standard techniques may be used for chemical syntheses, chemical analyses, and formulation. The foregoing techniques and procedures can be generally performed according to conventional methods well known in the art.

It is to be understood that both the foregoing general description and the following detailed description are exemplary and explanatory only and are not restrictive of the invention claimed. As used herein, the use of the singular includes the plural unless specifically stated otherwise. As used herein, “or” means “and/or” unless stated otherwise. Furthermore, use of the term “including” as well as other forms, such as “includes,” and “included,” is not limiting.

The section headings used herein are for organizational purposes only and are not to be construed as limiting the subject matter described.

The invention provides novel acetoxy, acyloxy, and N-acyl curing agents useful in a variety of epoxy adhesive formulations. As used herein, “acyloxy” refers compounds having at least one moiety of the following general structure:

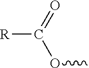

“Acetoxy”, according to the present invention, refers to compounds having at least one moiety of the following general structure:

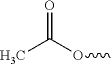

“N-acyl”, according to the present invention, refers to compounds having at least one moiety of the following general structure:

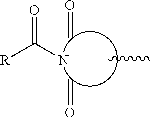

According to one embodiment of the invention, epoxy curing agents having the structure of Formulae I and II, below, are provided:

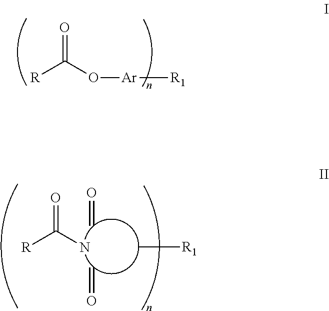

wherein each of R and R₁ is, independently, a substituted or an unsubstituted aliphatic, heteroaliphatic, aromatic, heteroaromatic, siloxane, maleimido, or cinnamyl moiety; Ar is a substituted or an unsubstituted aryl or heteroaryl moiety having between 6 and about 20 carbon atoms; and n is an integer having the value between 1 and about 11, such as between 1 and 6, for example, between 2 and 6.

“About” as used herein means that a number referred to as “about” comprises the recited number plus or minus 1-10% of that recited number. For example, “about” 100 degrees can mean 95-105 degrees or as few as 99-101 degrees depending on the situation. Whenever it appears herein, a numerical range such as “1 to 20” refers to each integer in the given range; e.g., “1 to 20 carbon atoms” means that an alkyl group can contain only 1 carbon atom, 2 carbon atoms, 3 carbon atoms, etc., up to and including 20 carbon atoms, although the term “alkyl” also includes instances where no numerical range of carbon atoms is designated.

In certain aspects of the invention, each of R and R₁ is, independently, a substituted or an unsubstituted alkyl, cycloalkyl, alkenyl, aryl, or heterocyclic moiety. According to some embodiments, at least one of R and R₁ is a C₁ to about C₂₀ substituted or unsubstituted alkyl, cycloalkyl, alkenyl, or aryl moiety. In other aspects, R and R₁ are each independently substituted or unsubstituted siloxane or maleimide.

In yet other embodiments, Ar is a substituted or an unsubstituted C₆ to about C₁₁ aryl or heteroaryl. In still further embodiments, Ar is phenyl, benzyl, tolyl, or xylyl.

In some embodiments, the value of n is between 2 and about 10, or between 4 and about 8. While in still further embodiments, the value of n is between 1 and 6.

As used herein, “alkyl” refers to straight or branched chain hydrocarbyl groups having between 1 and about 500 carbon atoms.

“Substituted alkyl” refers to alkyl moieties bearing substituents including, but not limited to, an alkyl, an alkenyl, an alkynyl, hydroxy, oxo, an alkoxy, mercapto, a cycloalkyl, a substituted cycloalkyl, a heterocyclic, a substituted heterocyclic, an aryl, a substituted aryl, a heteroaryl, a substituted heteroaryl, an aryloxy, a substituted aryloxy, a halogen, a haloalkyl, cyano, nitro, nitrone, an amino, an amido, —C(O)H, —C(O)—, —C(O)O—, —S—, —S(O)₂—, —OC(O)O—, —NR—C(O)—, —NR—C(O)—NR—, —OC(O)—NR—, wherein R is H, a lower alkyl, an acyl, an oxyacyl, carboxyl, carbamate, sulfonyl, sulfonamide, and sulfuryl.

As used herein, “alkenyl” refers to straight or branched chain hydrocarbyl groups having at least one carbon-carbon double bond, and having between 2 and about 500 carbon atoms, and “substituted alkenyl” refers to alkenyl groups further bearing one or more substituents as set forth above.

As used herein, “cycloalkyl” refers to cyclic ring-containing groups typically containing between 3 and about 20 carbon atoms, and “substituted cycloalkyl” refers to cycloalkyl groups further bearing one or more substituents as set forth above.

As used herein, “aryl” refers to aromatic groups having between 6 and about 20 carbon atoms. “Substituted aryl” refers to aryl groups further bearing one or more substituents as set forth above.

“Heteroaryl” refers to aryl groups having one or more heteroatoms (e.g., N, O, and S) as part of the ring structure.

As used herein, “heterocyclic” refers to cyclic (i.e., ring-containing) groups containing one or more heteroatoms (e.g., N, O, and S) as part of the ring structure, and having in between 3 and about 14 carbon atoms and “substituted heterocyclic” refers to heterocyclic groups further bearing one or more substituents as set forth above. The term heterocyclic is also intended to refer to heteroaromatic moieties.

As used herein, “siloxane” refers to any compound containing a Si—O moiety. In certain embodiments, siloxanes of the invention include 2 or more repeating units of Si—O.

As used herein, the term “maleimido” refers to a compound bearing at least one moiety having the structure:

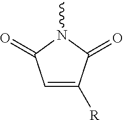

wherein R is H or lower alkyl.

“Imide” as used herein, refers to a functional group having two carbonyl groups bound to a primary amine or ammonia. The general formula of an imide of the invention is:

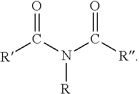

“Maleimide,” as used herein, refers to an N-substituted maleimide having the formula as shown below:

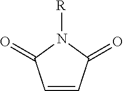

wherein R group may be an aromatic, heteroaromatic, aliphatic, or polymeric moiety.

“Polyimides” are polymers of imide-containing monomers. Polyimides typically have one of two forms: linear or cyclic. Non-limiting examples of linear and cyclic (e.g. an aromatic heterocyclic polyimide) polyimides are shown below for illustrative purposes.

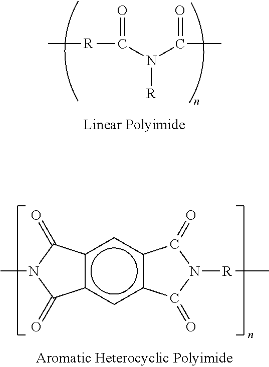

As used herein, the term “acrylate” refers to a compound bearing at least one moiety having the structure:

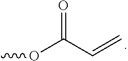

As used herein, the term “acrylamide” refers to a compound bearing at least one moiety having the structure:

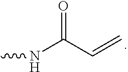

As used herein, the term “methacrylate” refers to a compound bearing at least one moiety having the structure:

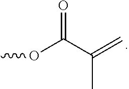

As used herein, the term “methacrylamide” refers to a compound bearing at least one moiety having the structure:

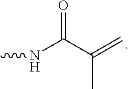

As used herein “epoxy” refers to a thermosetting epoxide polymer that cures by polymerization and crosslinking when mixed with a catalyzing agent or “hardener,” also referred to as a “curing agent” or “curative.” Epoxies of the present invention include, but are not limited to aliphatic, cycloaliphatic, glycidyl ether, glycidyl ester, glycidyl amine epoxies, and the like, and combinations thereof. Epoxies of the invention include compounds bearing at least one moiety having the structure:

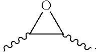

As used herein, the term “oxetane” refers to a compound bearing at least one moiety having the structure:

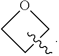

“Thermoplastic,” as used herein, refers to the ability of a compound, composition or other material (e.g. a plastic) to melt to a liquid when heated, and freeze to solid, often brittle and glassy, state when cooled sufficiently.

“Thermoset,” as used herein, refers to the ability of a compound, composition or other material to irreversibly “cure” to a stronger, harder form. Thermoset materials are typically polymers that may be cured, for example, through heat (e.g. above 200° C., or in the presence of appropriate catalysts at lower temperatures), via a chemical reaction (e.g. epoxy), or through irradiation (e.g. U.V. irradiation).

Thermoset materials, such as thermoset polymers or resins, are typically liquid or malleable forms prior to curing, and therefore may be molded or shaped into their final form, and/or used as adhesives. Curing transforms the thermoset resin into an infusible solid or rubber by a cross-linking process. Thus, energy and/or catalysts are added that cause the molecular chains to react at chemically active sites (unsaturated or epoxy sites, for example), linking the polymer chains into a rigid, 3-D structure. The cross-linking process forms molecules with a higher molecular weight and resultant higher melting point. During the reaction, when the molecular weight of the polymer has increased to a point such that the melting point is higher than the surrounding ambient temperature, the polymer becomes a solid material.

“Cross-linking,” as used herein, refers to the attachment of two or more oligomer or longer polymer chains by bridges of an element, a molecular group, a compound, or another oligomer or polymer. Crosslinking may take place upon heating or exposure to light; some crosslinking processes may also occur at room temperature or a lower temperature. As cross-linking density is increased, the properties of a material can be changed from thermoplastic to thermosetting.

“Adhesive” or “adhesive compound” as used herein, refers to any substance that can adhere or bond two items together. Implicit in the definition of an “adhesive composition” or “adhesive formulation” is the fact that the composition or formulation is a combination or mixture of more than one species, component or compound, which can include adhesive monomers, oligomers, and/or polymers along with other materials, whereas an “adhesive compound” refers to a single species, such as an adhesive polymer or oligomer.

More specifically, adhesive composition refers to un-cured mixtures in which the individual components in the mixture retain the chemical and physical characteristics of the original individual components of which the mixture is made. Adhesive compositions are typically malleable and may be liquids, paste, gel or another form that can be applied to an item so that it can be bonded to another item.

“Cured adhesive,” “cured adhesive composition” or “cured adhesive compound” refers to adhesives components and mixtures obtained from reactive curable original compound(s) or mixture(s) thereof which have undergone a chemical and/or physical changes such that the original compound(s) or mixture(s) is(are) transformed into a solid, substantially non-flowing material. A typical curing process may involve crosslinking.

“Curable” means that an original compound(s) or composition material(s) can be transformed into a solid, substantially non-flowing material by means of chemical reaction, crosslinking, radiation crosslinking, or the like. Thus, adhesive compositions of the invention are curable, but unless otherwise specified, the original compound(s) or composition material(s) is(are) not cured.

“Passivation” as used herein, refer to the process of making a material “passive” in relation to another material or condition. “Passivation layers” are commonly used to encapsulate semiconductor devices, such as semiconductor wafers, to isolate the device from its immediate environment and, thereby, to protect the device from oxygen, water, etc., as well airborne or space-borne contaminants, particulates, humidity and the like. Passivation layers are typically formed from inert materials that are used to coat the device. This encapsulation process also passivates semiconductor devices by terminating dangling bonds created during manufacturing processes and by adjusting the surface potential to either reduce or increase the surface leakage current associated with these devices.

In certain embodiments of the invention, passivation layers (PLs) contain dielectric material that is disposed over a microelectronic device. Such PLs are typically patterned to form openings therein that provide for making electrical contact to the microelectronic device. Often a passivation layer is the last dielectric material disposed over a device and serves as a protective layer.

“Interlayer Dielectric Layer” (ILD) refers to a layer of dielectric material disposed over a first pattern of conductive traces and between such first pattern and a second pattern of conductive traces. Such ILD layer is typically patterned to form openings therein (generally referred to as “vias”) to provide for electrical contact between the first and second patterns of conductive traces in specific regions. Other regions of such ILD layer are devoid of vias and thus prevent electrical contact between the conductive traces of the first and second patterns in such other regions.

A “die” or “semiconductor die” as used herein, refers to a small block of semiconducting material, on which a functional circuit is fabricated.

A “flip-chip” semiconductor device is one in which a semiconductor die is directly mounted to a wiring substrate, such as a ceramic or an organic printed circuit board. Conductive terminals on the semiconductor die, usually in the form of solder bumps, are directly physically and electrically connected to the wiring pattern on the substrate without use of wire bonds, tape-automated bonding (TAB), or the like. Because the conductive solder bumps making connections to the substrate are on the active surface of the die or chip, the die is mounted in a face-down manner, thus the name “flip-chip.”

“Underfill,” “underfill composition” and “underfill material” are used interchangeably to refer to a material, typically polymeric compositions, used to fill gaps between a semiconductor component, such as a semiconductor die, and a substrate. “Underfilling” refers to the process of applying an underfill composition to a semiconductor component-substrate interface, thereby filling the gaps between the component and the substrate.

“Thermal Interface Material” or “TIM” as used herein refers to a material used to dissipate heat from a heat-generating electronic component, such as a semiconductor component. Typically, a Thermal Interface Material will include a polymeric component, such as an adhesive compound or composition, and a thermally conductive component, such as a metallic filer. In certain embodiments, the Thermal Interface material doubles as an adhesive to adhesively attach two or more heat-generating electronic components to each other and/or to adhesively attach one or more heat-generating electronic components to a heat sink through which heat is dissipated.

The acyl-containing moiety of curatives described herein can be varied considerably in the practice of the invention. Exemplary acyloxy (—OC(O)R) moieties are set forth below:

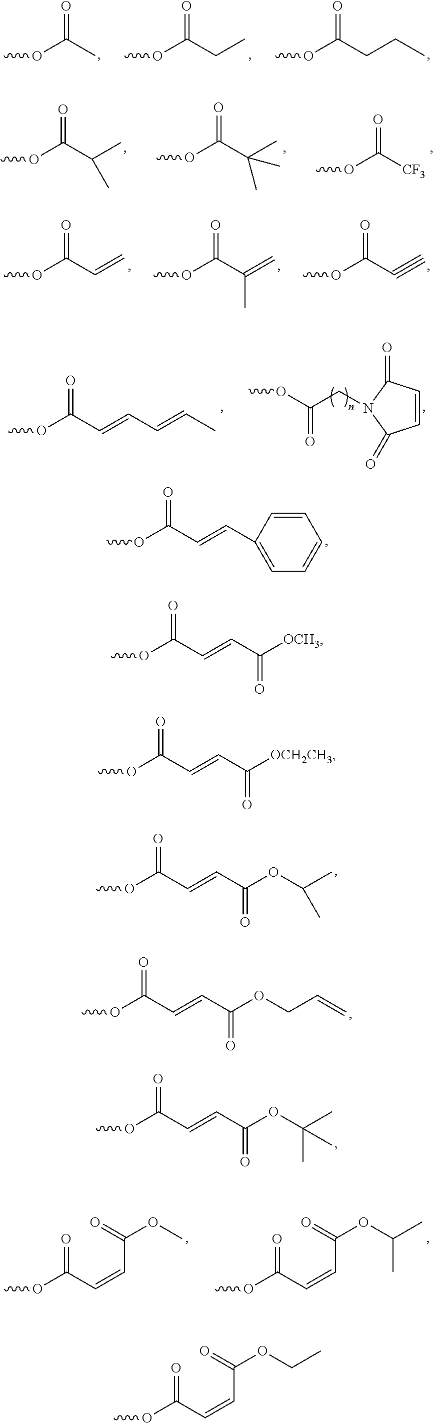

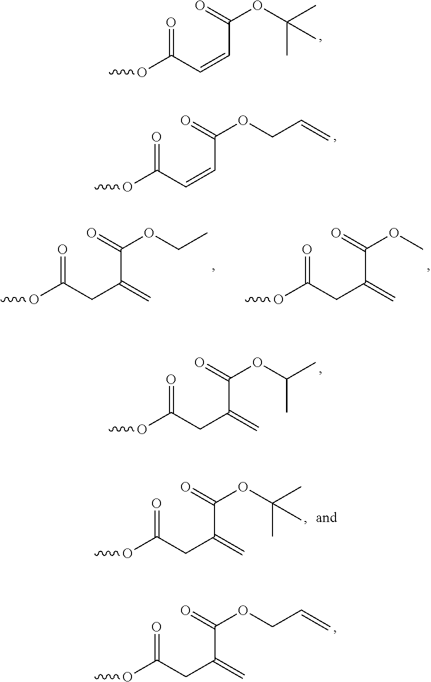

wherein n is an integer having the value between 1 and 11.

Exemplary invention curing agents include:

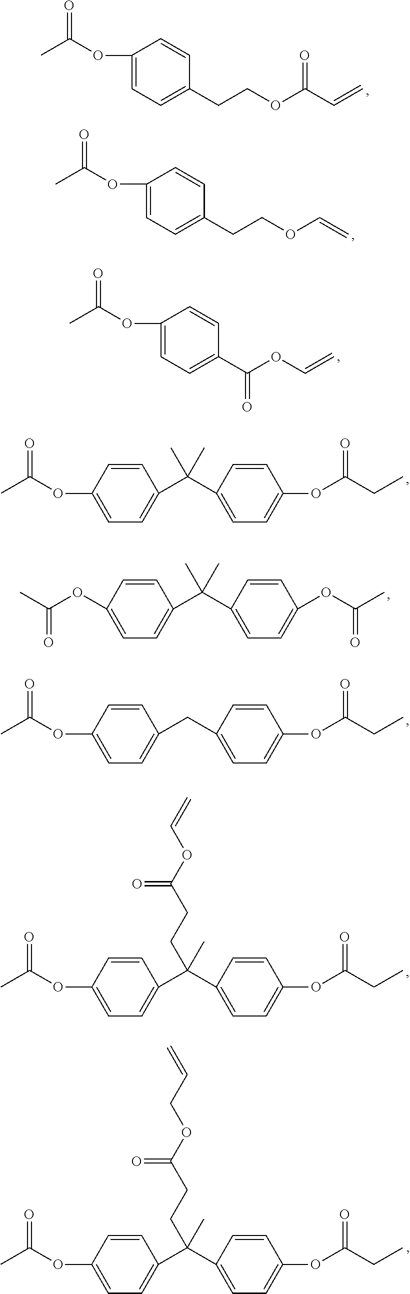

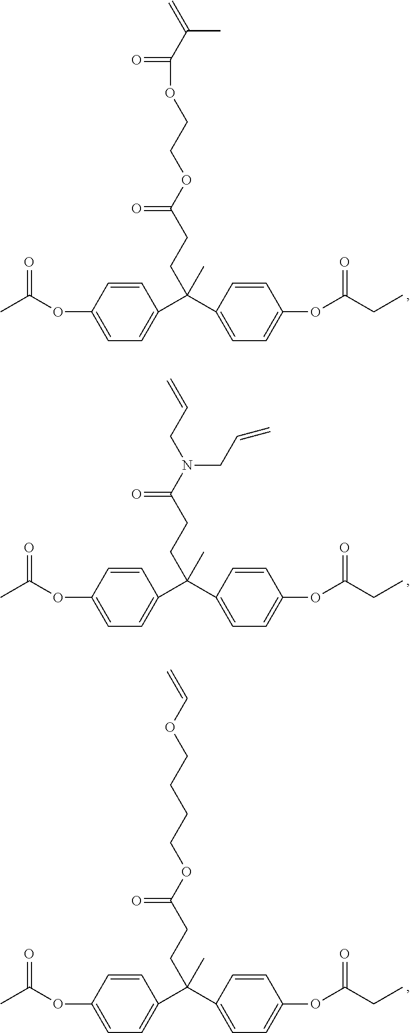

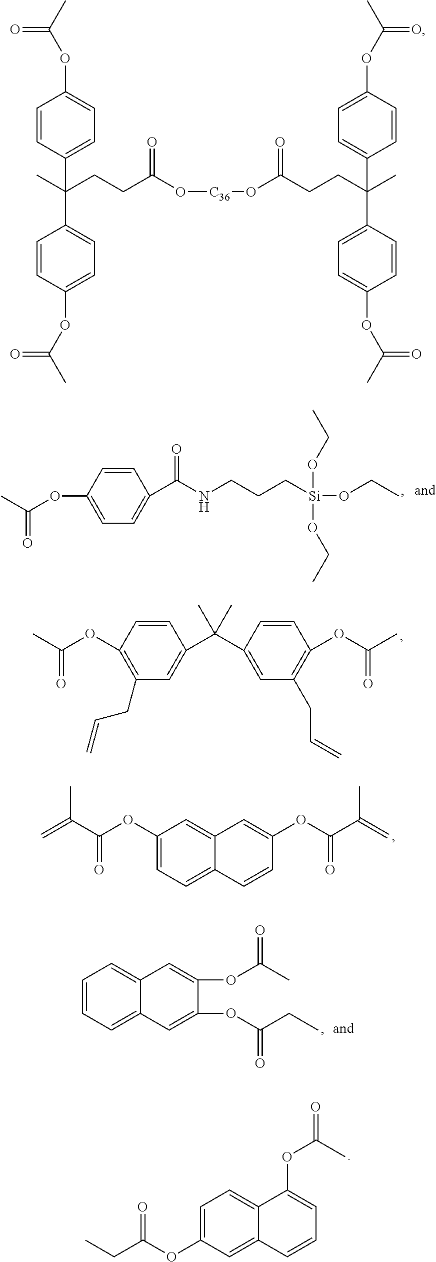

Dual functional acyloxy compounds of the present invention can be used to create new end-functionalized, monomers and oligomers through chain extension. Thus, according to one embodiment of the invention, a difunctional epoxy and a bisacyloxy compound can be reacted to form a linear oligomer. The oligomers can be chain terminated with a mono-acyloxy compound that also bears an independently polymerizable functional group. Where the end group is an acrylate, methacrylate, maleimide, citraconimide, diallylamide, vinyl ester, styrenyl, or other free radically polymerizable moiety, the oligomers can then be converted to a cross-linked thermoset in a second step. This dual stage cure is especially attractive for applications were it is desirable to apply an adhesive in liquid form, cure the material to a non-tacky thermoplastic state, and then cure this b-staged adhesive in a final heating step to bond two or more parts together.

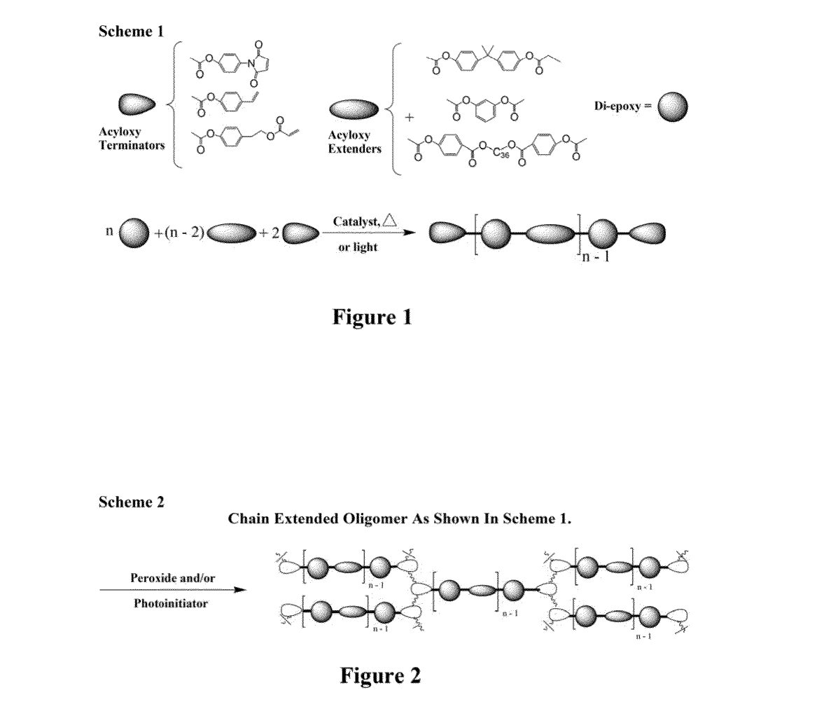

This dual stage cure method of the invention is particularly attractive for silicon wafer back coatings. The original mix of difunctional epoxies, difunctional acyloxy compounds, and suitably substituted mono-acyloxy compounds (along with coupling agents, catalysts, and optionally fillers) can be spin coated onto the back of a silicon wafer. The coating can then be b-staged with heat or light. The b-staging step can be represented by the chain extension and termination sequence shown in Scheme 1 (FIG. 1). The coated wafers can then be diced to yield individual microelectronic components, which may be thermally attached directly to a substrate, and/or stacked together. The thermal “tacking step” re-liquifies the oligomeric coating and provides a thermoplastic bond between the parts. The final bonding step involves a thermal (or in some cases light-based) cure to cross-link the b-staged functional oligomers as shown in Scheme 2 (FIG. 2). This method of assembly is desirable because it is easier to manufacture (especially for stacked die) than a traditional liquid adhesive assembly, and is less expensive and wasteful compared to film-based adhesive technology.

Poly-acyloxy curatives are also contemplated for use in the practice of the invention. These are especially suited for pre-applied and/or film applications. Indeed, any novolak can be converted to a poly-acyloxy compound, and therefore a vast array of poly-acyloxy curatives are contemplated, including but not limited to those shown below.

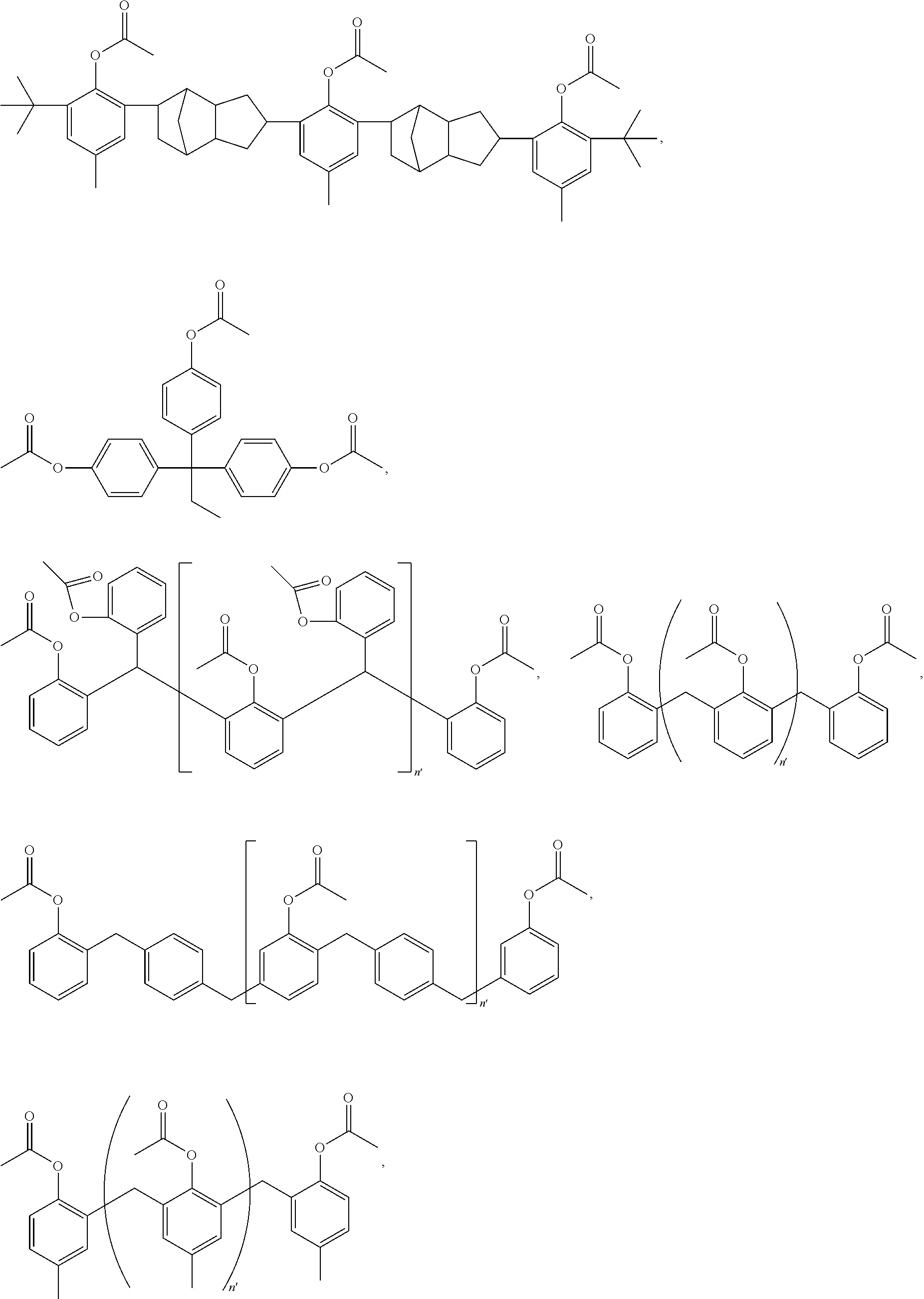

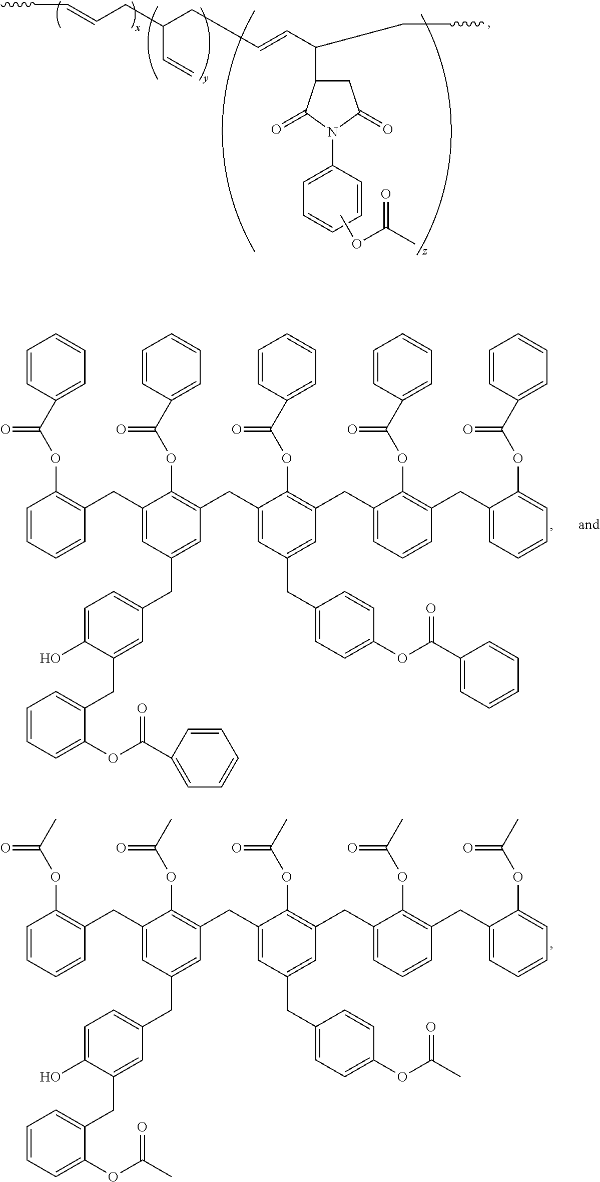

wherein each of n′, x, y and z is an integer, independently having the following values: n′ between 0 and 10, each of x and y between 4 and about 50, and z between 2 and about 40.

Referring now to Formula II, above, the substituent R can be varied considerably in the practice of the invention. Exemplary N-acyl moieties include but are not limited to:

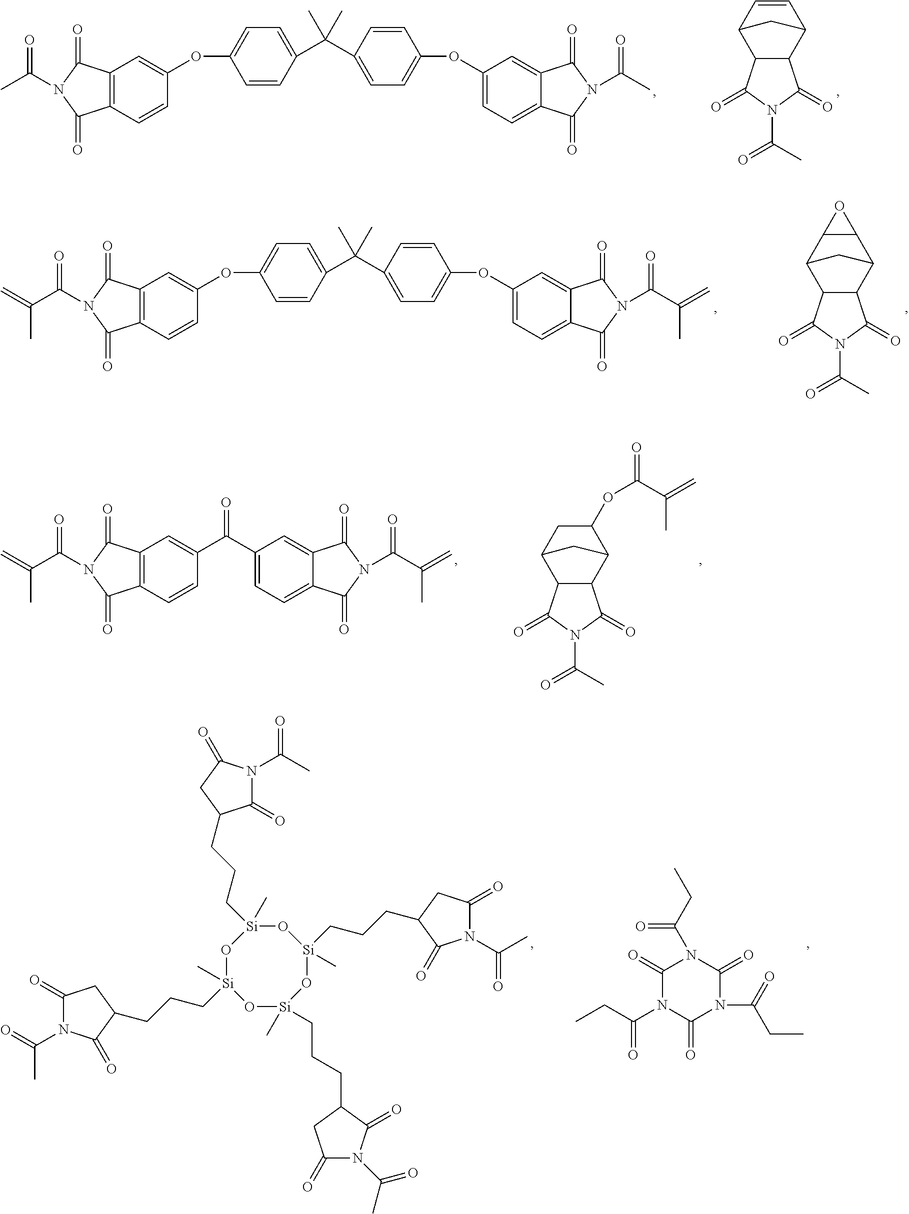

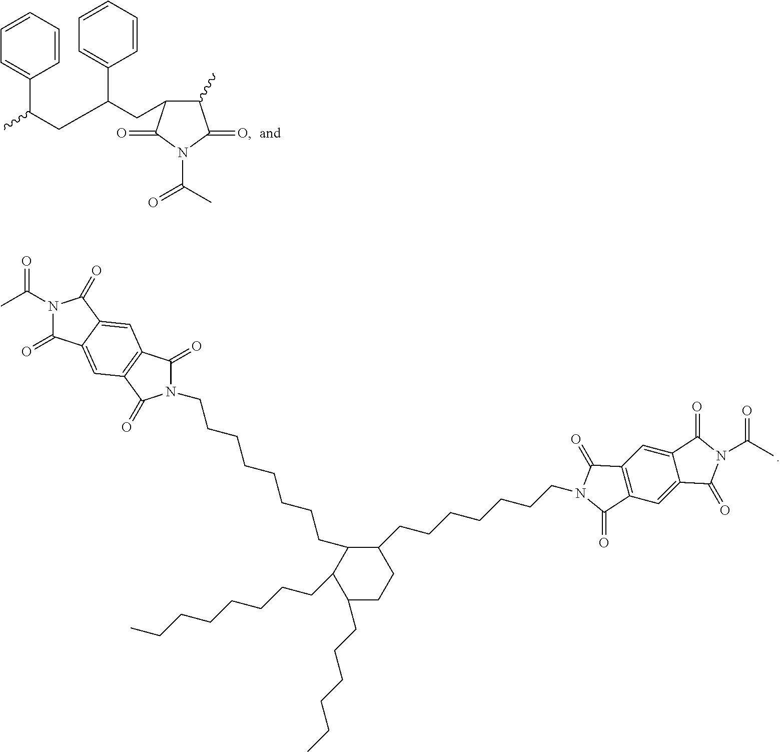

Additional exemplary invention curing agents are set forth below:

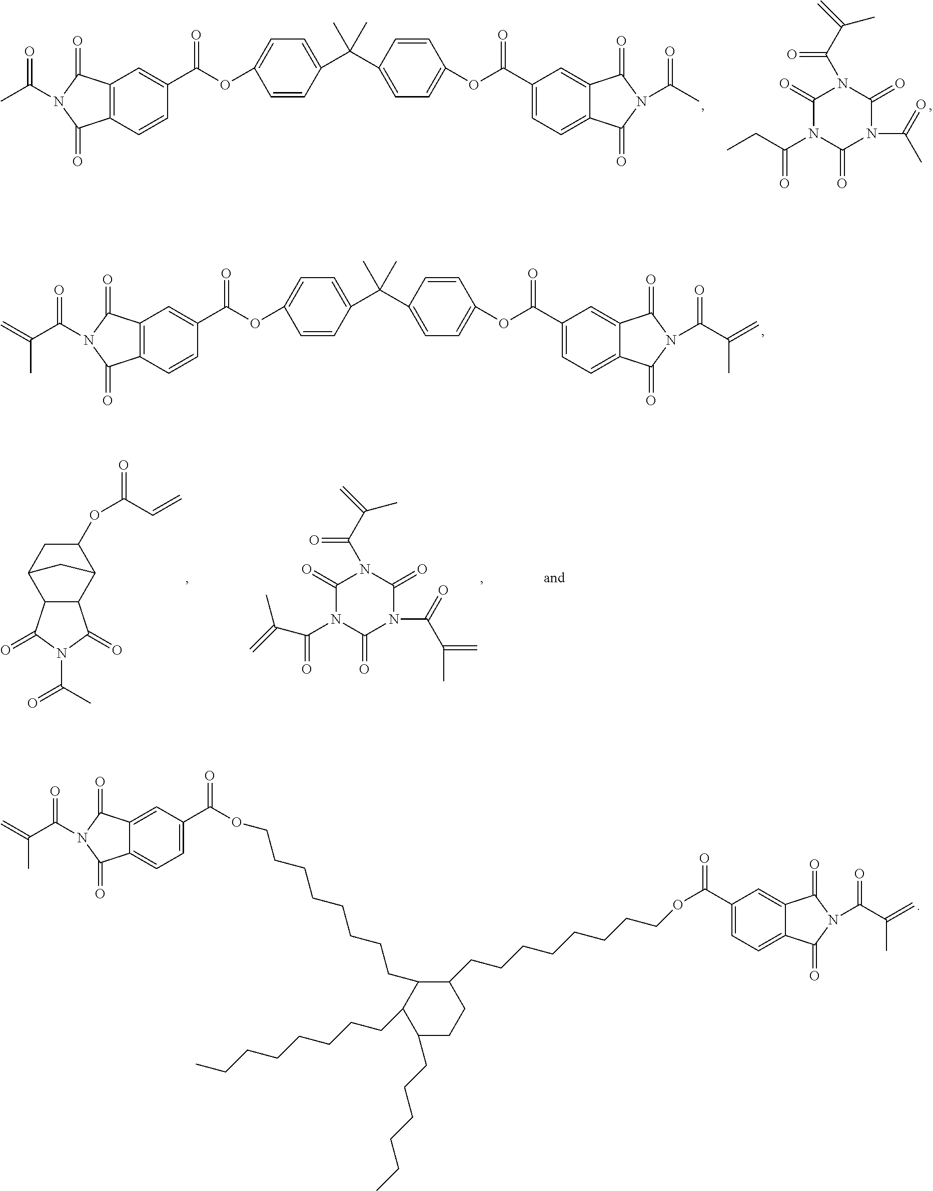

Additional curatives that can be used according to the embodiments of the invention also include, but not limited to, the following compounds:

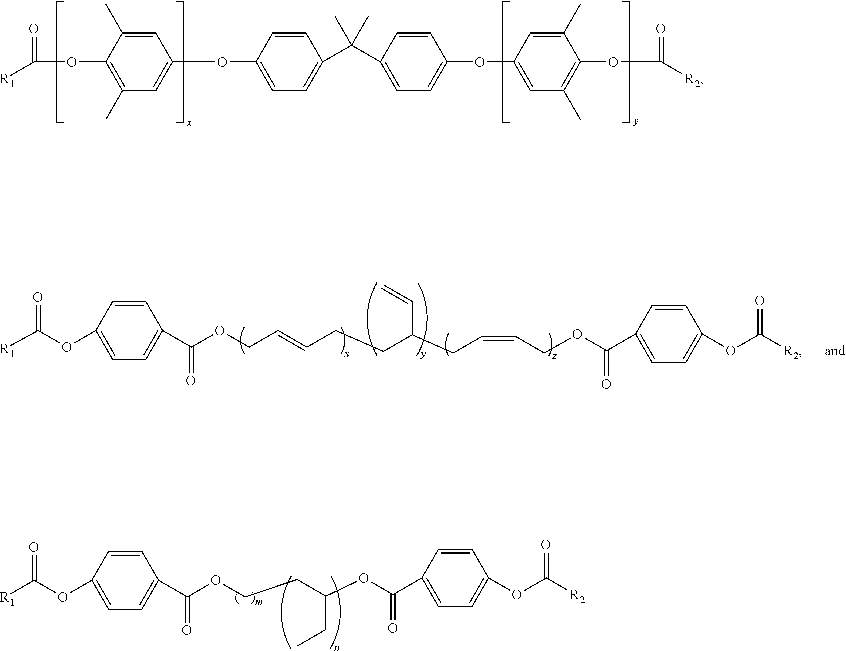

wherein the sum of x, y and z is equal to, or less than, about 130, the sum of m and n is equal to, or less than, about 300, and each of R₁ and R₂ is independently a lower alkyl or a substituted or an unsubstituted aryl.

In addition, any of the following “chain stopper” curatives can be used according to the embodiments of the invention:

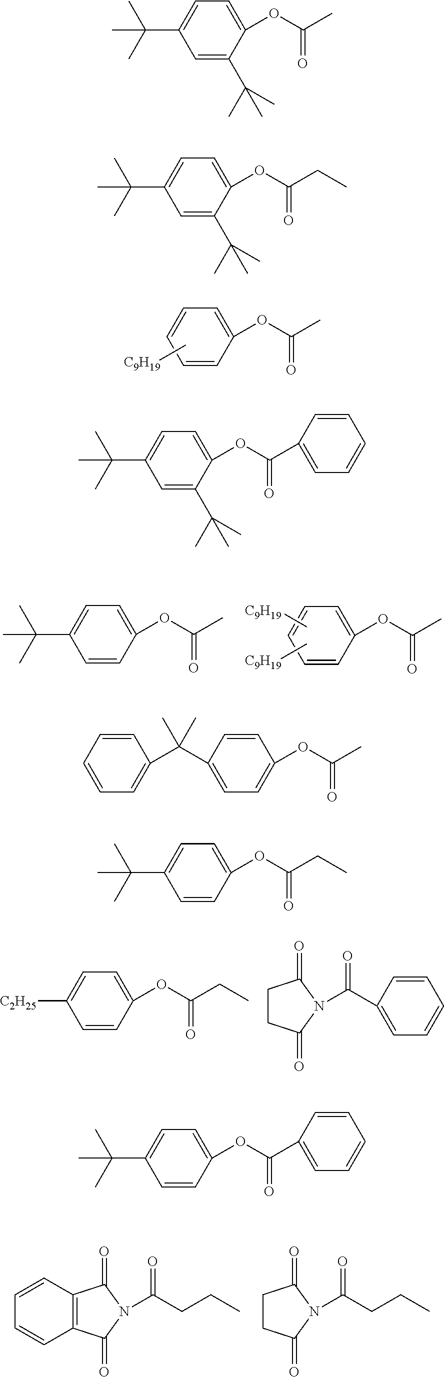

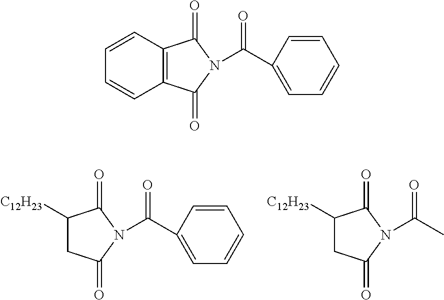

Poly-N-acyl curatives are also contemplated for use in the practice of the invention. These are especially suited for pre-applied and/or film applications. Indeed, any polymer containing anhydride residues in the main-chain or grafted to the backbone can be converted to a poly-N-acyl compound, and therefore a vast array of poly-N-acyl curatives are contemplated, including, but not limited to those illustrated below.

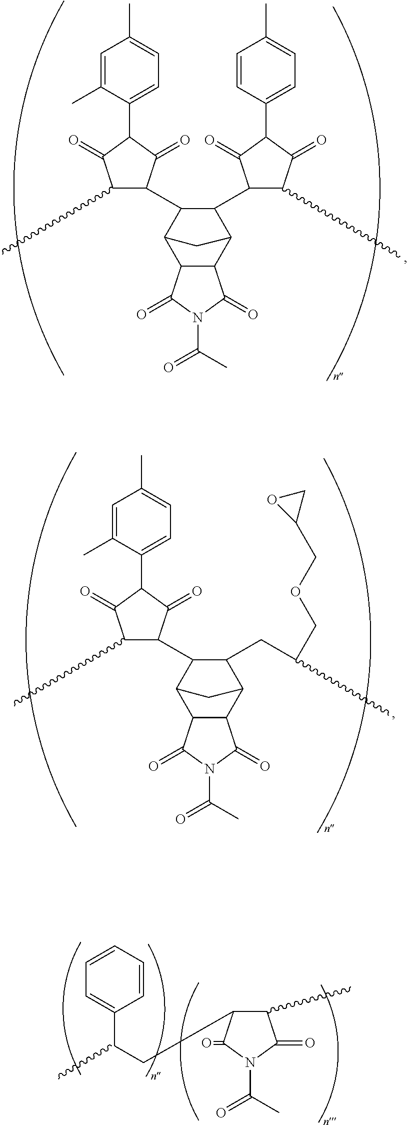

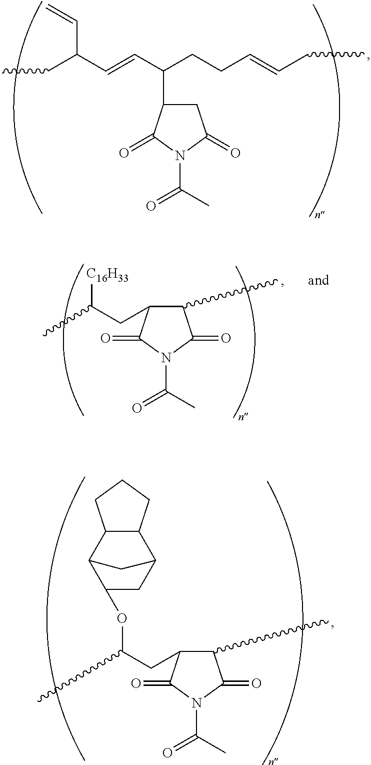

wherein each n″ and n′″ is an integer independently having the value between 1 and about 10.

The compounds set forth below provide representative, non-limiting examples of phenyl acyloxy derivatives that have additional useful functionality. In some cases these compounds can be used to make high T_{g}, linear, segments within a thermoset (i.e. where the molecule bears both epoxy and acyloxy functionality). The maleimide functional compounds can be used to make polymaleimides in situ, which would be available to participate in the rich cure chemistry of polymaleimides (ene/Diels-Alder, Michael addition, free-radical, etc.). It should be noted that most of these compounds are shown as their phenyl acetates, however any of the previous acyloxy moieties are contemplated for use in this embodiment of the invention. In some embodiments, the isopropenyl compounds could be used for ene/Diels-Alder cures of BMIs.

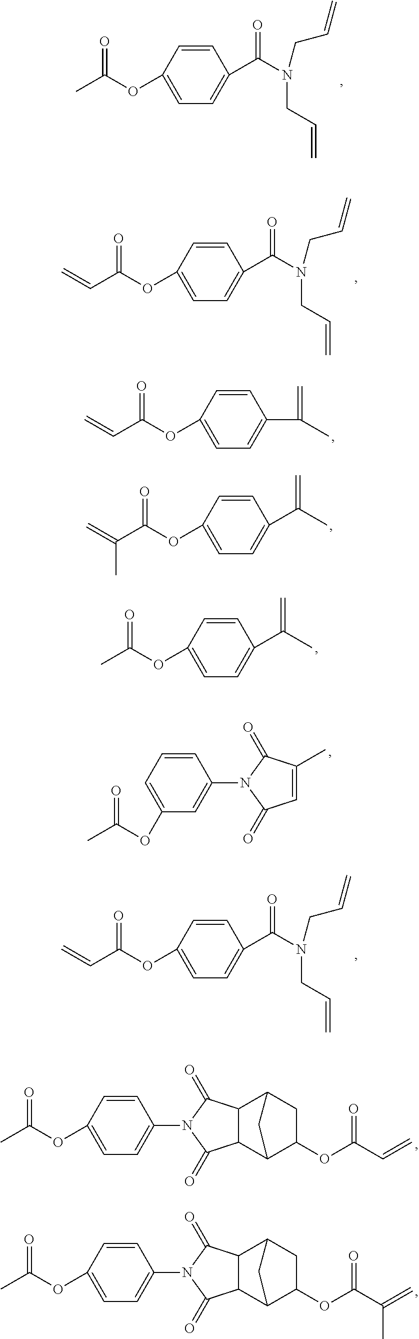

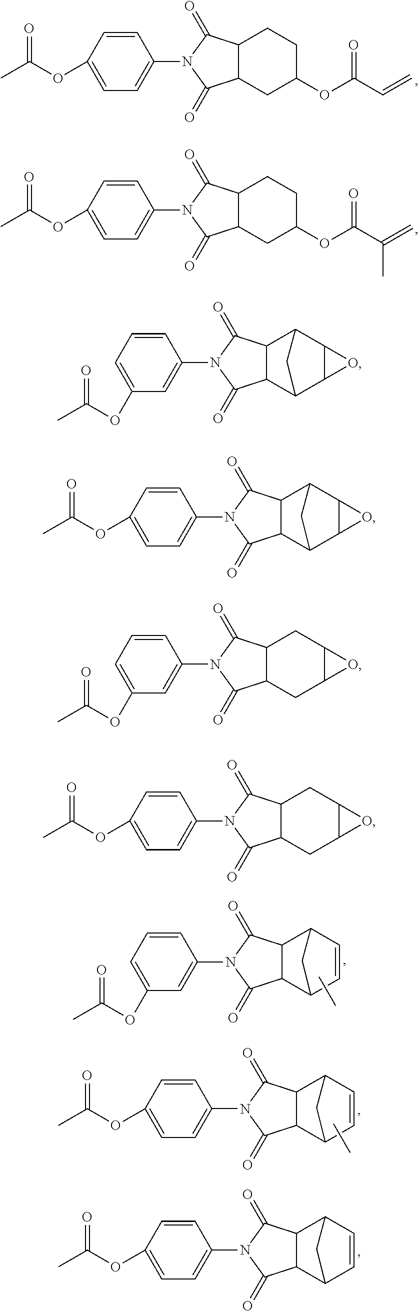

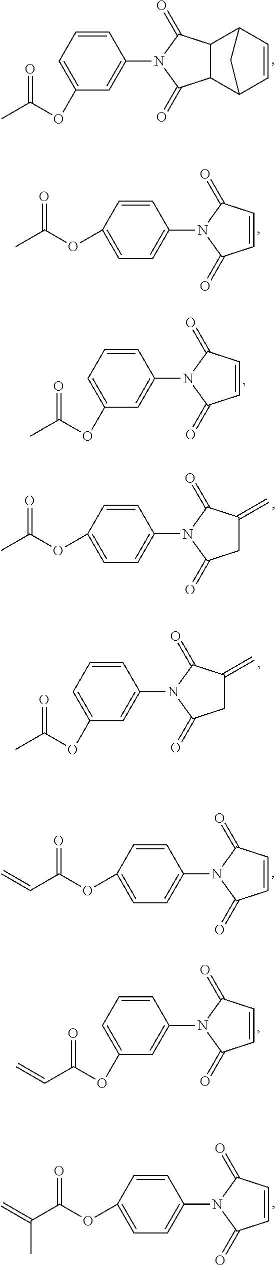

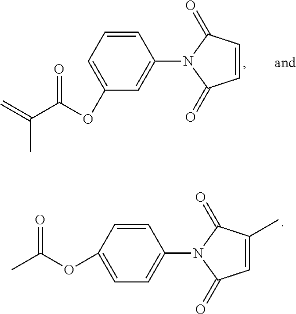 [SMILES: C=C(C)C(=O)Oc1cccc(N2C(=O)C=CC2=O)c1 ; CC(=O)Oc1ccc(N2C(=O)C=C(C)C2=O)cc1]

The compounds set forth below are and liquids would therefore be suited for use in paste based adhesives.

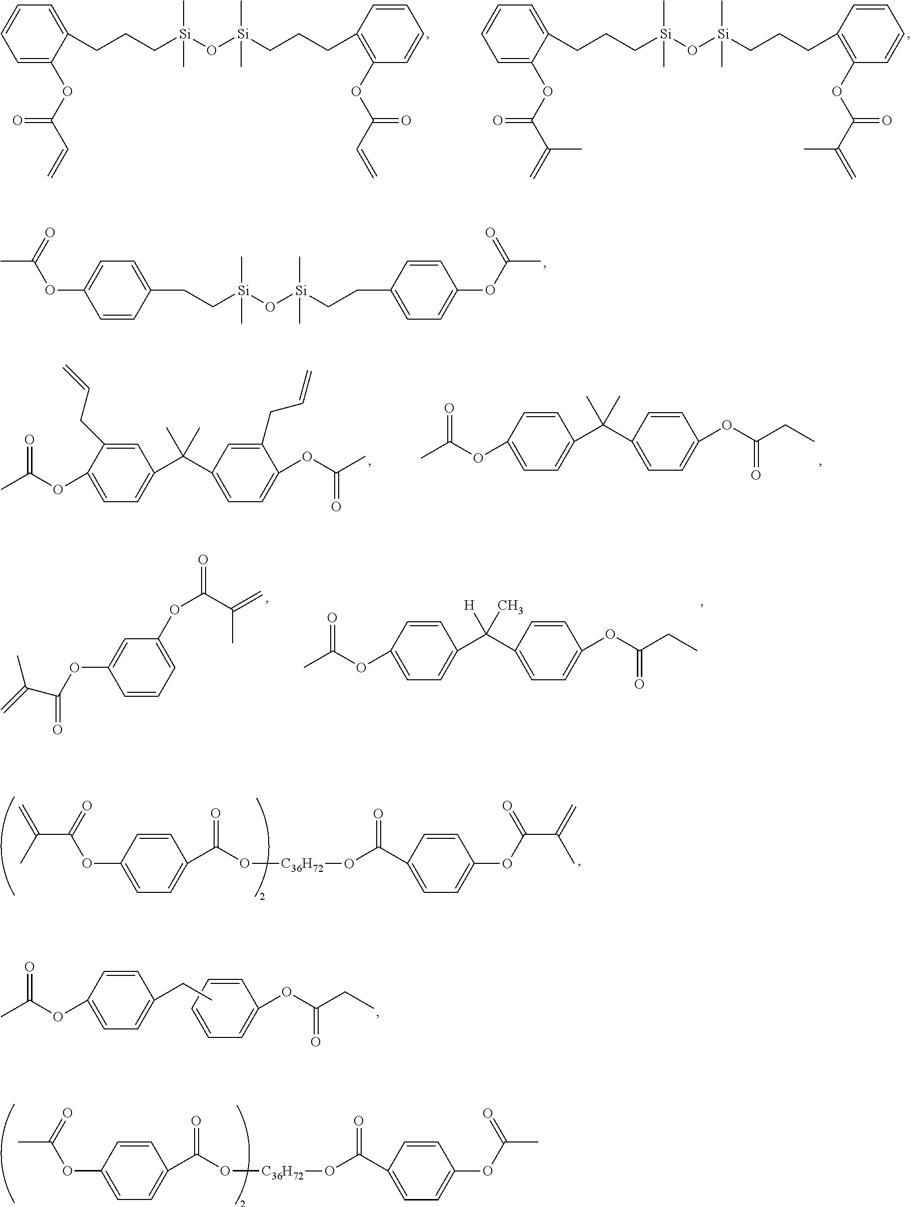

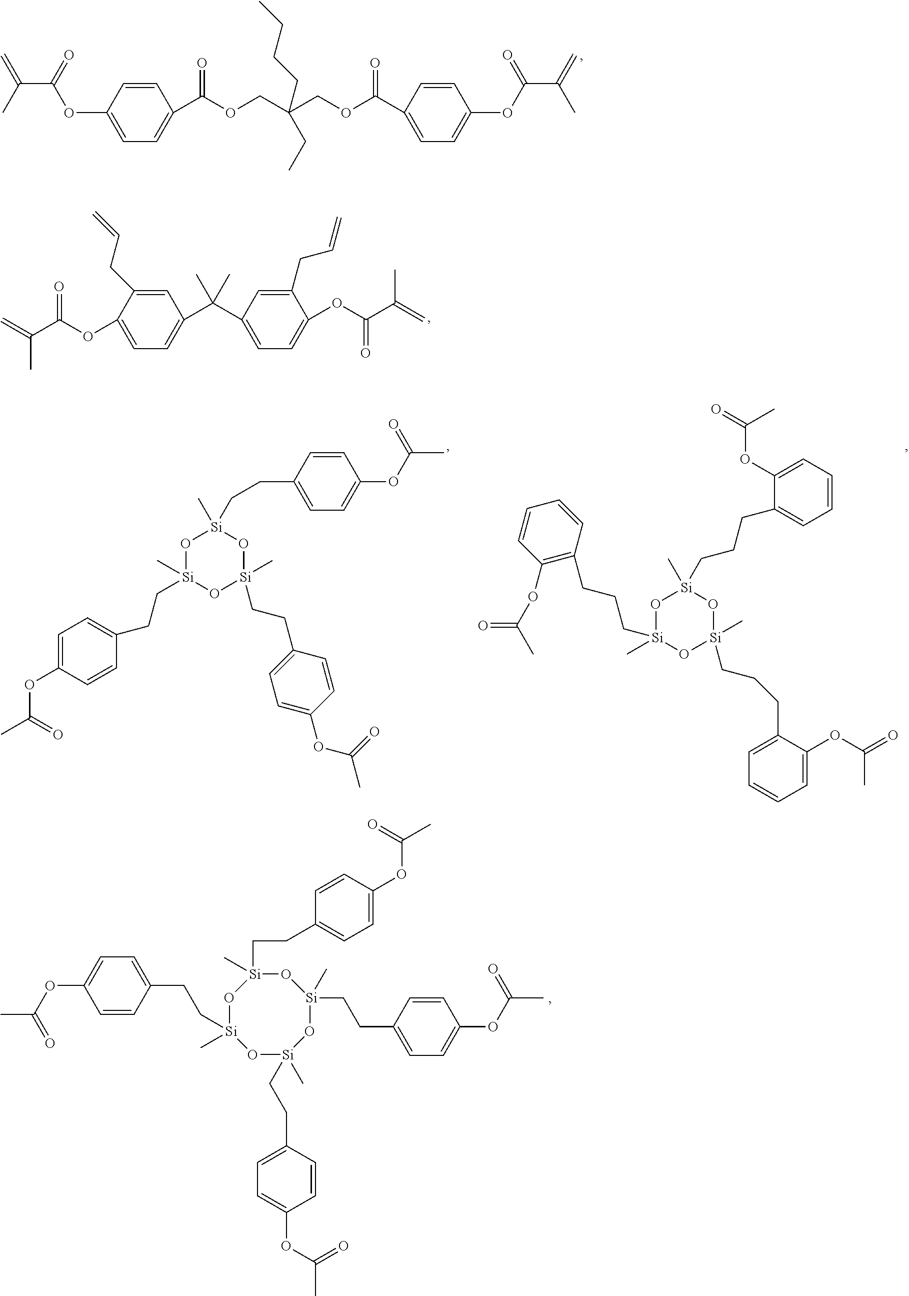

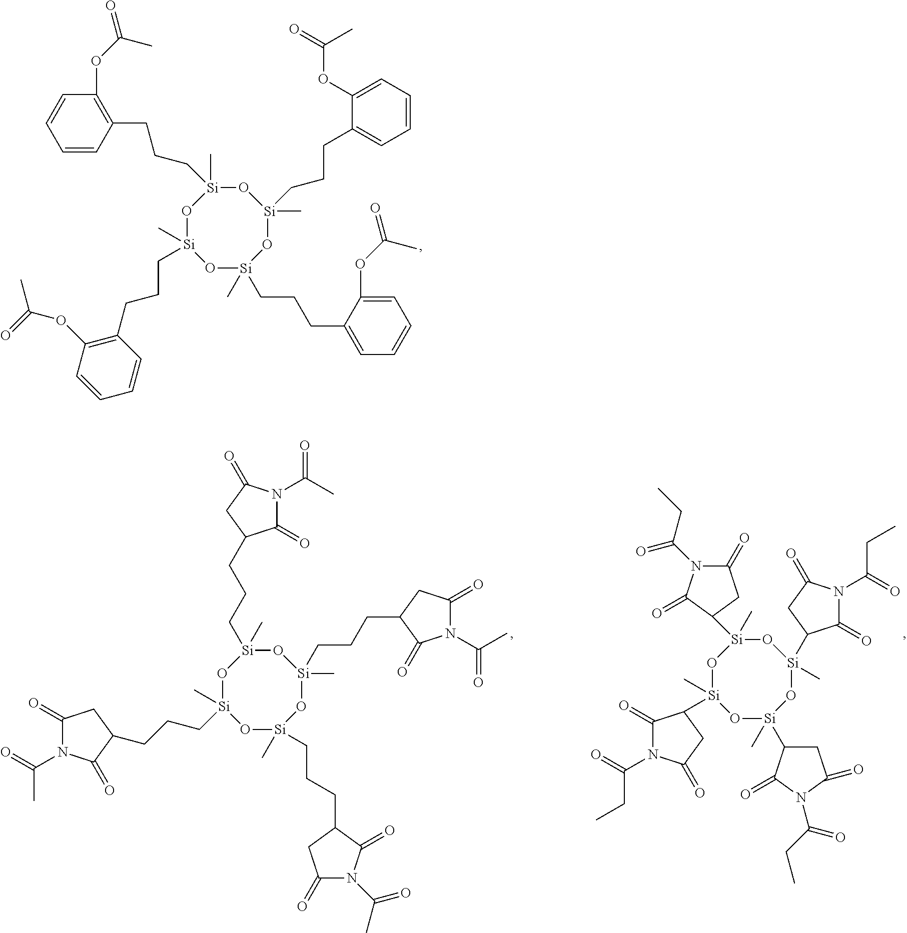 [SMILES: CC(=O)Oc1ccccc1CCC[Si]1(C)O[Si](C)(CCCc2ccccc2OC(C)=O)O[Si](C)(CCCc2ccccc2OC(C)=O)O[Si](C)(CCCc2ccccc2OC(C)=O)O1 ; CC(=O)N1C(=O)CC(CCC[Si]2(C)O[Si](C)(CCCC3CC(=O)N(C(C)=O)C3=O)O[Si](C)(CCCC3CC(=O)N(C(C)=O)C3=O)O[Si](C)(CCCC3CC(=O)N(C(C)=O)C3=O)O2)C1=O ; CCC(=O)N1C(=O)CC([Si]2(C)O[Si](C)(C3CC(=O)N(C(=O)CC)C3=O)O[Si](C)(C3CC(=O)N(C(=O)CC)C3=O)O[Si](C)(C3CC(=O)N(C(=O)CC)C3=O)O2)C1=O]

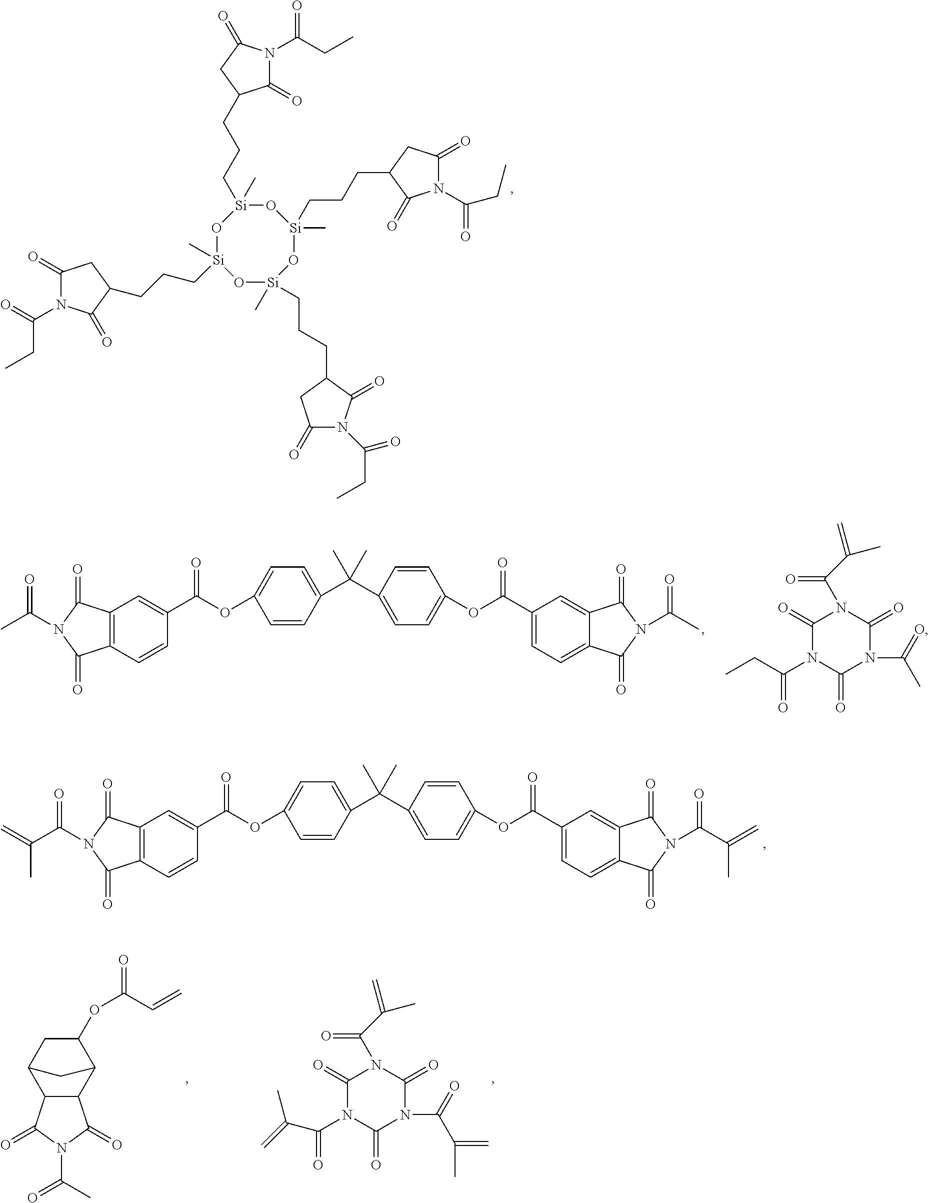

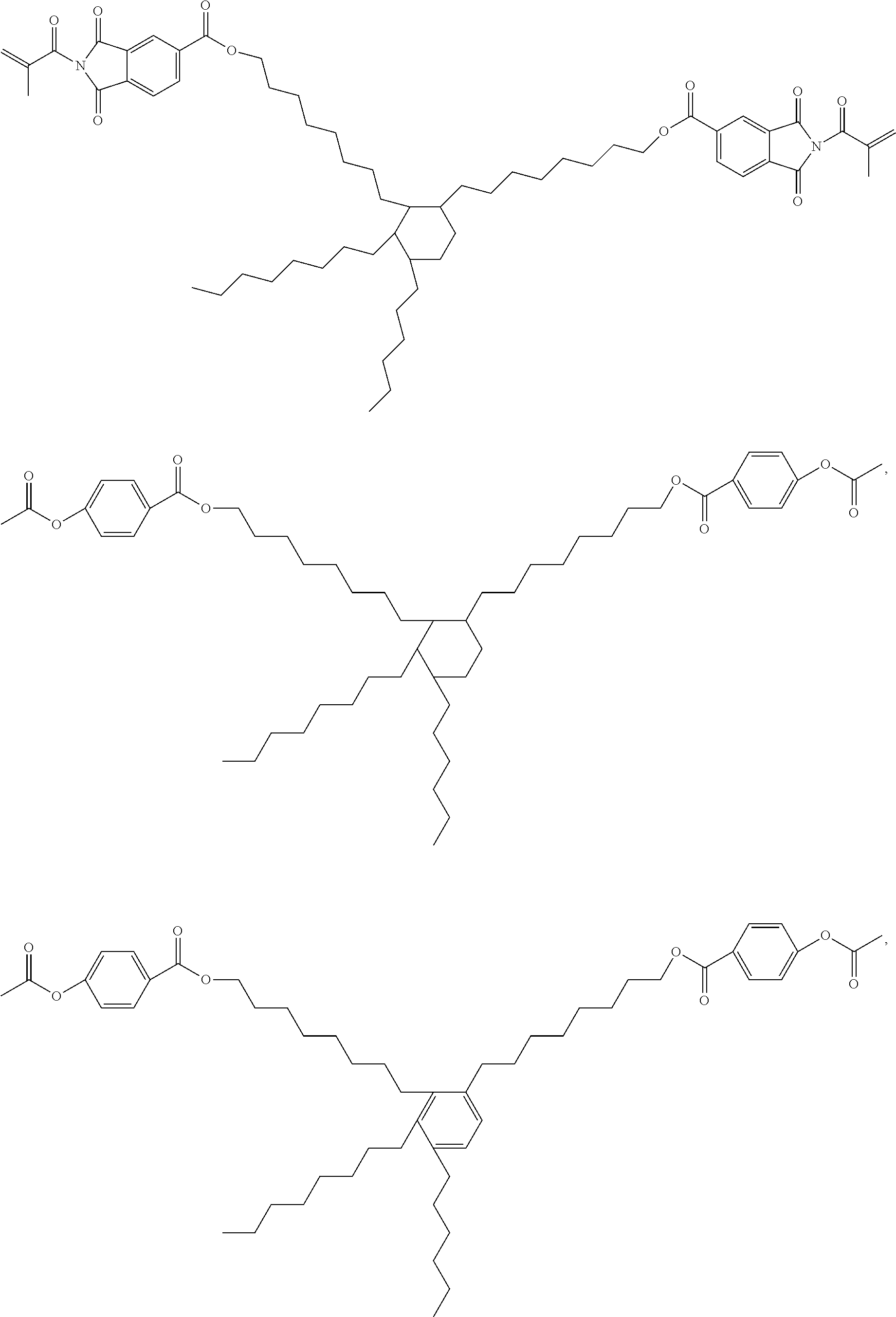

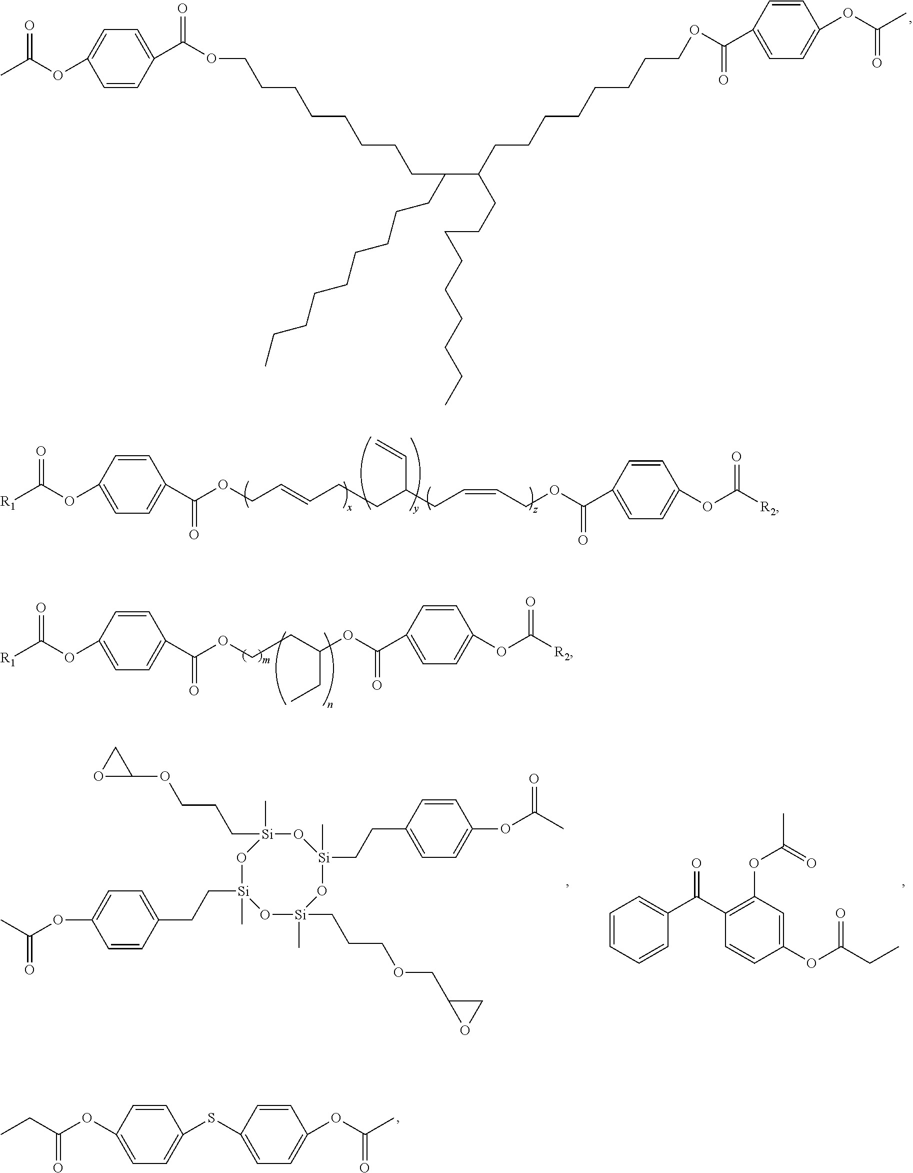

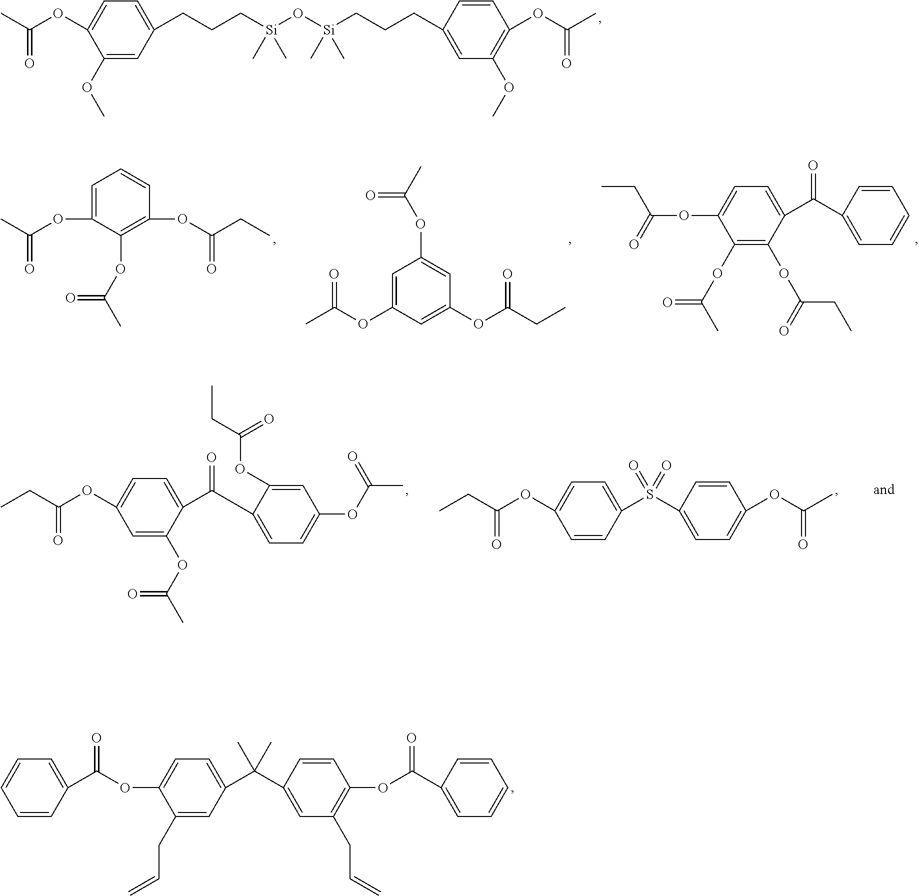

wherein the sum of x, y and z is equal to, or less than, about 130, the sum of m and n is equal to, or less than, about 300, and each of R₁ and R₂ is independently a lower alkyl or a substituted or an unsubstituted aryl. Epoxy resins contemplated for use in the practice of the invention include, but are not limited to, aliphatic, cycloaliphatic, glycidyl ether, glycidyl ester, glycidyl amine epoxies.

Glycidyl ether epoxy resins contemplated for use in the practice of the invention include, but are not limited to, a glycidyl ether of a phenol, an amine, an alcohol, or an isocyanurate, such as a phenyl glycidyl ether, a cresyl glycidyl ether, a nonylphenyl glycidyl ether, and a p-tert-butylphenyl glycidyl ether; a diglycidyl ether or a trisglycidyl ether of a phenolic compound such as bisphenol A, bisphenol F, ethylidinebisphenol, dihydroxydiphenyl ether, N,N′-disalicylal-ethylenediamine, triglycidyl-p-aminophenol, N,N,N′,N′-tetraglycidyl-4,4′-diphenylmethane, triglycidyl isocyanurate, bis(4-hydroxyphenyl)sulfone, bis(hydroxyphenyl)sulfide, 1,1-bis(hydroxyphenyl)cyclohexane, 9,19-bis(4-hydroxyphenyl)fluorene, 1,1,1-tris(hydroxyphenyl)ethane, tetrakis(4-hydroxyphenyl)ethane, trihydroxytritylmethane, 4,4′-(1-alpha-methylbenzylidene)bisphenol, 4,4′-(1,3-componentthylethylene)diphenol, componentthylstilbesterol, 4,4′-dihyroxybenzophenone, resorcinol, catechol, and tetrahydroxydiphenyl sulfide; a glycidyl ether of a cresol formaldehyde condensate; a glycidyl ether of a phenol formaldehyde condensate; a glycidyl ether of a cresol dicyclopentadiene addition compound; a glycidyl ether of a phenol dicyclopentadiene addition compound; a glycidyl ether of a fused ring polyaromatic phenol such as dihydroxy naphthalene, 2,2′-dihydroxy-6,6′-dinaphthyl disulfide, and 1,8,9-trihydroxyanthracene; a glycidyl ether of an aliphatic alcohol such as a diglycidyl ether of 1,4 butanediol, a diglycidyl ether of diethylene glycol, a diglycidyl ether of neopentyl glycol, a diglycidyl ether of cyclohexane dimethanol, a diglycidyl ether of tricyclodecane dimethanol, a trimethyolethane triglycidyl ether, and a trimethyol propane triglycidyl ether; a glycidyl ether of a polyglycol such as Heloxy 84™, Heloxy 32™, a polyglycidyl ether of castor oil, and a polyoxypropylene diglycidyl ether; a glycidyl derivative of an aromatic amine; ester linked epoxies, such as Heloxy 71 and glycidyl methacrylate. Other glycidyl ether epoxies contemplated herein include homo- and co-polymers based on allyl glycidyl ether.

Cycloaliphatic epoxy compounds contemplated for use in the practice of the invention include, but are not limited to, cyclohexene oxide; 3-vinylcyclohexene oxide; vinylcyclohexene dioxide; dicylcopentadiene dioxide; tricyclopentadiene dioxide; tetracyclopentadiene dioxide; norbornadiene dioxide; bis(2,3-epoxycyclopentyl)ether; limonene dioxide; 3′,4′-epoxycyclohexamethyl-3,4-epoxycyclohexanecarboxylate; 3,4-epoxycyclohexyloxirane; 2(3′,4′-epoxycyclohexyl)-5,1″-spiro-3″,4″-epoxycyclohexane-1,3-dioxane; bis(3,4-epoxycyclohexamethyl) adipate; and the like.

Aliphatic epoxy compounds contemplated for use in the practice of the invention include, but are not limited to, epoxidized polybutadiene; epoxidized polyisoprene; epoxidized poly(1,3-butadiene—acrylonitrile); epoxized soybean oil; epoxidized castor oil; dimethylpentane dioxide; divinylbenzene dioxide; butadiene dioxide; and 1,7-octadiene dioxide.

As used herein, “b-stageable” means that the adhesive has a first solid phase followed by a tacky rubbery stage at elevated temperature, followed by yet another solid phase at an even higher temperature. The transition from the tacky rubbery stage to the second solid phase is thermosetting. However, prior to that, the material behaves similarly to a thermoplastic material. Thus, such adhesives allow for low lamination temperatures while providing high thermal stability.

The b-stageable adhesive can be dispensed onto a die or a substrate by a variety of methods well known to those skilled in the art. In some embodiments, the adhesive is cast from solution using techniques such as spin coating, spray coating, stencil printing, screen printing, dispensing, and the like.

In certain embodiments, a solvent may be employed in the practice of the invention. For example, when the b-stageable adhesive is spin coated onto a circular wafer, it is desirable to have an even coating throughout the entire wafer, i.e., the solvent or solvent system should have the ability to deliver the same amount of adhesive to each point on the wafer. Thus, the adhesive will be evenly coated throughout, i.e., there will be the same amount of material at the center of the wafer as at the edges. Ideally, the adhesive is “Newtonian”, with a thixotropic slope of 1.0. In certain embodiments, the solvent or solvent systems used to dispense the b-stageable adhesive have thixotropic slopes ranging from 1.0 to about 5.

In some instances, the b-stageable adhesive is dispensed onto the backside of a die that has been optionally coated with a polyimide. To achieve this goal, in certain embodiments, the solvent system will include a polar solvent in combination with a non-polar solvent. In addition, the polar solvent typically has a lower boiling point than the non-polar solvent. Without wishing to be limited to a particular theory, it is believed that when the adhesive is dispensed and then b-staged, the lower boiling polar solvent escapes first, leaving behind only the non-polar solvent, essentially precipitating the polymer uniformly.

In some embodiments, the solvent or solvent system has a boiling point ranging between about 150° C. up and about 300° C. In some embodiments, the solvent system is a combination of dimethyl phthalate (DMP), NOPAR 13, and terpineol. In other embodiments, the solvent system is a 1:1 (by volume) ratio of terpineol and NOPAR 13.

Fillers contemplated for use in the practice of the present invention can be electrically conductive and/or thermally conductive, and/or fillers which act primarily to modify the rheology of the resulting composition. Examples of suitable electrically conductive fillers which can be employed in the practice of the present invention include silver, nickel, copper, aluminum, palladium, gold, graphite, metal-coated graphite (e.g., nickel-coated graphite, copper-coated graphite, and the like), and the like. Examples of suitable thermally conductive fillers which can be employed in the practice of the present invention include graphite, aluminum nitride, silicon carbide, boron nitride, diamond dust, alumina, and the like. Compounds, which act primarily to modify rheology, include polysiloxanes, silica, fumed silica, fumed alumina, fumed titanium dioxide, calcium carbonate, and the like.

The acyloxy curatives described in this invention can be prepared through a variety of methods known in the art. These synthetic methods include, but are not limited to, the reaction of phenolic compounds with carboxylic acid anhydrides, optionally in the presence of a catalyst. They can be prepared through the reaction of phenols with carboxylic acid chlorides. They may also be prepared via the condensation of phenols and carboxylic acids in the presence of a dehydrating agent, such as N,N′-dicyclohexylcarbodiimide.

The N-acyl curatives of this invention can also be prepared via a number of methods from the corresponding imides. These methods include all of those previously described for the preparation of acyloxy compounds. Thus, the N-acyl compounds may be prepared via the reaction of imides with carboxylic acid anhydrides, optionally in the presence of a catalyst. They can be prepared through the reaction of imides with carboxylic acid chlorides, optionally in the presence of a basic acid acceptor. They can also be made via the direct condensation of an imide and a carboxylic acid in the presence of a dehydrating agent.

### Adhesive Paste Compositions Containing Compounds of the Invention

In certain embodiments, the present invention provides adhesive compositions that are of various consistencies including, liquids, gels, pastes and solids. In one embodiment, the adhesive composition is a paste suitable for attaching an electronics die to a substrate (i.e., die-attach pastes). Die attach pastes of the invention are optimized for long-term reliability, rapid inline curing, long pot-life, viscosity and thixotropic control for fast automated dispensing and manufacturing.

In one embodiment, the present invention provides an adhesive composition that include 0.5 wt % to about 98 wt % based on total weight of the composition, of a compound according to the invention; 0 to about 90 wt % of a filler, based on total weight of the composition; 0.1 wt % to about 5 wt % of at least one curing initiator, based on total weight of the composition; and 0.1 wt % to about 4 wt %, of at least one coupling agent, based on total weight of the composition.

### B-Stageable Adhesives

In certain embodiments, the adhesive compositions and die attach pastes of the invention are b-stageable. As used herein, “B-stageable” refers to the properties of an adhesive having a first solid phase followed by a tacky rubbery stage at elevated temperature, followed by yet another solid phase at an even higher temperature. The transition from the rubbery stage to the second solid phase is thermosetting. However, prior to that, the thermosetting material behaves similarly to a thermoplastic material. Thus, such adhesives allow for low lamination temperatures while providing high thermal stability.

The B-stageable adhesive can be dispensed onto a die or a substrate by a variety of methods well known to those skilled in the art. In some embodiments, the adhesive is cast from solution using techniques such as spin coating, spray coating, stencil printing, screen printing, and the like. This dual stage cure is especially attractive for applications were it is desirable to apply an adhesive in liquid form, cure the material to a non-tacky thermoplastic state, and then cure this B-staged adhesive in a final heating step to bond two or more parts together. Thus, this dual stage cure method of the invention is particularly advantageous for silicon wafer back coatings. The original adhesive mixture can be spin coated onto the back of a silicon wafer. The coating can then be B-staged with heat or light. The coated wafers can then be diced to yield individual microelectronic components, which may be thermally attached directly to a substrate, and/or stacked together. The thermal “tacking step” re-liquifies the adhesive coating and provides a thermoplastic bond between the parts. The final bonding step involves a thermal (or in some cases light-based) cure to cross-link the B-staged adhesive composition. This method of assembly is highly desirable because it is easier to manufacture (especially for stacked die) than a traditional liquid adhesive assembly, and is much less expensive and wasteful compared to film-based adhesive technology.

In certain embodiments, a solvent may be employed in the practice of the invention. For example, when the B-stageable adhesive is spin-coated onto a circular wafer, it is desirable to have an even coating throughout the entire wafer, i.e., the solvent or solvent system should have the ability to deliver the same amount of adhesive to each point on the wafer. Thus, the adhesive will be evenly coated throughout, i.e., there will be the same amount of material at the center of the wafer as at the edges. Ideally, the adhesive is “Newtonian”, with a thixotropic slope of 1.0. In certain embodiments, the solvent or solvent systems used to dispense the B-stageable adhesive have slopes ranging from 1.0 to about 1.2.

In some instances, the B-stageable adhesive is dispensed onto the backside of a die that has been coated with a polyimide. Thus, the solvent or solvent system used to dispense the B-stageable adhesive should not have any deleterious effects on the polyimide coating. To achieve this goal, in certain embodiments, the solvent system will include a polar solvent in combination with a nonpolar solvent. Typically, the polar solvent is suitable for use with the [compound described herein] in B-stageable adhesives, and the nonpolar solvent is a non-solvent for the [compound]. In addition, the polar solvent typically has a lower boiling point than the non-polar solvent. Without wishing to be to be limited to a particular theory, it is believed that when the adhesive is dispensed and then B-staged, the lower boiling polar solvent escapes first, leaving behind only the nonpolar non-solvent, essentially precipitating the oligomer uniformly and leaving the polyimide film undamaged.

In some embodiments, the solvent or solvent system has a boiling point ranging from about 150° C. up to about 300° C. In some embodiments, the solvent system is a combination of dimethyl phthalate (DMP), NOPAR 13, and terpineol. In other embodiments, the solvent system is a 1:1 (by volume) ratio of terpineol and NOPAR 13.

In general, adhesive compositions such as die-attach pastes and B-stageable adhesive compositions of the invention, will cure within a temperature range of 80-220° C., and curing will be effected within a length of time of less than 1 minute up to about 60 minutes. The B-stageable adhesive composition may be pre-applied onto either a semiconductor die or onto a substrate. As will be understood by those skilled in the art, the time and temperature curing profile for each adhesive composition will vary, and different compositions can be designed to provide the curing profile that will be suited to a particular industrial manufacturing process.

Additional Compounds.

In certain embodiments, the compositions of the invention, such as adhesives (including die-attach paste adhesives), may contain modifiers that lend additional flexibility and toughness to the resultant cured adhesive. Such modifiers may be any thermoset or thermoplastic material having a T_{g} of 50° C. or less, and typically will be a polymeric material characterized by free rotation about the chemical bonds, the presence of ether groups, and the absence of ring structures. Suitable such modifiers include polyacrylates, poly(butadiene), polyTHF (polymerized tetrahydrofuran, also known as poly(1,4-butanediol)), CTBN (carboxy-terminated butadiene-acrylonitrile) rubber, and polypropylene glycol. When present, toughening compounds may be present in an amount up to about 15 percent by weight of [a compound according to formula I] and any other monomer in the adhesive.

Inhibitors for free-radical cure may also be added to the adhesive compositions and die-attach pastes described herein to extend the useful shelf life. Examples of free-radical inhibitors include hindered phenols such as 2,6-di-tert-butyl-4-methylphenol; 2,6-di-tert-butyl-4-methoxyphenol; tert-butyl hydroquinone; tetrakis(methylene(3,5-di-tert-butyl-4-hydroxyhydrocinnamate))benzene; 2,2′-methylenebis(6-tert-butyl-p-cresol); and 1,3,5-trimethyl-2,4,6-tris(3′,5′-di-tert-butyl-4-hydroxybenzyl)benzene. Other useful hydrogen-donating antioxidants such as derivatives of p-phenylenediamine and diphenylamine. It is also well know in the art that hydrogen-donating antioxidants may be synergistically combined with quinones and metal deactivators to make a very efficient inhibitor package. Examples of suitable quinones include benzoquinone, 2-tert butyl-1,4-benzoquinone; 2-phenyl-1,4-benzoquinone; naphthoquinone, and 2,5-dichloro-1,4-benzoquinone. Examples of metal deactivators include N,N′-bis(3,5-di-tert-butyl-4-hydroxyhydrocinnamoyl)hydrazine; oxalyl bis(benzylidenehydrazide); and N-phenyl-N′-(4-toluenesulfonyl)-p-phenylenediamine Nitroxyl radical compounds such as TEMPO (2,2,6,6-tetramethyl-1-piperidnyloxy, free radical) are also effective as inhibitors at low concentrations. The total amount of antioxidant plus synergists typically falls in the range of 100 to 2000 ppm relative to the weight of total base resin. Other additives, such as adhesion promoters, in types and amounts known in the art, may also be added.

The adhesive compositions, such as die-attach paste adhesives, described herein will generally perform within the commercially acceptable ranges for die attach adhesives. Commercially acceptable values for die shear for the adhesives on a 80×80 mil² silicon die are in the range of greater than or equal to 1 kg at room temperature, and greater than or equal to 0.5 kg at 260° C. Acceptable values for warpage for a 500×500 mil² die are in the range of less than or equal to 70 Nm at room temperature.

Fillers.

In some embodiments, fillers are contemplated for use in the practice of the present invention, which can be electrically conductive and/or thermally conductive, and/or fillers which act primarily to modify the rheology of the resulting composition. Examples of suitable electrically conductive fillers that can be employed in the practice of the present invention include silver, nickel, copper, aluminum, palladium, gold, graphite, metal-coated graphite (e.g., nickel-coated graphite, copper-coated graphite, and the like), and the like. Examples of suitable thermally conductive fillers that can be employed in the practice of the present invention include graphite, aluminum nitride, silicon carbide, boron nitride, diamond dust, zinc oxide, alumina, and the like. Compounds which act primarily to modify rheology include polysiloxanes (such as polydimethyl siloxanes), silica, fumed silica, fumed alumina, fumed titanium dioxide, calcium carbonate and the like.

### Underfill Compositions

During its normal service life, an electronic assembly is subjected to repeated cycles of widely varying temperature. Due to the differences in the coefficient of thermal expansion between the electronic component, the solder, and the substrate, thermal cycling can stress the components of the assembly and cause it to fail. To prevent the failure, the gap between the component and the substrate is filled with an underfill material to reinforce the solder material and to absorb some of the stress of the thermal cycling.

In practice, the underfill material is typically dispensed into the gap between and electronic component (such as a flip-chip) and the substrate by injecting the underfill along two or more sides of the component, with the underfill material flowing, usually by capillary action, to fill the gap. Alternatively, underfilling can be accomplished by backfilling the gap between the electronic component and the substrate through a hole in the substrate beneath the chip. In either method, the underfill material must be sufficiently fluid to permit filling very small gaps.

The requirements and preferences for underfills are well known in the art. Specifically, monomers for use in underfills should have high T_{g} and low α₁ CTE, important properties. A high T_{g}, preferably in the range of at least about 100-135° C., and a low modulus or α₁, preferably lower than about 60-65 ppm/° C., are optimal for underfill compositions.

Thus, the present invention provides underfill compositions including at least one compound or composition of the invention. Optionally, the underfill will also contain a fluxing agent and/or a filler.

Two prominent uses for underfill technology are in packages known in the industry as flip-chip, in which a chip is attached to a lead frame, and ball grid array, in which a package of one or more chips is attached to a printed wire board.

The underfill encapsulation may take place after the reflow of the metallic or polymeric interconnect, or it may take place simultaneously with the reflow. If underfill encapsulation takes place after reflow of the interconnect, a measured amount of underfill encapsulant material will be dispensed along one or more peripheral sides of the electronic assembly and capillary action within the component-to-substrate gap draws the material inward. The substrate may be preheated if needed to achieve the desired level of encapsulant viscosity for the optimum capillary action. After the gap is filled, additional underfill encapsulant may be dispensed along the complete assembly periphery to help reduce stress concentrations and prolong the fatigue life of the assembled structure. The underfill encapsulant is subsequently cured to reach its optimized final properties.

If underfill encapsulation is to take place simultaneously with reflow of the solder or polymeric interconnects, the underfill encapsulant, which can include a fluxing agent if solder is the interconnect material, first is applied to either the substrate or the component; then terminals on the component and substrate are aligned and contacted and the assembly heated to reflow the metallic or polymeric interconnect material. During this heating process, curing of the underfill encapsulant occurs simultaneously with reflow of the metallic or polymeric interconnect material.

A wide variety of acids are contemplated for use as the acidic fluxing agent. Typically, the acidic fluxing agent is a carboxylic acid such as, for example, 3-cyclohexene-1-carboxylic acid, 2-hexeneoic acid, 3-hexeneoic acid, 4-hexeneoic acid, acrylic acid, methacrylic acid, crotonic acid, vinyl acetic acid, tiglic acid, 3,3-dimethylacrylic acid, trans-2-pentenoic acid, 4-pentenoic acid, trans-2-methyl-2-pentenoic acid, 2,2-dimethyl-4-pentenoic acid, trans-2-hexenoic acid, trans-3-hexenoic acid, 2-ethyl-2-hexenoic acid, 6-heptenoic acid, 2-octenoic acid, (+/−)-citronellic acid, (R)-(+)-citronellic acid, (S)-(−)-citronellic acid, undecylenic acid, myristolic acid, palmitoleic acid, oleic acid, elaidic acid, cis-11-eicosenoic acid, erucic acid, nervonic acid, cis-3-chloroacrylic acid, trans-3-chloroacrylic acid, 2-bromoacrylic acid, 2-(trifluoromethyl)acrylic acid, 2-(bromomethyl)acrylic acid, 2-cyclopentene-1-acetic acid, (1R-trans)-2-(bromomethyl)-2-methyl-3-methylenecyclopentaneacetic acid, 2-acetamidoacrylic acid, 5-norbornene-2-carboxylic acid, 3-(phenylthio)acrylic acid, trans-styrylacetic acid, trans-cinnamic acid, alpha-methylcinnamic acid, alpha-phenylcinnamic acid, 2-(trifluoromethyl)cinnamic acid, 2-chlorocinnamic acid, 2-methoxycinnamic acid, cis-2-methoxycinnamic acid, 3-methoxycinnamic acid, 4-methylcinnamic acid, 4-methoxycinnamic acid, 2,5-dimethoxycinnamic acid, 3,4-(methylenedioxy)cinnamic acid, 2,4,5-trimethoxycinnamic acid, 3-methylindene-2-carboxylic acid, and trans-3-(4-methylbenzoyl)acrylic acid, oxalic acid, malonic acid, methylmalonic acid, ethylmalonic acid, butylmalonic acid, dimethylmalonic acid, diethylmalonic acid, succinic acid, methylsuccinic acid, 2,2-dimethylsuccinic acid, 2-ethyl-2-methylsuccinic acid, 2,3-dimethylsuccinic acid, meso-2,3-dimethylsuccinic acid, glutaric acid, (+/−)-2-methylglutaric acid, 3-methylglutaric acid, 2,2-dimethylglutaric acid, 2,4-dimethylglutaric acid, 3,3-dimethylglutaric acid, adipic acid, 3-methyladipic acid, (R)-(+)-3-methyladipic acid, 2,2,5,5-tetramethylhexanedioic acid, pimelic acid, suberic acid, azelaic acid, 1,10-decanedicarboxylic acid, sebacic acid, 1,11-undecanedicarboxylic acid, undecanedioic acid, 1,12-dodecanedicarboxylic acid, hexadecanedioic acid, docosanedioic acid, tetracosanedioic acid, tricarballylic acid, beta-methyltricarballylic acid, 1,2,3,4-butanetetracarboxylic acid, itaconic acid, maleic acid, fumaric acid, citraconic acid, mesaconic acid, trans-glutatonic acid, trans-beta-hydromuconic acid, trans-traumatic acid, trans,trans-muconic acid, cis-aconitic acid, trans aconitic acid, (+/−)-chlorosuccinic acid, (+/−)-bromosuccinic acid, meso-2,3-dibromosuccinic acid, hexa fluoroglutaric acid, perfluoroadipic acid hydrate, dibromo-maleic acid, DL-malic acid, D-malic acid, L-malic acid, (R)-(−)-citramalic acid, (S)-(+)-citramalic acid, (+/−)-2-isopropylmalic acid, 3-hydroxy-3-methylglutaric acid, ketomalonic acid monohydrate, DL-tartaric acid, L-tartaric acid, D-tartaric acid, mucic acid, citric acid, citric acid monohydrate, dihydroflumaric acid hydrate, tetrahydrofuran-2,3,4,5-tetracarboxylic acid, mercaptosuccinic acid, meso-2,3-dimercaptosuccinic acid, thiodiglycolic acid, 3,3′-thiodipropionic acid, 3,3′-dithiodipropionic acid, 3-carboxypropyl disulfide, (+/−)-2-(carboxymethylthio) succinic acid, 2,2′,″,2″-[1,2-ethanediylidenetetrakis(thio)]-tetrakisacetic acid, nitromethanetrispropionic acid, oxalacetic acid, 2-ketoglutaric acid, 2-oxoadipic acid hydrate, 1,3-acetonedicarboxylic acid, 3-oxoadipic acid, 4-ketopimelic acid, 5-oxoazelaic acid, chelidonic acid, 1,1-cyclopropanedicarboxylic acid, 1,1-cyclobutanedicarboxylic acid, (+/−)-trans-1,2-cyclobutanedicarboxylic acid, trans-DL-1,2-cyclopentanedicarboxylic acid, 3,3-tetramethyleneglutaric acid, (1R,3S)-(+)-camphoric acid, (1S,3R)-(−)-camphoric acid, (+/−)-cyclohexylsuccinic acid, 1,1-cyclohexanediacetic acid, (+/−)-trans-1,2-cyclohexanedicarboxylic acid, (+/−)-1,3-cyclohexanedicarboxylic acid, trans-1,2-cyclohexanedicarboxylic acid, 1,4-cyclohexanedicarboxylic acid, 1,3-adamantanedicarboxylic acid, 3-methylenecyclopropane-trans-1,2-dicarboxylic acid, cis-5-norbornene-endo-2,3-dicarboxylic acid, 1,3,5-cyclohexanetricarboxylic acid, 1,3,5-cyclohexanetricarboxylic acid, kemp's triacid, (1alpha.3alpha.5beta)-1,3,5-trimethyl-1,3,5-cyclohexanetricarboxylic acid, 1,2,3,4-cyclobutane-tetracarboxylic acid, and 1,2,3,4,5,6-cyclo-hexanehexacarboxylic acid monohydrate, phenylmalonic acid, benzylmalonic acid, phenylsuccinic acid, 3-phenylglutaric acid, 1,2-phenylenediacetic acid, homophthalic acid, 1,3-phenylenediacetic acid, 4-carboxyphenoxyacetic acid, 1,4-phenylenediacetic acid, 2,5-dihydroxy-1,4-benzenediacetic acid, 1,4-phenylenediacrylic acid, phthalic acid, isophthalic acid, 1,2,3-benzenetricarboxylic acid hydrate, terephthalic acid, 1,2,4-benzenetricarboxylic acid, 1,2,4,5-benzenetetracarboxylic acid, mellitic acid, 3-(carboxymethylaminomethyl)-4-hydroxybenzoic acid, 4-methylphthalic acid, 2-bromoterephthalic acid, 4-bromoisophthalic acid, 4-hydroxyisophthalic acid, 4-nitrophthalic acid, nitrophthalic acid, 1,4-phenylenedipropionic acid, 5-tert-butylisophthalic acid, 5-hydroxyisophthalic acid, 5-nitroisophthalic acid, 5-(4-carboxy-2-nitrophenoxy)-isophthalic acid, diphenic acid, 4,4′-biphenyldicarboxylic acid, 5,5′dithiobis(2-nitrobenzoic acid), 4-[4-(2-carboxybenozoyl)phenyl]-butyric acid, pamoic acid, 1,4-naphthalenedicarboxylic acid, 2,3-naphthalenedicarboxylic acid, 2,6-naphthalenedicarboxylic acid, 1,4,5,8-naphthalene-tetracarboxylic acid hydrate, 2,7-di-tert-butyl-9,9-dimethyl-4,5-xanthenedicarboxylic acid, and the like.

A particularly useful carboxylic acid for the preparation of the latent fluxing agents of the present invention is DIACID 1550®, a monocyclic C₂₁ dicarboxylic acid product derived from tall oil fatty acids, commercially available from Westvaco Corporation.

### Mold Compounds and Compositions

In the electronics industry, a semiconductor chip or die mounted to a “package” substrate may be overmolded with a mold compound to provide a level of protection from environmental effects such as moisture and contaminants.

In terms of reliability performance, various properties of mold compositions materials are generally considered important. The properties desirable for mold compositions are known in the art. See, for example, U.S. Pat. Nos. 7,294,915, 6,512,031, and 6,429,238. These include low CTE, low modulus, adhesion, and high fracture toughness of the cured resin. A high T_{g}, preferably in the range of at least about 100-135° C., and a low modulus or α₁, preferably lower than about 60-65 ppm/° C., are optimal for mold compositions. See, for example, U.S. Pat. Nos. 6,512,031 and 5,834,848. A typical overmolding process places a solid or semi-solid molding compound over the chip using a mold press. The package is then transferred through a heated mold that causes the molding compound to flow and encapsulate the chip.

Mold compositions are highly filled compositions. They are typically filled with silica. This high filler loading is critical to their performance in terms of CTE (coefficient of thermal expansion), flame retardance, and thermal conductivity.

Certain compounds of the present invention have properties desirable of mold compounds. Specifically, high T_{g} and low α₁ CTE. A high T_{g}, preferably in the range of at least about 100-135° C., and a low modulus or α₁, preferably lower than about 60-65 ppm/° C., are optimal for mold compositions. Thus, the present invention provides mold compositions containing at least one compound or composition described herein.

### Thermal Interface Materials

Electronic devices containing semiconductors generate a significant amount of heat during operation. The level of heat generated is related to the performance of the semiconductor, with less highly performing devices generating lower levels of heat. In order to cool the semiconductors, which must be cooled in order to obtain appreciable performance, heat sinks are affixed to the device.

In operation, heat generated during use is transferred from the semiconductor to the heat sink where the heat is harmlessly dissipated. The TIM ideally provides intimate contact between the heat sink and the semiconductor to facilitate the heat transfer.

Various forms of TIMs can be used in semiconductor manufacturing, including but not limited to, liquids, gels, pastes, films, tapes, pre-cured, foams, rubbers and the like. In certain embodiments of the invention, the TIM is an adhesive, which, when cured is converted to a strong, but stress-relieving elastomer that holds the heat sink in place without the use of mechanical fasteners. Adhesives are also used to adhere and couple entire circuit boards to metal base plates or outer cases.

Certain compounds of the invention are suited for use in TIMs, particularly as adhesive components of a Thermal Interface Material. Thus, the present invention provides Thermal Interface Materials that comprise at least one compound or composition described herein and a thermally conductive material, such as a metallic particle, a conductive non-metal particle, a metal particle having an outer metallic surface (e.g. a coated metal particle), a conductive non-metal particle having an outer metallic surface (e.g. a coated non-metal particle). Suitable metals will be known by those of skill in the art to include, for example silver, gold, platinum, palladium, nickel, aluminum, copper, and steel. Optionally, the TIM can include supporting structural elements such as spacers (e.g. beads), fibers (e.g. carbon fibers or nanotubues), mesh (e.g. a wire mesh) or the like.

According to another embodiment, the invention also provides methods of forming a thermal interface between first and second substrates, which includes the step of applying a Thermal Interface Material comprising at least one compound or composition of the invention to the at least one first substrate and optionally the at least one second substrate. Optionally, the Thermal Interface Material is an adhesive and optionally, the Thermal Interface Material is cured following application. Application of the TIM can include any method or combination of methods known in the art, including, but not limited to at least one of: encapsulation, coating, filling, embedding, spinning, spraying, flowing, mounting, adhering, dispensing, depositing and the like.

### Assemblies

The present invention also provides assemblies of components adhered together by the above-described adhesive compositions (e.g., B-stageable adhesives and die-attach pastes) of the invention. Thus, for example, assemblies comprising a first article adhered to a second article by a cured aliquot of an adhesive composition containing at least one compound of the invention are provided. Articles contemplated for assembly employing invention compositions include electronic components such as dies, memory devices (e.g. as flash memory devices), ASIC devices, microprocessors, and other microelectronic components. Assemblies also include microelectronic devices, such as copper lead frames, Alloy 42 lead frames, silicon dice, gallium arsenide dice, and germanium dice, that are adhered to a substrate by a cured aliquot of the above-described adhesive compositions.

Additional embodiments of the invention include adhesively bonded structures containing at least one compound described herein. Non-limiting examples of the adhesively bonded structures include electronic components bonded to a substrate, and circuit components bonded to printed wire boards. In other embodiments of the invention, articles of manufactures can be comprised substantially of a cured amount of the composition described herein, such as an industrial, marine, automotive, airline, aerospace, sporting goods, medical or dental article. Such articles of manufacture can also include fillers, extenders, pigments and/or reinforcing materials along with the compositions disclosed herein.

Conditions suitable to cure invention die attach paste adhesives include subjecting the above-described assembly to a temperature of less than about 200° C. for about 0.5 up to 2 minutes. This rapid, short duration heating can be accomplished in a variety of ways, e.g., with an in-line heated rail, a belt furnace, or the like. Optionally, the material can be oven cured at 150-220° C.

In other embodiments the invention provides methods for attaching a semiconductor die to a substrate. Such methods can be performed, for example, by (a) applying a die-attach adhesive composition described herein to the substrate and/or the semiconductor die, (b) bringing the substrate and the die into contact to form an assembly, such that the substrate and the die are separated only by the die-attach adhesive composition applied in step (a), and (c) subjecting the assembly to conditions sufficient to cure the die-attach paste, thereby attaching the semiconductor die to the substrate.

In certain embodiments the assemblies are packages comprising a die or other heat-generating electronic device and an integrated heat spreader (IHS) or other heat sink and the these elements are separated only by an adhesive composition as described above, wherein the adhesive composition is or forms upon curing, a Thermal Interface Material.

### Methods of Using Compounds and Compositions of the Invention

According to the present invention, methods for adhesively attaching a first article to a second article are provided. Such methods can be performed, for example, by a) applying an adhesive composition of the invention to the first article, the second article or both the first and second articles; b) contacting the first article and the second article, where the first article and the second article are separated only by the adhesive composition applied in step a); and c) curing the adhesive composition applied in step a), thereby adhesively attaching the first article to the second article.

In one aspect of this method, the first and second articles are a semiconductor die and a substrate, respectively. In other embodiments, the articles can be, for example, CPU's, microprocessors, flip chips, package lids, optical components (e.g., laser diodes, multiplexers and transceivers); sensors, power supplies, high speed mass storage drives, motor controls, high voltage transformers, automotive mechatronics and the like.

According to one aspect the adhesive is a die attach paste. The method can include the steps of applying the adhesive composition (e.g. die attach paste) to the substrate, the semiconductor die, or both the substrate and the semiconductor die; b) melting the adhesive composition applied in step a); c) contacting the semiconductor device and the substrate, where the die and substrate are separated only by the adhesive composition applied in step a); and d) curing the adhesive composition applied in step a), thereby adhesively attaching the semiconductor device to the substrate. Applying the adhesive composition can include spin-coating, spray coating, stencil printing, screen printing and other methods well known in the art.

It will be understood those of skill in the art that using the compounds and methods of the present invention, it is possible to prepare adhesives having a wide range of cross-link density by the judicious choice and amount of a compound of the invention. The greater proportion of polyfunctional compounds reacted, the greater the cross-link density. If thermoplastic properties are desired, the adhesive compositions can be prepared from (or at least contain a higher percentage of) mono-functional compounds to limit the cross-link density. A minor amount of poly-functional compounds can be added to provide some cross-linking and strength to the composition, provided the amount of poly-functional compounds is limited to an amount that does not diminish the desired thermoplastic properties. Within these parameters, the strength and elasticity of individual adhesives can be tailored to a particular end-use application.

In still further embodiments, the invention provides B-stageable type methods for adhesively attaching a semiconductor die to a substrate. Such methods can be performed, for example, by applying an invention adhesive composition to the substrate, the semiconductor device or both the substrate and the semiconductor device; melting the applied adhesive composition applied; (c) contacting the semiconductor device and the substrate, such that the die and substrate are separated only by the applied adhesive composition; and curing the applied adhesive composition, thereby attaching the semiconductor device to the substrate. The invention will now be further described with reference to the following non-limiting examples.

### EXAMPLES

It should be noted that for each of the following exemplary compounds, where the substitution on the backbone is asymmetric or where the molecule has been extended with another bi-functional reactant, that only a single representative structure is shown. That is to say, such compounds are in fact composed of statistical distributions of several molecules. Only the most predominant species in these distributions are shown.

### Example 1

### Preparation of a Phenol Functional Curative

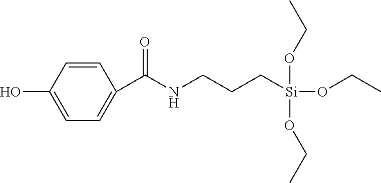 [SMILES: CCO[Si](CCCNC(=O)c1ccc(O)cc1)(OCC)OCC]

A 500 mL, 2-neck flask was charged with 44.27 g (0.2 mole) 3-aminopropyl triethoxysilane, and 20.79 g (0.21 mole) butyl-4-hydroxybenzoate. The flask was equipped with a Dean-Stark trap condenser and bubbler. The mix was then stirred magnetically and heated at 170° C. under an argon blanket for 41.25 hours. Approximately 18.0 mL of butanol was collected in the trap (theoretical yield=18.3 mL). The mix was sparged with argon at 170° C. for 45 min. The product was poured out of the container while still hot. It was a very viscous amber liquid at room temperature. A total of 65.6 g of product was recovered (96.0% of theoretical yield). An FTIR run on this compound had a broad —OH absorbance as well as strong absorptions at 2930, 1688, 1605, 1531, 1270, 1162, 1073, 953, 848, and 769 wavenumbers.

### Example 2

### Preparation of a Phenyl Acetate Curative/Coupling Agent

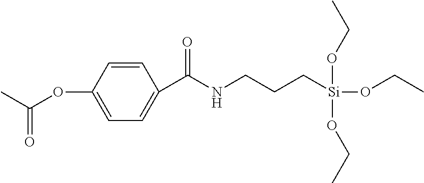 [SMILES: CCO[Si](CCCNC(=O)c1ccc(OC(C)=O)cc1)(OCC)OCC]

A portion of the compound obtained as described in EXAMPLE 1 was converted to the phenyl acetate shown above. A 250 mL flask was charged with 37.15 g (0.11 mole) of the compound from EXAMPLE 1, 11.02 g (0.11 mole) acetic anhydride, and 0.1 g of dimethylaminopyridine. This mix was heated and stirred at 90° C. for 2 hours. The acetic acid side product was then removed via rotary evaporation and sparge. The final product weighted 40.5 g (97% of theoretical yield). An FTIR spectrum of this material revealed a small amide N—H stretch at 3318 along with prominent absorptions at 2934, 1760, 1639, 1501, 1268, 1198, 1073, 913, and 762 wavenumbers.

### Example 3

### Comparison of Epoxy Formulations Containing Phenol Functional Curative to the Corresponding Phenyl Acetate

The following example demonstrates the remarkably improved adhesion for an epoxy resin cured using an acyloxy coupling agent from EXAMPLE 2, versus the analogous phenol-functional coupling agent from EXAMPLE 1, which does not contain the acyloxy moiety.

TABLE 1
Properties of Epoxy Formulations Containing a Phenol Functional
Curative and Corresponding Phenyl Acetate

| Composition | Formulation 1 | Formulation 2 |
|---|---|---|
| Tactix 756 epoxy | 31.6% | 31.6% |
| Ricon | 15.2% | 15.2% |
| Terpineol | 36.7% | 36.7% |
| Curezol 2MA | 1.1% | 1.1% |
| Silica | 1.1% | 1.1% |
| EXAMPLE 1 compound | 2.1% | 0.0% |
| EXAMPLE 2 compound | 0.0% | 2.1% |
| Adhesion*, kg force | 11.1 | 31.5 |
| (300 × 300 Si on ceramic | | |
| @260° C.-175° C. 60 min | | |
| ramp cure + 4 hour PMC) | | |

*The die-shear adhesion was measured as kg force on a Dage Series 4000.

The phenyl acetate functional coupling agent had almost three times the 260° C. adhesion of its phenol functional counterpart. Even at a relatively low percentage of the entire composition, the acyloxy compound is a superior epoxy curative compared to the free phenol.

### Example 4

### Preparation of Acrylic Acid 2-(4-Hydroxy-Phenyl)-Ethyl Ester Curative for Hybrid Epoxy and Free-Radical Cure Adhesives

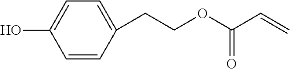

The compound shown above was designed for use as a possible hybrid monomer for adhesive compositions comprising epoxies and free-radical cure monomers. A 500 mL, two-neck flask was charged with 27.63 g (0.2 mole) 2-(4-hydroxyphenyl)ethyl alcohol, 150 mL toluene, 18.02 g (0.25 mole) acrylic acid, 40 mg hydroquinone, and 1.5 g methanesulfonic acid. The flask was equipped with a trap and condenser. The mixture was then refluxed under a mild air sparge for 1.5 hours. A total of 3.7 mL water (theoretical yield=3.6 mL) was collected in the trap. The mixture was then cooled and treated with 12 g sodium bicarbonate plus 3 g water until carbon dioxide evolution ceased. The mix was dried with 8 g magnesium sulfate and then passed over 15 g silica gel. The toluene was removed to yield 38.33 g (99.7% of theoretical yield) of a yellow liquid. The compound had prominent absorptions at 3394, 1699, 1635, 1614, 1514, 1408, 1264, 1196, 1059, 981, and 811 wavenumbers.

### Example 5

### Preparation of Acrylic Acid 2-(4-Acetoxy-Phenyl)-Ethyl Ester Curative for Hybrid Epoxy and Free-Radical Cure Adhesives

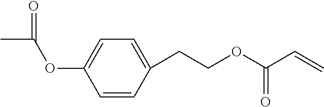 [SMILES: C=CC(=O)OCCc1ccc(OC(C)=O)cc1]

The phenyl acetate cousin of the compound described in EXAMPLE 4 was prepared according to an identical procedure except that 20.42 g (0.2 mole) acetic anhydride was added after the initial acrylate esterification was complete. This mixture was stirred overnight at 60° C. Work-up afforded 46.44 g (99.1% of theoretical yield) of a light yellow, low viscosity liquid. The compound had prominent absorptions at 1755, 1724, 1635, 1509, 1497, 1369, 1181, 1058, 984, 909, and 809 wavenumbers.

### Example 6

### Comparison of Epoxy Formulations Containing Hydroxy and Acetoxy Curatives

Two weight percent dicumyl peroxide was added to each of the compounds from Examples 4 and 5. These mixtures were evaluated by DSC and TGA. The results of these tests are shown in the following table:

TABLE 2
Properties of Epoxy Formulations Containing Acrylic Acid 2-(4-
Hydroxy-Phenyl)-Ethyl Ester Curative or Corresponding Phenyl Acetate

| Example (w/2% Dicup) | Retained Weight @300° C. | Cure Energy (J/g) |
|---|---|---|
| 4 | 40.1% | 6.6 |
| 5 | 89.7% | 223.8 |

The results in Table 2 indicate that the cure of the acrylate function for the EXAMPLE 4 compound was practically non-existent. This was also evident from the high weight loss for this example. The phenyl ester compound from EXAMPLE 5, by contrast, had a strong exotherm and almost 90% retained weight at 300° C. Capping the phenol with an ester function thus overcomes the inherent free-radical cure inhibition demonstrated by the free-phenol original compound.

### Example 7

### Preparation of a Mixed Acetate Propionate of Bisphenol A

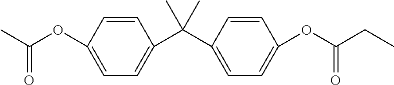 [SMILES: CCC(=O)Oc1ccc(C(C)(C)c2ccc(OC(C)=O)cc2)cc1]

A 250 mL flask was charged with 45.66 g (0.2 mole) bisphenol A, 20.42 g (0.1 mole) acetic anhydride, 26.04 g (0.1 mole) propionic anhydride, and 0.1 g DMAP catalyst). This mixture was stirred in a bath maintained at 90° C. for 1.5 hours. The residual acetic and propionic acids were then stripped off to yield a colorless liquid that weighed 64.5 g (99% of theoretical yield). It should be noted that the above representation of the example compound constitutes about 50% of the total product distribution, while the remainder is approximately a one to one mix of the diacetate and dipropionate. An advantage of this mixed product is that it has a lower melting point than any of the individual components. The mixed compound can remain as a stable supercooled liquid at room temperature for several days. It eventually crystallizes to a low melting solid. The bisacyloxy compound as a supercooled liquid had a 25° C., viscosity of 1,873 centipoise. An FTIR on this liquid showed prominent absorptions at 2971, 1756, 1504, 1367, 1166, 1015, 909, and 846 wavenumbers.

### Example 8

### Epoxy Generated from Mixed Acetate Propionate of Bisphenol A

A one to one equivalent mix of the diglycidyl ether of Bisphenol A (DER 332) and the bisacyloxy compound from EXAMPLE 7 was prepared. This mixture was catalyzed with two weight percent of DMAP (N,N-dimethylaminopyridine). The cure of this mixture was analyzed via DSC and TGA. The cure (via DSC) was found to give a single symmetrical peak with an onset of 123° C., a peak maximum of 143° C. and a cure energy of 182 joules per gram. The mix had 98.82% retained weight at 300° C. and a decomposition onset (TGA, 10° C./min., air purge) of 420° C. These results indicated that the DMAP catalyzed cure of the bisacyloxy compound from EXAMPLE 7 was a synergistic co-cure, where both the acyloxy and epoxy functions fully participated.

### Example 9

### Preparation of Diacetate of 2,2′-Diallylbisphenol A

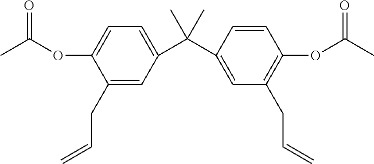 [SMILES: C=CCc1cc(C(C)(C)c2ccc(OC(C)=O)c(CC=C)c2)ccc1OC(C)=O]

A 250 mL, single-neck flask was charged with 30.84 g (0.1 mole) o,o′-diallylbisphenol A, 20.42 g (0.2 mole) acetic anhydride, and 0.5 g DMAP. This mixture was stirred at 85° C. for one hour and the residual acetic acid was then removed to give 39.3 g (100% of theoretical yield) of a light orange liquid. The compound had prominent absorptions at 1759, 1495, 1367, 1197, 1117, 1008, 911, and 828 wavenumbers. The viscosity of this liquid was 2600 centipoise at 25° C. The viscosity of the o,o′-diallylbisphenol A starting material, by contrast, was 15,400 centipoise at the same temperature.

### Example 10

### Comparison of Acyloxy Curative with Corresponding Phenolic Curative

The following table shows the benefits of the acyloxy curative over a phenolic curative. The synthesis of the diacetate of o,o′-diallyl bisphenol A phenol was described in Example 9. Compositions containing the o,o′-diallyl bisphenol A phenol starting material and the corresponding diacetate were use to compare the properties of both materials when cured with bisphenol A epoxy (DER 332 from Dow Chemical). Both materials were formulated as a 1:1 epoxy equivalent and two different catalysts were used for comparison. Anjicure PN-23 is a latent aliphatic amine catalyst and DMAP(N,N-dimethyaminopyridine) is a tertiary amine catalyst. Each catalyst was used at the level of 2% of the total resin.

The data shown in Table 3 below demonstrate the superior properties for the phenyl acetate curative in the terms of moisture absorption, adhesion, weight loss, cure energy, and viscosity. The ortho diallyl bis A phenol either had unacceptable worklife with the DMAP and cured to a thermoplastic under these conditions making it difficult to collect the TMA data.

TABLE 3
Properties of Epoxy Formulations Containing of Acyloxy Curative and
Corresponding Phenolic Curative

| | | | | |
|---|---|---|---|---|
| 1:1 equivalents | 115-51A | 115-51B | 115-51C | 115-51D |

Phenol Acetate Experiments

| | | | | |
|---|---|---|---|---|
| DER 332 % | 48 | 48 | 54 | 54 |
| ortho diallyl Bis A | 52 | 52 | | |
| phenol % | | | | |
| ortho diallyl Bis A | | | 46 | 46 |
| phenylacetate % | | | | |
| Ajicure PN-23 (2% level) | X | | X | |
| DMAP (2% level) | | X | | X |

Dynamic TGA
(10° C./min)

| | | | | |
|---|---|---|---|---|
| Weight loss at 300° C. % | 1.1 | 2.1 | 0.5 | 1.2 |
| Onset for | 398 | 402 | 391 | 395 |
| decompostion ° C. | | | | |

DSC (10° C./min)

| | | | | |
|---|---|---|---|---|
| onset for cure ° C. | 85 | 50 | 75 | 75 |
| Peak cure | 154 | 124 | 150 | 135 |
| temperature ° C. | | | | |
| Peak energy J/g | 155 | 107 | 187 | 178 |

TMA

| | | | | |
|---|---|---|---|---|
| Alpha 1 | NA* | NA | 62 | 48 |
| Tg | NA | NA | 57 | 53 |
| Alpha 2 | NA | NA | 324 | 315 |
| RT modulus (70% Ag) | 4.5 GPa | NA | 6.5 GPa | 5.8 GPa |
| Viscosity 5 rpm | 64 Kcps | cured | 18 Kcps | 18 Kcps |
| (70% Ag) | | within | | |
| | | hours | | |
| 260° C. die shear | <1 kgf | | 2.7 kgf | 3.0 kgf |
| 150² mil dieBare Cu | | | | |
| Moisture Absorption | 1.28 | | 0.78 | 0.60 |
| 96 hours in 85/85% | | | | |

*Comments
Thermoplastic, TMA NA

### Example 11

### Preparation of the Bis-4-Acetoxybenzoate of Dimer Diol

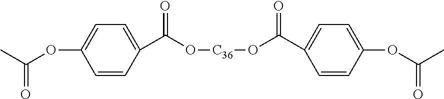

A one liter, single neck flask was charged with 55.25 g (0.4 mole) 4-hydroxybenzoic acid, 107.4 g (0.2 mole) dimer diol, 250 mL toluene, and 20 g of dry Amberlyst 46 resin. A magnetic stir bar was placed in the flask and a trap, condenser, and bubbler were attached. The mix was refluxed under an argon blanket for twenty-eight hours and 7.9 mL water (theoretical yield=7.2 mL) was collected. The Amberlyst catalyst was filtered out using a fritted funnel and the toluene was then removed. The product was then reacted with 40.84 g (0.4 mole) acetic anhydride plus 0.2 g DMAP at 90° C. for 1.5 hours. The acetic acid side product was then removed to yield 168.7 g (98% of theoretical yield) of a light yellow liquid. This compound had prominent infrared absorptions at 2922, 2853, 1763, 1720, 1271, 1190, 1158, 1115, 1016, and 912 wavenumbers.

### Example 12

### Epoxy Mixtures with Bis-4-Acetoxybenzoate of Dimer Diol

Mixtures were made using the DER 332 epoxy, a combination of two catalysts, and various levels of the curative from EXAMPLE 11. The mixture compositions are shown in Table 4 and the cured properties of those compositions are shown in Table 5.

TABLE 4
Epoxy + EXAMPLE 11 Curative Compositions

| Mixture | DER 332 % | Exp. 11 % | Anjicure PN23 % | Zn Undecylate % |
|---|---|---|---|---|
| A | 85 | 5 | 5 | 5 |
| B | 80 | 10 | 5 | 5 |
| C | 75 | 15 | 5 | 5 |
| D | 70 | 20 | 5 | 5 |

TABLE 5
Thermoset Cured Properties From Table 4 Mixtures

| | Alpha 1 | | | |
|---|---|---|---|---|
| Mixture | (ppm/° C.) | Alpha 2 (ppm/° C.) | T_{g} (° C.) | Moisture Uptake^{a} |
| A | 63.2 | 210 | 106.5 | 1.55 |
| B | 66.4 | 212 | 105.9 | 1.02 |
| C | 69.5 | 221 | 90.3 | 0.87 |
| D | 76.5 | 231 | 72.5 | 0.74 |

Percent weight gain at 85° C./85 RH over 168 hours

It is apparent from the results given in Table 5 that small additions of the curative from EXAMPLE 11 can dramatically reduce the moisture uptake, without significantly reducing the glass transition temperature or increasing the thermal expansion coefficient. Higher addition levels of this curative further reduced moisture uptake, but the thermoset cured property parameters were more severely impacted.

### Example 13

### Preparation of 2,7-dimethacryloxynapthalene

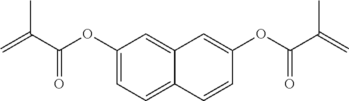 [SMILES: C=C(C)C(=O)Oc1ccc2ccc(OC(=O)C(=C)C)cc2c1]

A 500 mL, single-neck flask was charged with 16.02 g (0.1 mole) 2,7-dihydroxynaphthalene, 150 mL toluene, 30.8 g (0.2 mole) methacrylic anhydride, 30 mg of BHT, and 0.5 g DMAP. This mixture was stirred on an oil bath set at 65° C. for 72 hours. The residual methacrylic acid was neutralized with 30 g sodium bicarbonate plus 5 g water, and then dried over 12 g anhydrous magnesium sulfate. The mixture was passed over 12 g of silica gel and the toluene was removed to yield 25.1 g (84.7% of theoretical yield) of what at first appeared to be a light red colored liquid. The compound converted to a waxy solid upon standing at room temperature. The product had significant infrared absorptions at 1730, 1637, 1316, 1202, 1114, 943, and 806 wavenumbers.

A portion of this compound was catalyzed with two weight percent of dicumyl peroxide. This mixture was found to have a cure onset of 137.4° C., and a cure maxima of 148.5° C. by DSC. The mix was found to have 93.9% retained weight at 300 C, and a decomposition onset of 423° C. (10° C./minute, air purge) via TGA. A cured sample of this compound was found to have a remarkably low alpha 1 value of 41.4 ppm/° C., an alpha 2 of 117 ppm/° C. and a T_{g} of 78.1° C. by TMA. This compound is a useful acyloxy curative. It can be used as a chain extender for di-functional epoxies. The extended, thermoplastic oligomer can be cross-linked through the pendant methacrylate moieties in a secondary free radical cure.

### Example 14

### Preparation of Acyloxy-Phenylmaleimide Mixture

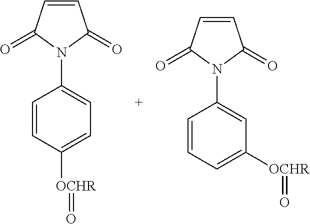

wherein R is CH₃ or CH₂CH₃.

A 125 mL flask was charged with 1.89 g (0.01 mole) of 4-hydroxyphenylmaleimide, 1.89 g (0.01 mole) of 3-hydroxyphenylmaleimide and half an equivalent each of acetic anhydride and propionic anhydride along with about 10 mg of DMAP catalyst. The flask was stirred on a rotovap for two hours at 90° C. and then the residual acetic and propionic acids were removed by sparging. The resulting red liquid set up to an orange solid at room temperature. The product had strong infrared absorptions at 1756, 1717, 1510, 1398, 1196, 1148, 828, and 689 wavenumbers. The mixed compound was found to have a broad melting point via DSC. The melt onset was 93.8° C., with a melt minima at 107.9° C. The acyloxy-phenylmaleimide mixture appeared to be readily soluble in other monomers.

### Example 15

### Preparation of a Mixed N-Acylimide Curative

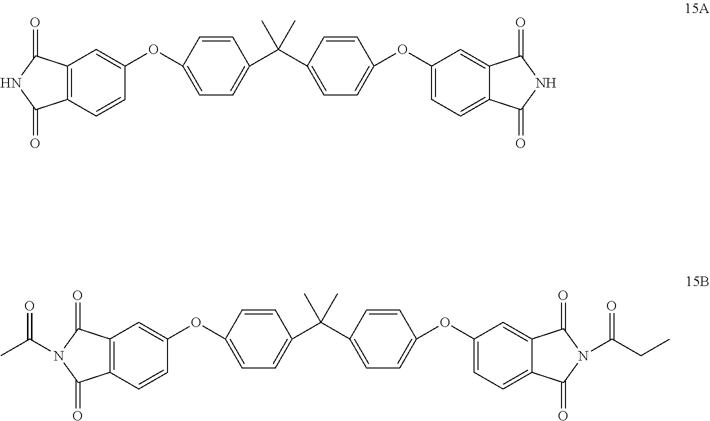 [SMILES: CC(C)(c1ccc(Oc2ccc3c(c2)C(=O)NC3=O)cc1)c1ccc(Oc2ccc3c(c2)C(=O)NC3=O)cc1 ; CCC(=O)N1C(=O)c2ccc(Oc3ccc(C(C)(C)c4ccc(Oc5ccc6c(c5)C(=O)N(C(C)=O)C6=O)cc4)cc3)cc2C1=O]

The imide precursor 15A was prepared from the commercially available Ultem BPADA (GE Plastics, Pittsfield, Mass.). Thus, 52.0 g (0.1 mole) of the dianhydride and 6.0 g (0.1 mole) urea were ground together in a mortar and pestle. This mixture was transferred to a single neck, 500 mL flask. The flask was equipped with a condenser and bubbler, and then heated in an oil bath that was controlled at 133° C. The mix foamed up as carbon dioxide and then water were evolved. The contents were occasionally stirred to insure homogeneity. The temperature bath was raised to and held at 165° C. for thirty minutes once CO2 generation had ceased. The mix was cooled to room temperature and then 60 mL of deionized water was added. The slurry was transferred to a Buchner funnel and the solids were rinsed with deionized water. The solid was dried at 100° C. in an oven to yield 49.9 g (96.2% of theoretical yield) of a cream colored powder. An FTIR was run on this compound and it was found to have significant absorptions at 3264, 1766, 1716, 1598, 1476, 1361, 1237, 1041, 835, and 749 wavenumbers.

The mixed N-acyl curative 15B was prepared by charging a 250 mL, one-neck flask with 25.93 g (0.05 mole) compound 15A, 5.3 g (0.052 mole) acetic anhydride, 6.76 g (0.052 mole) propionic anhydride, 0.2 g DMAP catalyst, and 100 mL toluene. A magnetic stir bar was added and a condenser attached to the flask. This mixture was gently refluxed for twenty hours (during which time all of the solids went into solution). A light yellow solid precipitated out when the solution was cooled to room temperature. This solid was transferred to a Buchner funnel and rinsed with toluene. The solid was dried to yield 30.96 g (100% of theoretical yield) of a yellow-white powder. This compound was found to have a melting point of 197-200° C. An FTIR on the compound revealed significant absorptions at 2921, 1795, 1753, 1714, 1598, 1471, 1360, 1280, 1230, 1170, 1079, 840, and 745 wavenumbers.

### Example 16

### Preparation of an N-Acetylimide Curative Oligomer

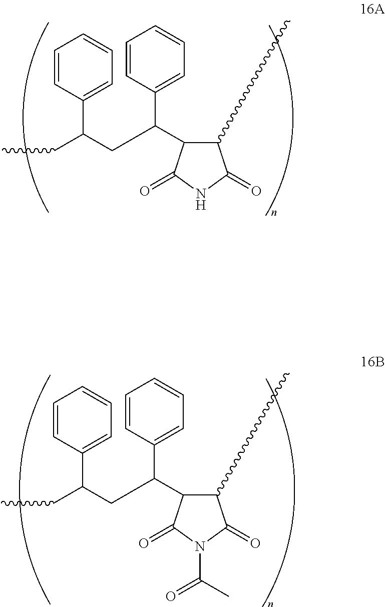

The imide precursor 16A was prepared from the commercially available poly(styrene-co-maleic anhydride) compound SMA-2000P (Sartomer Company, Inc. Exton Pa., USA). Thus, 30.8 g (0.1 equivalent) of the polyanhydride and 6.0 g (0.1 mole) urea were ground together in a mortar and pestle. This mixture was transferred to a single neck, 500 mL flask and 15 mL of NMP was added. The flask was equipped with a condenser and bubbler, and then heated in an oil bath that was controlled at 135° C. The mix foamed up as carbon dioxide and then water were evolved. The contents were occasionally stirred to insure homogeneity. The temperature bath was raised to and held at 165° C. for three hours once CO₂ generation had ceased. The mix was cooled to room temperature and then dissolved in 60 mL of acetone. The solution was dripped into 500 mL of vigorously stirred deionized water. The solid was collected and dried at 80° C. in an oven to yield 29.86 g (97.1% of theoretical yield) of a cream colored powder. An FTIR was run on this compound and it was found to have significant absorptions at 3207, 1771, 1711, 1453, 1381, 1181, 760, and 701 wavenumbers.

The N-acetyl curative oligomer 16B was prepared by slowly dripping 6.3 g (0.08 mole) acetyl chloride into a magnetically stirred solution containing 23.1 g (0.075 equivalents) 16A, 9.1 g (0.09 mole) triethylamine and 50 mL acetone. There was an immediate exotherm and a solid precipitate of triethylamine hydrochloride was observed to form. This mixture was stirred for another forty-five minutes and was then dripped into a one-liter beaker containing 500 mL of vigorously stirred deionized water. The solid was collected and then re-dissolved in 75 mL fresh acetone and the product was once again precipitated into 500 mL of deionized water. The solid was recovered via filtration and dried in an oven at 75° C. The product was an off-white fine powdered solid that weighed 24.57 g (93.7% of theoretical yield). An FTIR on the compound revealed significant absorptions at 3028, 2925, 1801, 1751, 1708, 1601, 1494, 1453, 1384, 1295, 1195, 759, and 704 wavenumbers.

### Example 17

### Epoxy Blends with the N-Acetylimide Curative Oligomer

A mixture was made that contained 70% by weight compound 16B, 30% limonene dioxide and one part per hundred of DMAP catalyst. A DSC was run on this composition and an exotherm was observed to occur with an onset of 153° C., a cure maximum of 170.7° C. and with a cure energy of 68 J/g.

Another mix was made consisting of 75% by weight compound 16B, 25% ERL-4221 (Dow Chemical) and one part per hundred DMAP catalyst. A DSC was run on this composition and an exotherm was observed with an onset of 121.6° C., a maximum at 169.2° C. and a cure energy of 48.2 J/g.

The limonene dioxide is a mixed cycloaliphatic and aliphatic epoxy compound while the ERL-4221 is a bi-functional cycloaliphatic epoxy. The 16B was shown to be an active curative for both of these epoxy compounds.

### Example 18

### Cyclic Siloxane Phenyl Ester Epoxy Curative

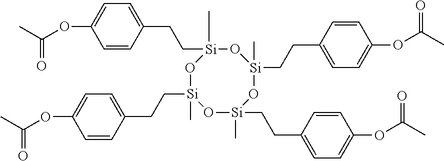 [SMILES: CC(=O)Oc1ccc(CC[Si]2(C)O[Si](C)(CCc3ccc(OC(C)=O)cc3)O[Si](C)(CCc3ccc(OC(C)=O)cc3)O[Si](C)(CCc3ccc(OC(C)=O)cc3)O2)cc1]

Methylhydrocyclosiloxane (30.1 g, 125 mmol) was dissolved in toluene (50 ml) in a 2-neck, 500 ml flask. Dihydrogen hexachloroplatinate (20 mg) and a stir bar were added to the flask. A temperature probe was attached to one of the necks. A condenser was attached to the other. 4-acetoxystyrene (81.1 g, 500 mmol) was diluted with toluene (100 ml) and placed into an addition funnel. The addition funnel was placed on top of the condenser. The toluene solution containing methylhydrocyclosiloxane and catalyst was stirred and controlled at 80° C. One-third of the solution in the addition funnel was dripped in. The addition did not initially show evidence of an exotherm. The pot temperature was increased to 90° C. and the remaining solution in the addition funnel was allowed to drip in. An exotherm occurred during this addition that caused the temperature to increase the temperature to over a 100° C. The temperature was reset to 100° C. and the solution was left to stir at this temperature overnight. When the reaction was complete, the flask was equipped with a trap and sparge tube.

The solution was air sparged at 100° C. for 6 hours to remove the toluene. A total of 95.7 g (86.1% theory) of a very viscous, light yellow, clear liquid was recovered. The compound was subjected to thermogravimetric analysis (TGA). The retained weight at 300° C. (TGA ramp rate=10° C./min., air purge) was 95.43%. Infrared spectrum included absorptions at 2961, 1759, 1504, 1369, 1260, 1193, 1059, 909, and 782 wavenumbers. The 40° C. viscosity of this compound was found to be 23,863 cps at 5 RPM.

### Example 19

### Hybrid Epoxy-Phenyl Ester Thermoset Monomer

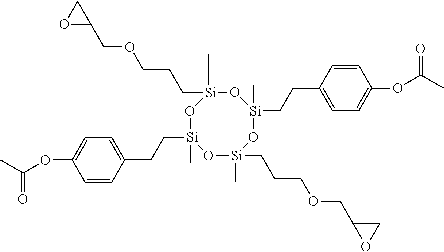 [SMILES: CC(=O)Oc1ccc(CC[Si]2(C)O[Si](C)(CCCOCC3CO3)O[Si](C)(CCc3ccc(OC(C)=O)cc3)O[Si](C)(CCCOCC3CO3)O2)cc1]

Methylhydrocyclosiloxane (30.1 g, 125 mmol) was dissolved with toluene (50 ml) in a 2-neck, 500 ml flask. Dihydrogen hexachloroplatinate (20 mg) and a stir bar were added to the flask. A temperature probe was attached to one of the necks. A condenser was attached to the other neck. 4-Acetoxystyrene (40.6 g, 250 mmol) and allyl glycidyl ether were diluted with toluene (100 ml) and transferred to an addition funnel. The addition funnel was placed on top of the condenser. The initial pot temperature was set to 80° C. The solution in the addition funnel was then added dropwise. The addition caused the temperature to increase the temperature to a 100° C. The addition was paused until the temperature cooled down to 80° C. The addition was continued, but no additional exotherm was observed. Once all of the contents of the addition funnel had been added, the temperature was increased to 90° C. and then to 100° C. The temperature was maintained at 100° C. for 30 minutes. The temperature was then increased to 110° C. for 2 hours. FTIR on the solution showed the complete disappearance of the Si—H peak.

The solution was air sparged at 95° C. for 5 hours to remove the toluene. 73.6 g (74.3% theory) of a viscous, tan colored liquid was recovered. The compound was subjected to thermogravimetric analysis (TGA). The retained weight at 300° C. (TGA ramp rate=10° C./min., air purge) was 96.4%. Infrared spectrum included absorptions at 2932, 1764, 1505, 1369, 1259, 1192, 1050, 908, and 793 wavenumbers.

### Example 20

### Hybrid Allyl-Phenyl Ester Epoxy Curative

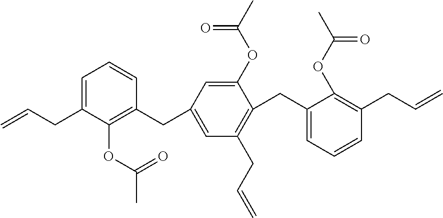 [SMILES: C=CCc1cc(Cc2cccc(CC=C)c2OC(C)=O)cc(OC(C)=O)c1Cc1cccc(CC=C)c1OC(C)=O]

2-Allyphenyl novolac (42.7 g, 300 meq, “Rezicure 3700” available from SI Group), acetic anhydride (30.6 g, 300 mmol), and 4-dimethylaminopyridine (0.2 g) were added to a 250 ml flask. The mixture was stirred at 80° C. for 2 hours. The acid was removed via air sparge for 6 hours at 85° C. The product was recovered as a dark red liquid with a yield of 54.5 g (98.5% theory). The compound was subjected to thermogravimetric analysis (TGA). The retained weight at 200° C. (TGA ramp rate=10° C./min., air purge) was 99.6% and the decomposition onset was at 267° C. Infrared spectrum included absorptions at 1758, 1639, 1495, 1433, 1368, 1192, 1120, 1009, 909, 827, and 768 wavenumbers. The 25° C. viscosity for this product was found to be 2538 cps at 5 RPM.

### Example 21

### 2,4-Diacyloxybenzophenone Phenyl Ester Epoxy Curative

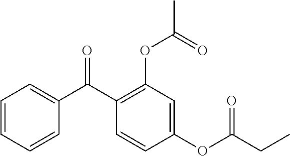 [SMILES: CCC(=O)Oc1ccc(C(=O)c2ccccc2)c(OC(C)=O)c1]

2,4-Dihydroxybenzophenone (43.9 g, 205 mmol), acetic anhydride (20.9 g, 205 mmol), propionic anhydride (26.7 g, 205 mmol), and 4-dimethylaminopyridine (0.2 g) were added to a 250 ml flask. The flask was immersed into a heated bath and rotated at 80° C. for 5 hours. An FTIR on the mixture indicated that the anhydrides had reacted completely. The residual acids were removed via air sparge at 80° C. The product was a moderately viscous liquid that weighed 63.3 g (98.9% theory). The compound was subjected to thermogravimetric analysis (TGA). The retained weight at 200° C. (TGA ramp rate=10° C./min., air purge) was 96.8% and the decomposition onset was at 232° C. Infrared spectrum included absorptions at 1763, 1662, 1605, 1448, 1368, 1255, 1188, 1120, 1010, 898, 799, and 701 wavenumbers. The 25° C. viscosity for this compound was 5540 cps at 10 RPM.

### Example 22

### Sulfide Bridged Phenyl Ester Epoxy Curative

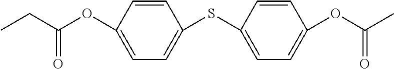 [SMILES: CCC(=O)Oc1ccc(Sc2ccc(OC(C)=O)cc2)cc1]

Bis(4-hydroxyphenyl)sulfide (21.8 g, 100 mmol), acetic anhydride (10.2 g, 100 mmol), propionic anhydride (13.0 g, 100 mmol), and 4-dimethylaminopyridine (50 mg) were added to a 250 ml flask. The mixture was rotated on a rotovap at 85° C. for 4.5 hours. FTIR indicated that the anhydrides had reacted completely. The residual acids were removed via air sparge at 85° C. The product was an almost colorless liquid that solidified on standing. It weighed 31.5 g (99.6% theory). The compound was subjected to thermogravimetric analysis (TGA). The retained weight at 200° C. (TGA ramp rate=10° C./min., air purge) was 99.3% and the decomposition onset was at 266° C. A DSC was conducted (ramp rate=10° C./min., air purge) on a sample of this material. The melting point onset was 37.7° C. and the peak was 42.3° C. Infrared spectrum included absorptions at 2982, 1757, 1588, 1485, 1368, 1192, 1075, 1011, 899, 840, 797, and 717 wavenumbers.

### Example 23

### Siloxane Extended Phenyl Ester Epoxy Curative

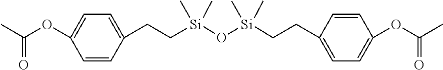 [SMILES: CC(=O)Oc1ccc(CC[Si](C)(C)O[Si](C)(C)CCc2ccc(OC(C)=O)cc2)cc1]

Tetramethyldisiloxane (134.4 g, 1.00 mol) was dissolved in toluene (100 ml) in a 2-neck, 2 L flask. 5% Platinum on carbon (100 mg) and a stir bar were added to the solution. A temperature controller probe was attached to one of the necks. A condenser attached to the other. 4-Acetoxystyrene (324.4 g, 2.00 mol) and toluene (200 ml) were added to an addition funnel. The addition funnel was attached to the top of the condenser. A bubbler was attached to the top of the addition funnel A chiller for the condenser cooling fluid was turned on and controlled at 10-15° C. The solution in the pot was heated to 95° C. The solution in the addition funnel was dripped in. The combined solution was then stirred at 95° C. for sixty hours. An FTIR on the solution following this period showed the complete absence of the Si—H peak. The solution was passed over silica gel (50 g).

The toluene was removed via rotary evaporation followed by an air sparge in a 130° C. oil bath. The product was free of solvent after 3.0 hours of sparging. The product was a fairly low viscosity, almost colorless liquid that weighed 446.5 g (97.3% theory). The compound was subjected to thermogravimetric analysis (TGA). The retained weight at 200° C. (TGA ramp rate=10° C./min., air purge) was 99.1% and the decomposition onset was at 260° C. Infrared spectrum included absorptions at 2953, 1762, 1505, 1368, 1252, 1196, 1048, 907, 834, 782, and 701 wavenumbers. The 25° C. viscosity was 97 cps at 10 RPM.

### Example 24

### Siloxane Extended Diphenol Epoxy Curative

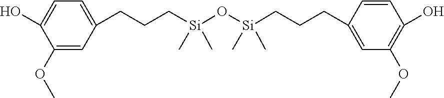 [SMILES: COc1cc(CCC[Si](C)(C)O[Si](C)(C)CCCc2ccc(O)c(OC)c2)ccc1O]

Tetramethyldisiloxane (33.6 g, 250 mmol) was dissolved in toluene (50 ml) in a 2-neck, 500 ml flask. 5% Platinum on carbon (50 mg) and a stir bar were added to the solution. A temperature controller probe was attached to one of the necks. A condenser attached to the other. Eugenol (82.1 g, 500 mmol) and toluene (100 ml) were added to an addition funnel. The addition funnel was attached to the top of the condenser. A bubbler was attached to the top of the addition funnel A chiller for the condenser cooling fluid was turned on and controlled at 10-15° C. The solution in the pot was heated to 95° C. The solution in the addition funnel was dripped in. The combined solution was then stirred at 95° C. overnight. An FTIR on the solution the next morning showed the complete disappearance of the Si—H peak. The solution was passed over silica gel (15 g). The toluene was removed via rotary evaporation followed by an air sparge in a 130° C. oil bath. The product was free of solvent after 2.5 hours of sparging.

The product was a moderately viscous, yellow liquid that weighed 111.7 g (96.6% theory). The compound was subjected to thermogravimetric analysis (TGA). The retained weight at 200° C. (TGA ramp rate=10° C./min., air purge) was 98.0% and the decomposition onset was at 280° C. Infrared spectrum included absorptions at 3545, 2925, 1606, 1513, 1429, 1367, 1250, 1206, 1150, 1034, 839, 792, and 703 wavenumbers. The 25° C. viscosity was 437 cps at 10 RPM.

### Example 25

### Siloxane Extended Phenyl Ester Epoxy Curative

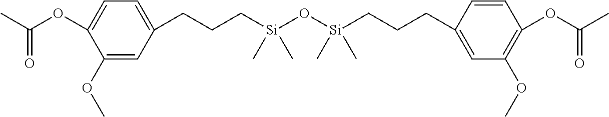 [SMILES: COc1cc(CCC[Si](C)(C)O[Si](C)(C)CCCc2ccc(OC(C)=O)c(OC)c2)ccc1OC(C)=O]

The product (SD23-22B) obtained from the previous reaction (46.3 g, 100 mmol), acetic anhydride (20.4 g, 200 mmol), and 4-dimethylaminopyridine (50 mg) were charged into a 1-neck, 500 ml flask. The mixture was rotated in an 80° C. water bath for 10 hours. The residual acetic acid was removed via air sparge at 80° C. for 2 hours. The product was a moderately viscous, light amber liquid. The compound was subjected to thermogravimetric analysis (TGA). The retained weight at 200° C. (TGA ramp rate=10° C./min., air purge) was 99.3% and the decomposition onset was at 292° C. Infrared spectrum included absorptions at 2928, 1762, 1604, 1510, 1455, 1368, 1252, 1186, 1149, 1125, 1031, 903, 836, and 789 wavenumbers. The 25° C. viscosity was 1667 cps at 10 RPM.

### Example 26

### 1,2,3-Triacyloxy Phenyl Ester Epoxy Curative

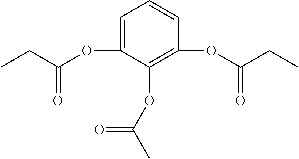 [SMILES: CCC(=O)Oc1cccc(OC(=O)CC)c1OC(C)=O]

1,2,3-Trihydroxybenzene (25.2 g, 200 mmol), acetic anhydride (20.4 g, 200 mmol), propionic anhydride (52.0 g, 400 mmol), and 4-dimethylaminopyridine (200 mg) were added to a 500 ml flask. The mixture was rotated on a rotovap at 80° C. for 4 hours. FTIR indicated that the anhydrides had reacted completely. The residual acids were removed via rotary evaporation followed by air sparge at 80° C. The product was a tan colored solid that weighed 54.9 g (98% theory). The compound was subjected to thermogravimetric analysis (TGA). The retained weight at 100° C. (TGA ramp rate=10° C./min., air purge) was 99.3% and the decomposition onset was at 197° C. A DSC was conducted (ramp rate=10° C./min., air purge) on a sample of this material. The product had a broad melt between 52 and 80° C. Infrared spectrum included absorptions at 2986, 2885, 1761, 1605, 1472, 1370, 1270, 1122, 1033, and 874 wavenumbers.

### Example 27

### 1,3,5-Triacyloxy Phenyl Ester Epoxy Curative

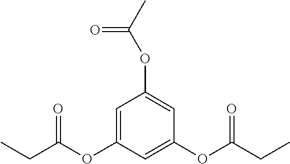 [SMILES: CCC(=O)Oc1cc(OC(C)=O)cc(OC(=O)CC)c1]

1,3,5-Trihydroxybenzene (25.2 g, 200 mmol), acetic anhydride (20.4 g, 200 mmol), propionic anhydride (52.0 g, 400 mmol), and 4-dimethylaminopyridine (200 mg) were added to a 2-neck, 500 ml flask. A stir bar was added to the flask. A temperature probe was attached to one neck. A condenser was attached to the other. The temperature was set to 80° C. An initial exotherm caused the temperature to overshoot to 131° C. The reaction was complete after 8.25 hours. The residual acids were removed by air sparge at 85-90° C. 55.6 g (99.2%) of a fairly low viscosity, amber liquid was recovered. The compound was subjected to thermogravimetric analysis (TGA). The retained weight at 200° C. (TGA ramp rate=10° C./min., air purge) was 94.5%. Infrared spectrum included absorptions at 2982, 1758, 1605, 1454, 1353, 1188, 1113, 1077, 1018, 900, 805, and 665 wavenumbers.

### Example 28

### 2,3,4-Triacyloxybenzophenone Phenyl Ester Epoxy Curative

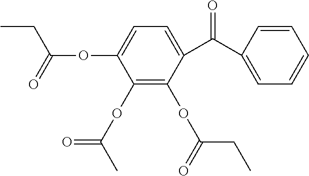 [SMILES: CCC(=O)Oc1ccc(C(=O)c2ccccc2)c(OC(=O)CC)c1OC(C)=O]

2,3,4-Trihydroxybenzophenone (23.0 g, 100 mmol), acetic anhydride (10.2 g, 100 mmol), propionic anhydride (26.0 g, 200 mmol), and 4-dimethylaminopyridine (200 mg) were added to a 500 ml flask. The mixture was rotated in a water bath at 80-90° C. for 2.25 hours. FTIR indicated that the anhydrides had reacted completely. The residual acids were removed by sparging with clean dry air at 95° C. The product was a very, viscous, tacky, dark amber liquid that weighted 35.2 g (91.6% theory). The compound was subjected to thermogravimetric analysis (TGA). The retained weight at 200° C. (TGA ramp rate=10° C./min., air purge) was 98.5% and the decomposition onset was at 272° C. Infrared spectrum included absorptions at 2987, 1789, 1667, 1598, 1447, 1261, 1161, 1118, 1050, 864, 800, and 702 wavenumbers.

### Example 29

### 2,2′,4,4′-Tetraacyloxybenzophenone Phenyl Ester Epoxy Curative

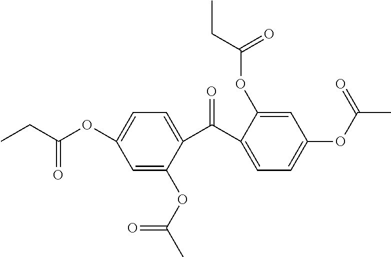 [SMILES: CCC(=O)Oc1ccc(C(=O)c2ccc(OC(C)=O)cc2OC(=O)CC)c(OC(C)=O)c1]

2,2′,4,4′-Tetrahydroxybenzophenone (24.6 g, 100 mmol), acetic anhydride (20.4 g, 200 mmol), propionic anhydride (26.0 g, 200 mmol), and 4-dimethylaminopyridine (200 mg) were added to a 250 ml flask. The mixture rotated in a water bath at 80-90° C. for 5.25 hours. FTIR indicated that the anhydrides had reacted completely. The residual acids were removed by sparging with clean dry air at 80° C. for 9 hours. The product did not seem to be free of acid after the 80° C. sparge, so it was sparged in a 120° C. oil bath for 8 hours. The final product was an amber, viscous almost gel-like liquid that weighted 42.0 g (97.9% theory). The compound was subjected to thermogravimetric analysis (TGA). The retained weight at 200° C. (TGA ramp rate=10° C./min, air purge) was 98.1% and the decomposition onset was at 251.6° C. Infrared spectrum included absorptions at 2987, 1766, 1668, 1604, 1493, 1417, 1370, 1253, 1198, 1143, 1013, 906, and 832 wavenumbers.

### Example 30

### Sulfone Bridged Phenyl Ester Epoxy Curative

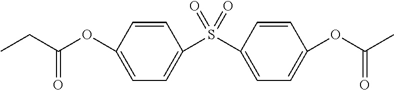 [SMILES: CCC(=O)Oc1ccc(S(=O)(=O)c2ccc(OC(C)=O)cc2)cc1]

Bis(4-hydroxyphenyl)sulfone (225.2 g, 900 mmol), acetic anhydride (91.9 g, 900 mmol), propionic anhydride (117.1 g, 900 mmol), and 4-dimethylaminopyridine (450 mg) were added to a 1 L flask. The mixture rotated in a 115° C. oil bath for 7.75 hours. FTIR indicated that the reaction was complete. The residual acids were removed via rotary evaporation followed by air sparge at 115° C. The product was an off-white solid that weighed 308.9 g (98.5% theory). The compound was subjected to thermogravimetric analysis (TGA). The retained weight at 200° C. (TGA ramp rate=10° C./min., air purge) was 99.6% and the decomposition onset was at 320° C. A DSC was conducted (ramp rate=10° C./min., air purge) on a sample of this material. The onset of the melting point was 99.5° C. and the peak was 100.8° C. Infrared spectrum included absorptions at 1754, 1585, 1487, 1319, 1098, 1013, 847, and 736 wavenumbers.

### Example 31

### Novolac Polybenzoate Epoxy Curative

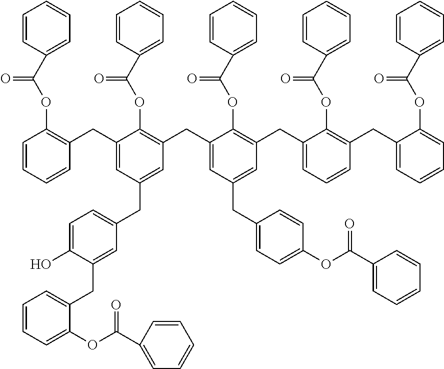 [SMILES: O=C(Oc1ccc(Cc2cc(Cc3cccc(Cc4ccccc4OC(=O)c4ccccc4)c3OC(=O)c3ccccc3)c(OC(=O)c3ccccc3)c(Cc3cc(Cc4ccc(O)c(Cc5ccccc5OC(=O)c5ccccc5)c4)cc(Cc4ccccc4OC(=O)c4ccccc4)c3OC(=O)c3ccccc3)c2)cc1)c1ccccc1]

Rezicure 3000 (53.0 g, 500 meq, available from SI Group), triethylamine (53.1 g, 525 meq), toluene (100 ml), and a stir bar were added to a 2-neck, 500 ml flask. Benzoyl chloride (66.8 g, 475 meq) was added dropwise into the mixture. When completely added, the mixture was allowed to stir at room temperature overnight. The next day, the temperature was turned up to 100° C. for 1.5 hours. The mixture was transferred to a separation funnel and diluted with toluene (300 ml). Water extractions (3×100 ml) were used to remove the salt from the mixture. The organic phase was also rinsed with brine (100 ml). The mixture was dried with magnesium sulfate (25 g) then passed over silica (25 g). The toluene was removed via rotary evaporation followed by air sparge. The product was a clear, light yellow, glassy solid that weighed 83.7 g (82.6% theory). The compound was subjected to thermogravimetric analysis (TGA). The retained weight at 300° C. (TGA ramp rate=10° C./min, air purge) was 98.5% and the decomposition onset was at 366° C. The infrared spectrum included absorptions at 3481, 3059, 1735, 1600, 1505, 1265, 1058, 870, and 701 wavenumbers.

### Example 32

### Novolac Polyacetate Epoxy Curative

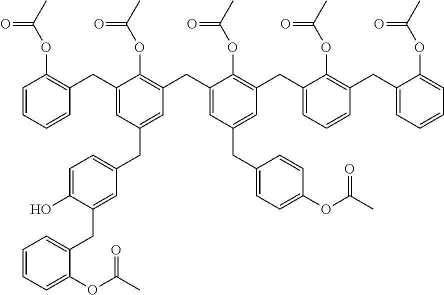 [SMILES: CC(=O)Oc1ccc(Cc2cc(Cc3cccc(Cc4ccccc4OC(C)=O)c3OC(C)=O)c(OC(C)=O)c(Cc3cc(Cc4ccc(O)c(Cc5ccccc5OC(C)=O)c4)cc(Cc4ccccc4OC(C)=O)c3OC(C)=O)c2)cc1]

Rezicure 3000 (424 g, 4000 meq, available from SI Group), acetic anhydride (408.4 g, 4000 mmol), 4-dimethylaminopyridine (1.0 g), and a stir bar were charged into a 2 L, 1-neck flask. A Claisen head was attached. A temperature probe was added to one neck and a condenser was attached to the other. The temperature was set to 85° C., but an initial overshoot allowed the temperature to get as high as 129° C. The reaction was complete after 20.5 hours at 80° C. The stir bar was removed and the flask was place onto a rotovap. The acid was removed via air sparge in a 115° C. oil bath. 590 g of a reddish-brown, glassy solid was recovered. The compound was subjected to thermogravimetric analysis (TGA). The retained weight at 200° C. (TGA ramp rate=10° C./min, air purge) was 99.9% and the decomposition onset was at 258° C. The infrared spectrum included absorptions at 3484, 3039, 2925, 1750, 1608, 1505, 1369, 1206, 1013, 911, 830, and 752 wavenumbers.

### Example 33

### Comparison of Novolac and Novolac Polyacyloxy Epoxy Curatives

Test compositions were made using the curatives from Examples 31, 32, and the Rezicure 3000 novolac starting material. All test mixtures were made using one to one equivalents of each of the curatives with the diglycidyl ether of Bisphenol F. All mixtures were catalyzed with two weight percent Curezol 2P4MZ azine. These compositions were compared in terms of their performance in terms of TGA, DSC and TMA analysis. The results of that testing is summarized in Table 6.

TABLE 6
Thermoset Cure Performance and Thermoset Properties
Comparison Between Two Novolac Phenyl Ester Curatives
and Corresponding Novolac Starting Compound

| | | Cure | | | Decomp. | Glass |
|---|---|---|---|---|---|---|
| | Onset | Max | Δ H | Reside @ | Onset | Transition |
| Curative | (° C.) | (° C.) | (J/g) | 300° C. | (° C.) | (° C.) |
| Rezicure | 133 | 157 | 217 | 98.3% | 423 | 105 |
| 3000 | | | | | | |
| Example 32 | 151 | 175 | 261 | 98.8% | 416 | 62 |
| Example 31 | 160 | 182 | 188 | 99.9% | 431 | 83 |

The Rezicure 3000 (free-phenol) starting material had the lowest onset, cure peak maximum, 300° C. residual weight, and glass transition temperature. Both of the acyloxy curatives were more latent. The composition containing Example 32 had 0.5% less weight loss at 300° C. than the control, while the resin mix containing the Example 31 curative had 1.6% less weight loss than the control. The Example 32 curative reduced the glass transition temperature by 43° C. versus the control, while the Example 31 curative had a T_{g} that was 22° C. lower than the control. The exemplary curatives present advantages in terms of latency and reduced volatility. The elimination of hydroxy functionality, furthermore, makes these curatives desirable in terms of the inherent hydrophobicity.

### Example 34

### Bisphenol F Phenyl Ester Epoxy Curative

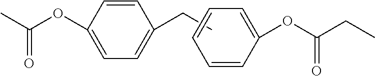

Bisphenol F (100.10 g, 500 mmol), acetic anhydride (65.05 g, 500 mmol), propionic anhydride (51.05 g, 500 mmol), and 4-dimethylaminopyridine (0.25 g) were charged into a 500 ml flask. The mixture was rotated in a water bath set at 65° C. for 5.25 hours. The temperature of the bath was then increased to 85° C. for another 2.75 hours. The residual acids were removed via vacuum followed by a sparge with clean dry air at 85° C. Toluene (200 ml) was added to the flask and the solution was filtered over a bed of silica gel (30 g). The toluene was then removed via rotary evaporation followed by an air sparge in a 55° C. water bath. The product was an odorless, clear, yellow, moderately viscous liquid that weighed 144.4 g (96.8% theory). The compound was subjected to thermogravimetric analysis (TGA). The decomposition onset (TGA ramp rate=10° C./min, air purge) was at 252° C. Infrared spectrum included prominent absorptions at 1757, 1505, 1369, 1193, 1017, 910, 806, and 752 wavenumbers. The viscosity of this liquid at 25° C. was 509 centipoise.

### Example 35

### 2,3-Acyloxy Substituted Naphthalene Epoxy Curative

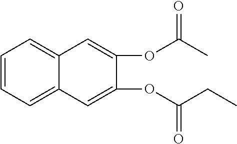 [SMILES: CCC(=O)Oc1cc2ccccc2cc1OC(C)=O]

2,3-Dihydroxynaphthalene (32.0 g, 200 mmol), acetic anhydride (20.4 g, 200 mmol), propionic anhydride (26.0 g, 200 mmol), and 4-dimethylaminopyridine (0.1 g) were added to a 250 ml flask. The flask was rotated for one hour in a heated bath that was controlled at approximately 85° C. An FTIR run on this mixture showed the complete disappearance of the anhydride carbonyl absorption, indicating the reaction was finished. The acids were removed under vacuum in a rotary evaporator followed by a sparge at 85° C. with clean, dry air. The reaction product recovered weighed 50.9 g (98.5% theory). It was a reddish brown, moderately viscous liquid. The compound was subjected to thermogravimetric analysis (TGA). The decomposition onset (TGA ramp rate=10° C./min., air purge) was at 233° C. Infrared spectrum included absorptions at 1766, 1603, 1508, 1468, 1363, 1248, 1189, 1095, 1009, 900, and 749 wavenumbers. The 25° C. viscosity for this compound was 805 cps at 5 RPM.

### Example 36

### 1,6-Acyloxy Substituted Naphthalene Epoxy Curative

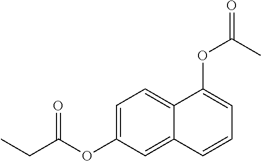 [SMILES: CCC(=O)Oc1ccc2c(OC(C)=O)cccc2c1]

1,6-Dihydroxynaphthalene (16.0 g, 100 mmol), acetic anhydride (10.2 g, 100 mmol), propionic anhydride (13.0 g, 100 mmol), and 4-dimethylaminopyridine (50 mg) were charged into a 250 ml flask. The flask was rotated for 4.5 hours in a heated bath that was controlled at approximately 85° C. An FTIR on the crude product indicated the complete disappearance of the anhydride carbonyl absorptions. The acids were removed via a combination of vacuum and air sparge at 85° C. The product was initially a black-brown liquid. The product solidified into a milky brown solid after standing for several hours at room temperature. The recovered product weighed 24.6 g (95.3% theory). The compound was subjected to thermogravimetric analysis (TGA). The retained weight at 200° C. (TGA ramp rate=10° C./min., air purge) was 96.9% and the decomposition onset was at 216° C. The infrared spectrum of this compound included absorptions at 2948, 1755, 1603, 1431, 1367, 1192, 1139, 1037, 899, and 788 wavenumbers.

### Example 37

### Preparation of Dibenzoate of 2,2′-Diallylbisphenol A

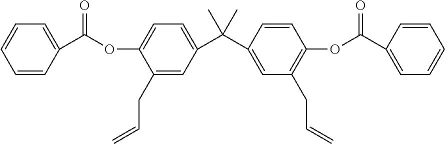 [SMILES: C=CCc1cc(C(C)(C)c2ccc(OC(=O)c3ccccc3)c(CC=C)c2)ccc1OC(=O)c1ccccc1]

A 500 ml, single-neck flask was charged with 30.84 g (0.1 mole) o,o′-diallylbisphenol A, 200 ml toluene, and 25.3 g (0.25 mole) triethylamine. This mixture was stirred at room temperature and 28.1 g (0.20 mole) benzoyl chloride dissolved in 100 ml toluene was dripped in. The mixture was stirred for another three hours at room temperature and then one hour at 100° C. The mixture was cooled to room temperature and then extracted with four 50 ml portions of deionized water, followed by 50 ml of brine. The solution was dried with ten grams of MgSO₄ and then passed over 20 g of silica gel. The toluene was removed to yield 50.72 g (98.2% of theory) of a clear, light yellow, very viscous tacky liquid. The compound had prominent absorptions at 2970, 1638, 1495, 1450, 1251, 1168, 1057, 1023, 994, 914, 873, 812, and 704 wavenumbers. The viscosity of this liquid was 71,760 centipoise at 40° C. A TGA was run on this compound revealed 97.82% residue remained at 300° C. while the decomposition onset was at 351.3° C.

### Example 38

### Mixed Acetate-Propionates Versus All-Acetate Compounds

Phenyl esters containing a mixture of acyloxy functional groups were found to have significantly lower melting points than the corresponding acetate-only counterparts. The value of this approach for melting point suppression is demonstrated in Table 7.

TABLE 7
Melting Point Comparison Between Mixed Acetate-Propionates
and All-Acetate Comparative Compounds

| Example | Example Melting | Melting Point of Corresponding All |
|---|---|---|
| Compound | Point (° C.) | Acetate Compound (° C.) |
| 7 | 41-43 | 91-94 |
| 21 | liquid at RT | 78 |
| 22 | 38-42 | 92-94 |
| 26 | liquid at RT | 165-167 |
| 27 | liquid at RT | 105-106 |
| 28 | liquid at RT | 117-118 |
| 30 | 100-101 | 163-165 |

The presence of the mixed acetate-propionate functionality significantly reduced the melting point for the invention phenyl ester compounds compared to the all-acetate comparative compounds. Several of the invention compounds were stable liquids at room temperature, while all of the acetate-only compounds were crystalline solids. Even where the mixed acetate-propionates were solids at room temperature, they were still significantly lower in melting point than the comparative all-acetate compounds. Low melting solids, as a rule are much more soluble in, and therefore compatible with other reactive formulation components.

While this invention has been described with respect to these specific examples, it should be clear that other modifications and variations would be possible without departing from the spirit of this invention.

What is claimed is:

1. A curative for epoxy or oxetane resins having the structure of Formula I or Formula II: 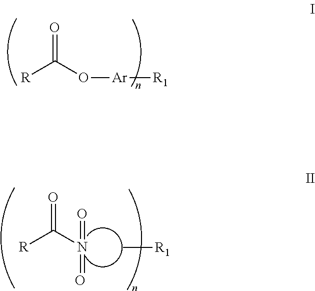
wherein each of R and R₁ is, independently, selected from the group consisting of a substituted or an unsubstituted aliphatic, heteroaliphatic, aromatic, heteroaromatic, siloxane, maleimido, and cinnamyl moieties;
Ar is selected from the group consisting of a substituted or an unsubstituted aryl or heteroaryl having between 6 and about 20 carbon atoms; and
n is an integer having the value between 1 and about 11.

2. The curative of claim 1, wherein each of R and R₁ is, independently, selected from the group consisting of a substituted or an unsubstituted alkyl, cycloalkyl, alkenyl, aryl, and heterocyclic moieties.

3. The curative of claim 1, wherein Ar is a substituted or an unsubstituted C₆ to about C₁₁ aryl or a substituted or an unsubstituted C₆ to about C₁₁ heteroaryl.

4. The curative of claim 1, wherein n is 3 to about 11.

5. The curative of claim 4, wherein n is 3 to about 6.

6. The curative of claim 1, wherein R₁ is different than at least one R.

7. The curative of claim 6, wherein the at least one R is a terminal R group.

8. The curative of claim 1, wherein the curative is a liquid at room temperature.

9. The curative of claim 1, selected from the group of compounds consisting of: 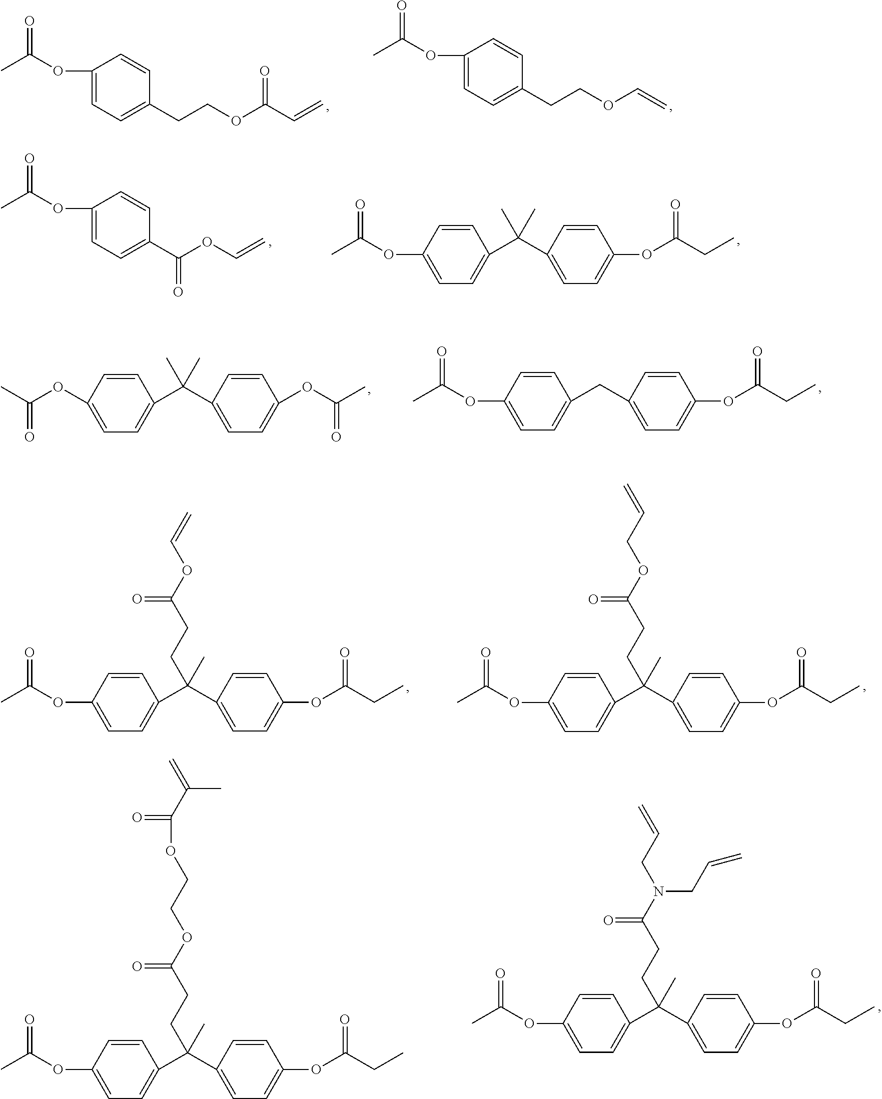 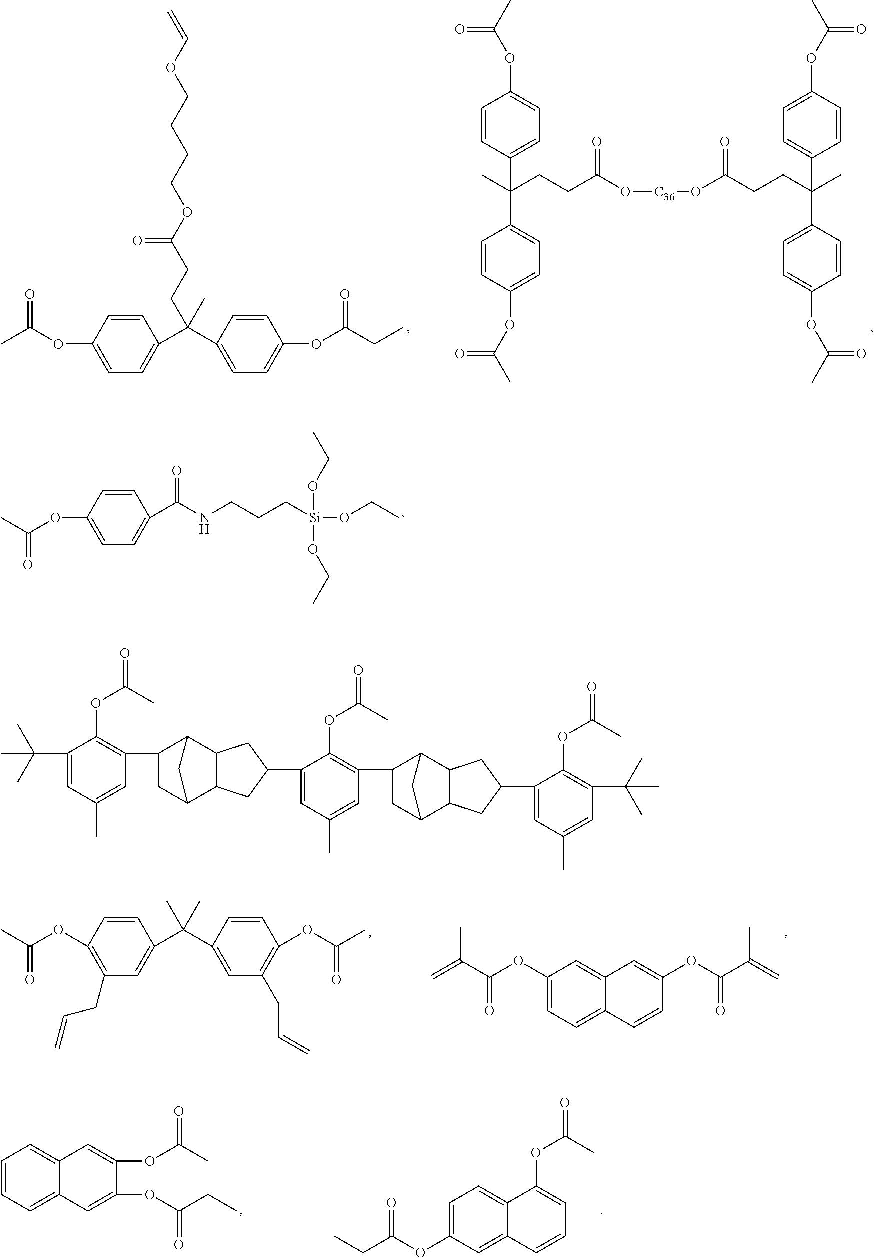 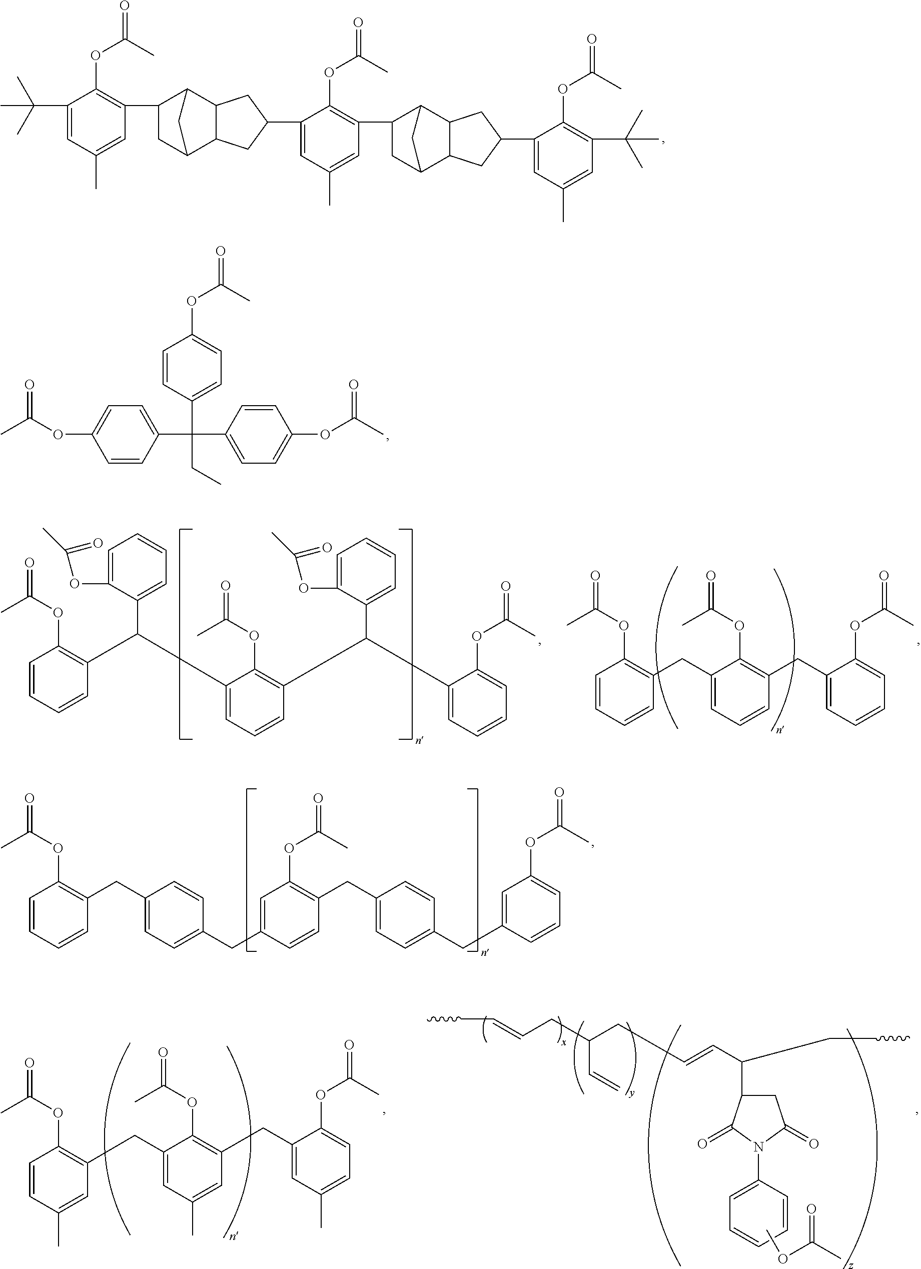 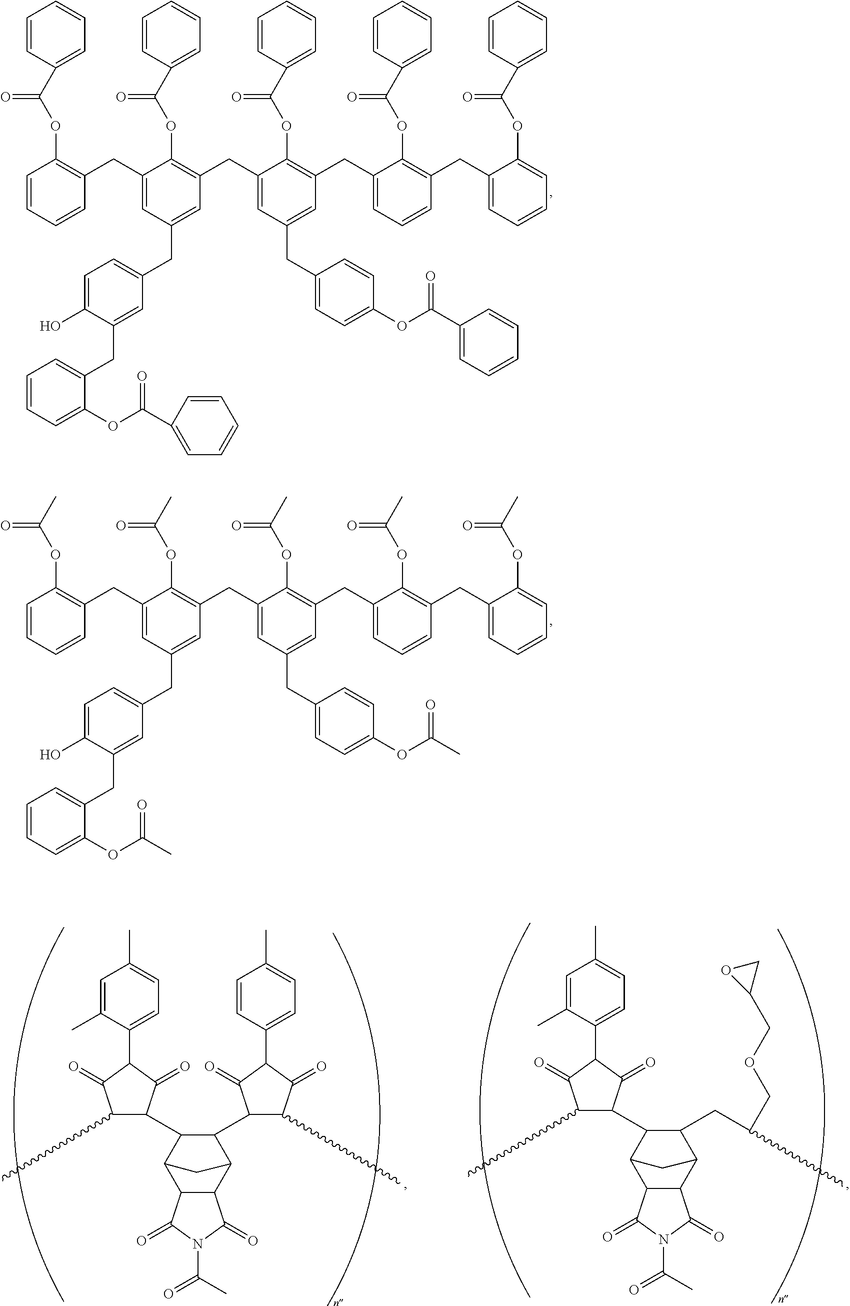 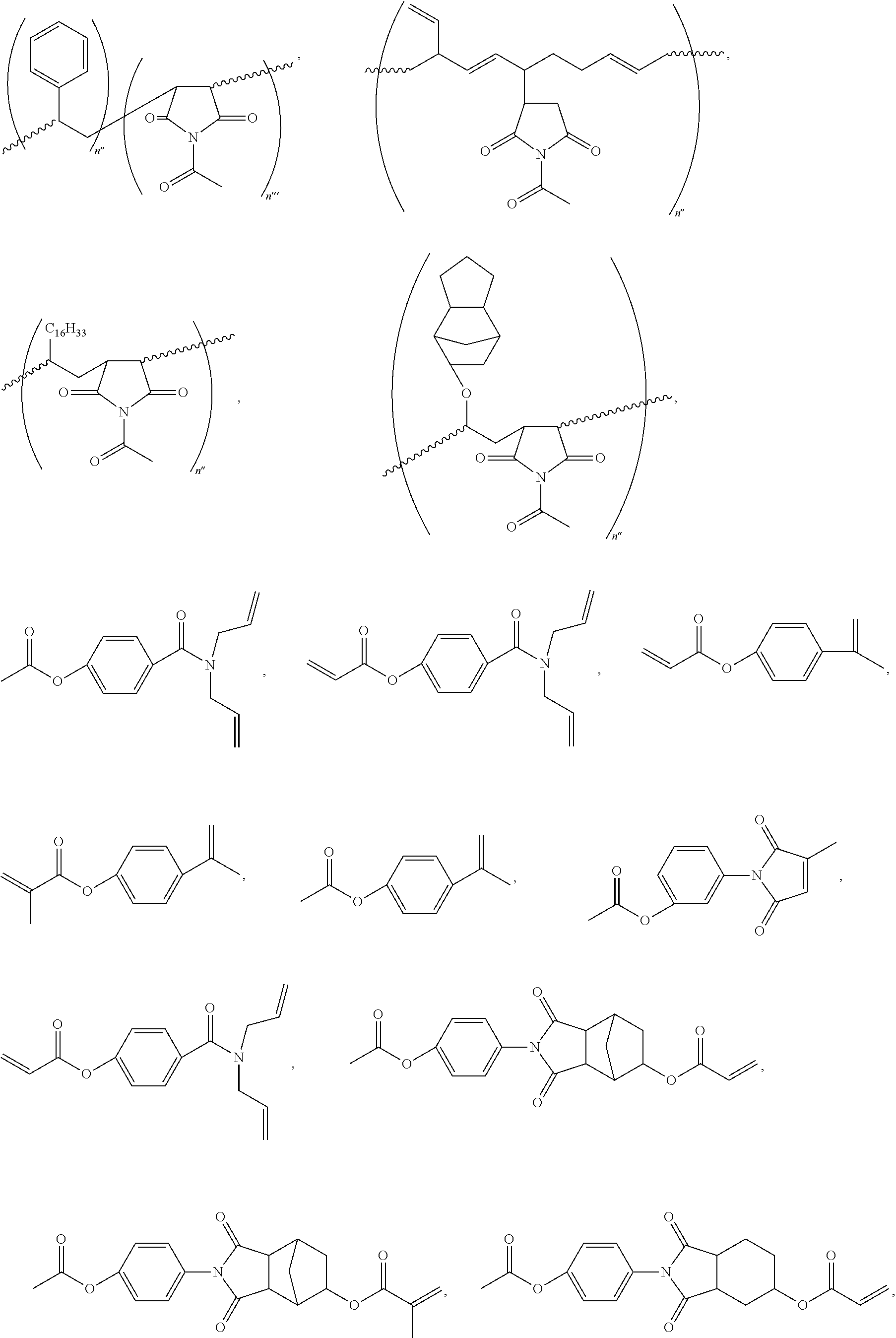 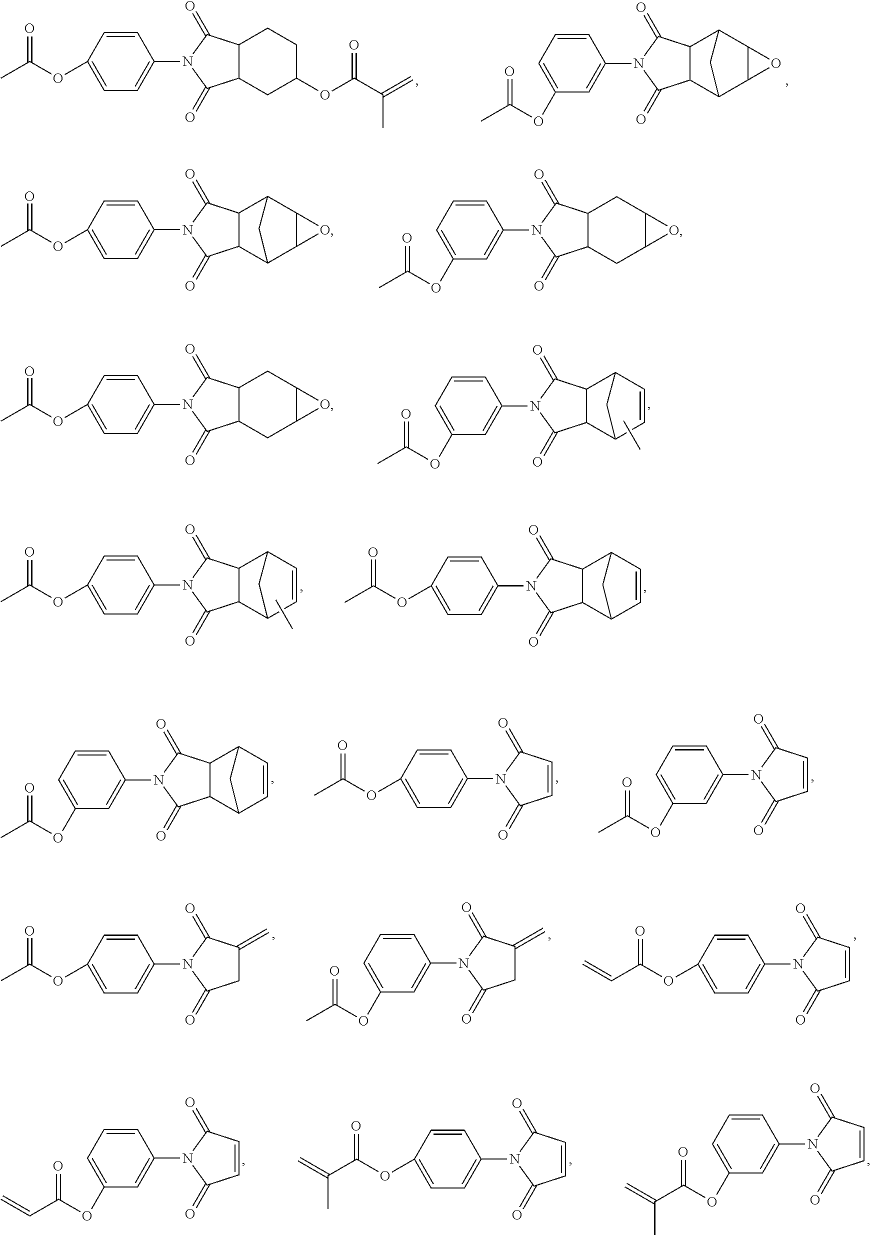 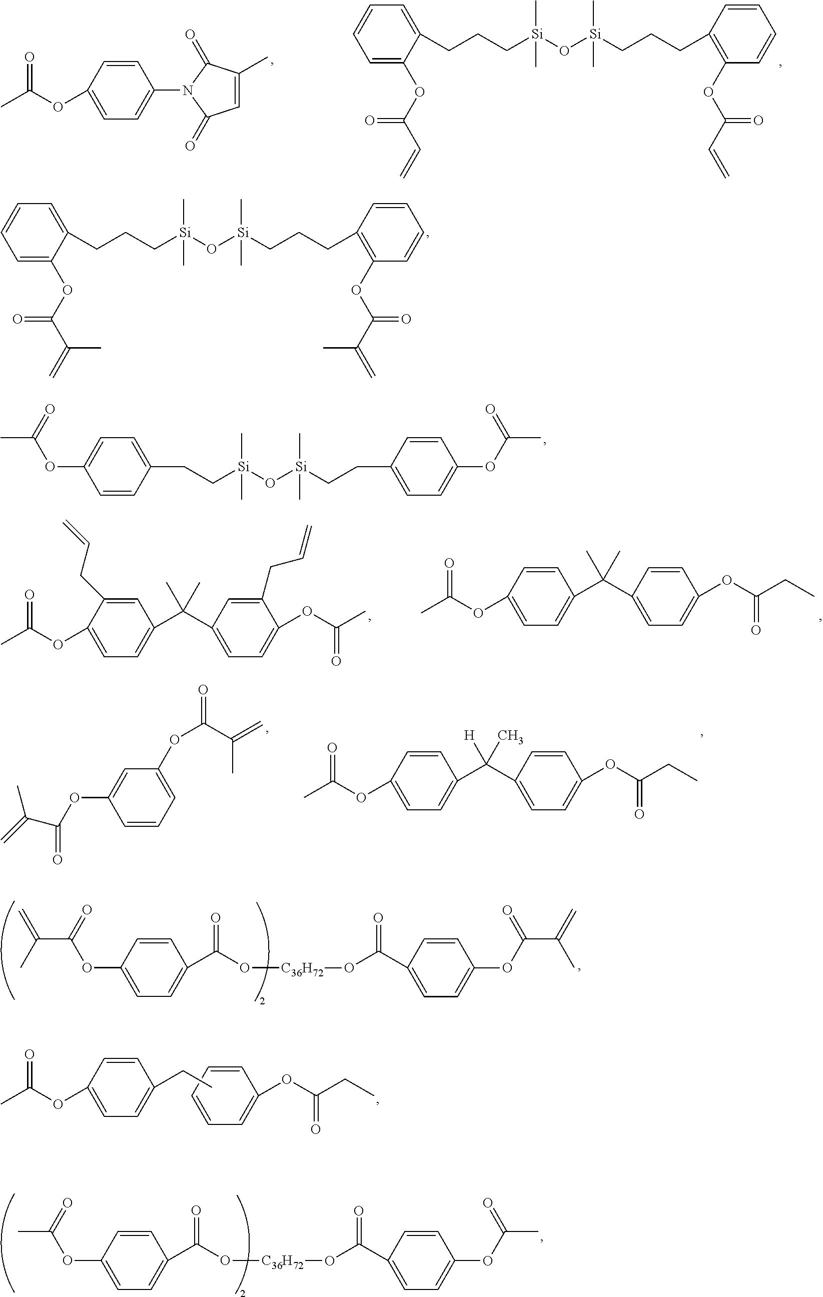 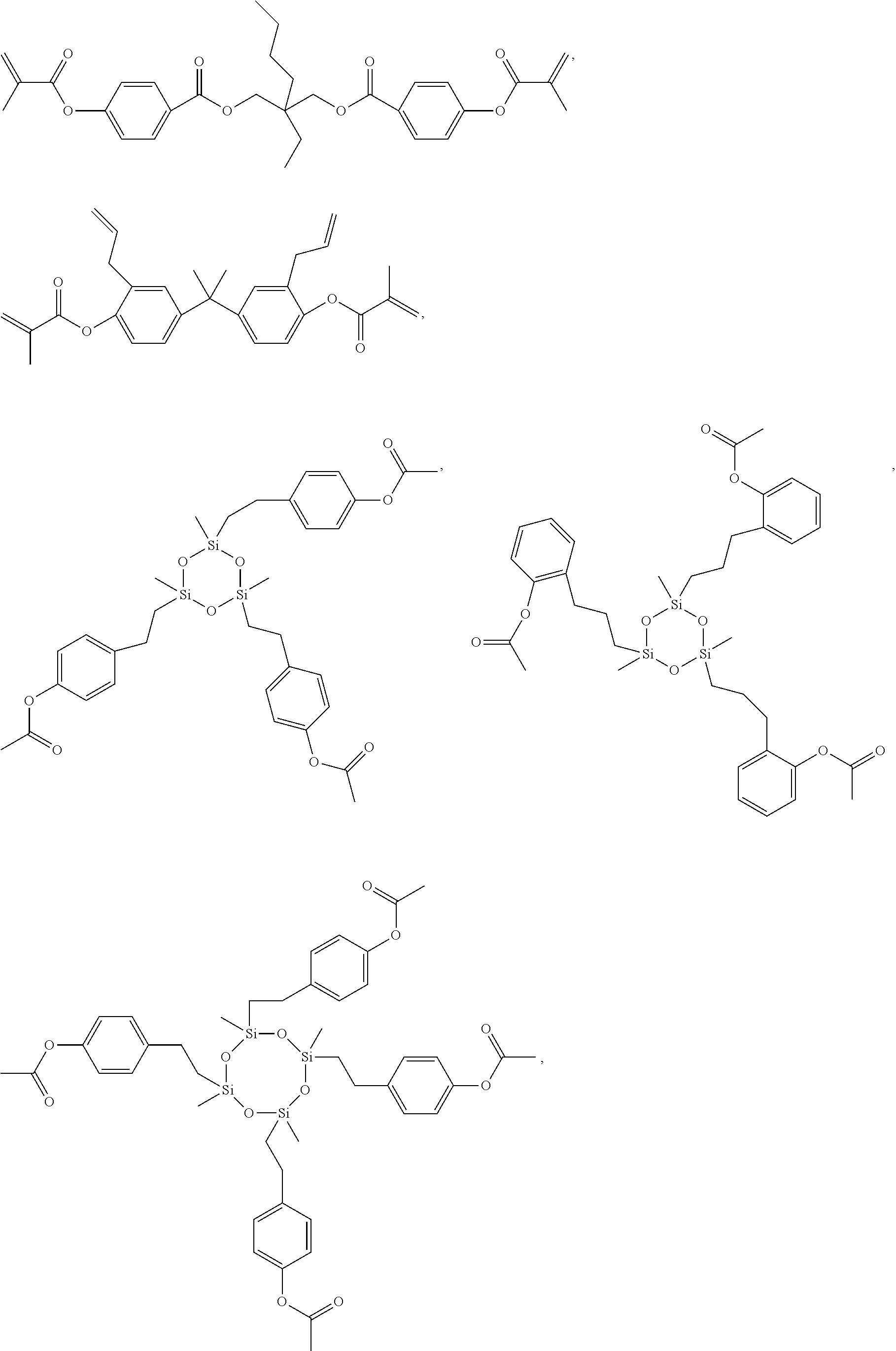 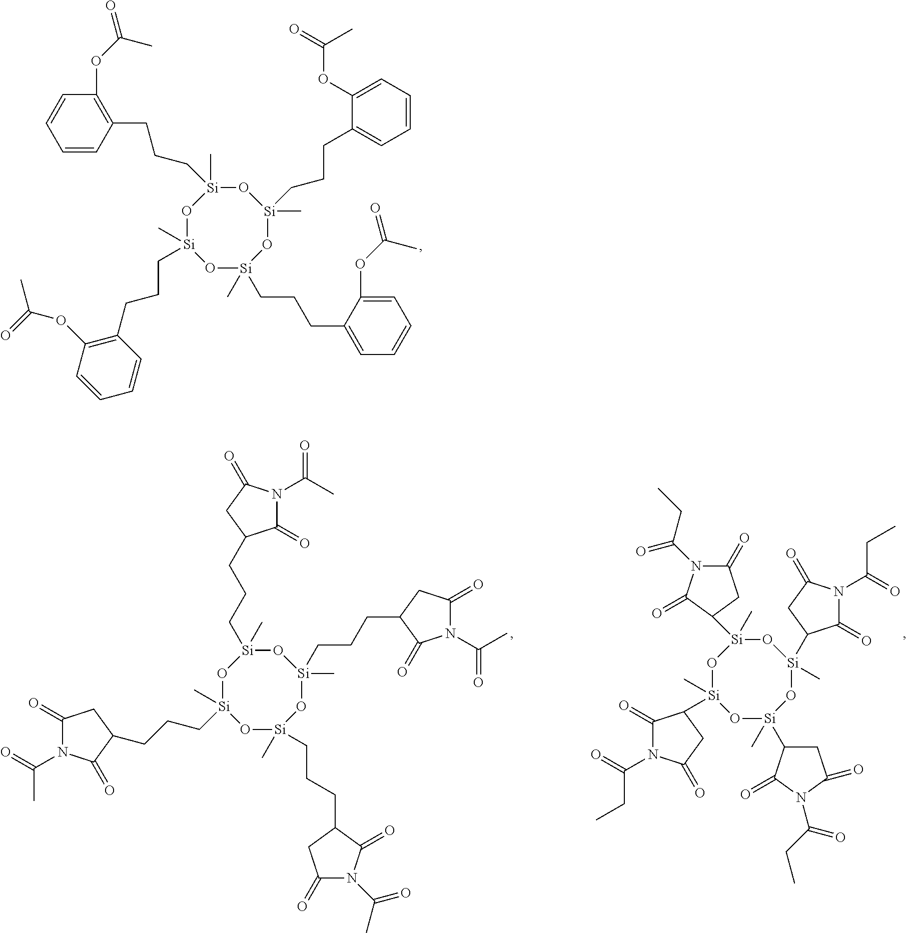 [SMILES: CC(=O)Oc1ccccc1CCC[Si]1(C)O[Si](C)(CCCc2ccccc2OC(C)=O)O[Si](C)(CCCc2ccccc2OC(C)=O)O[Si](C)(CCCc2ccccc2OC(C)=O)O1 ; CC(=O)N1C(=O)CC(CCC[Si]2(C)O[Si](C)(CCCC3CC(=O)N(C(C)=O)C3=O)O[Si](C)(CCCC3CC(=O)N(C(C)=O)C3=O)O[Si](C)(CCCC3CC(=O)N(C(C)=O)C3=O)O2)C1=O ; CCC(=O)N1C(=O)CC([Si]2(C)O[Si](C)(C3CC(=O)N(C(=O)CC)C3=O)O[Si](C)(C3CC(=O)N(C(=O)CC)C3=O)O[Si](C)(C3CC(=O)N(C(=O)CC)C3=O)O2)C1=O] 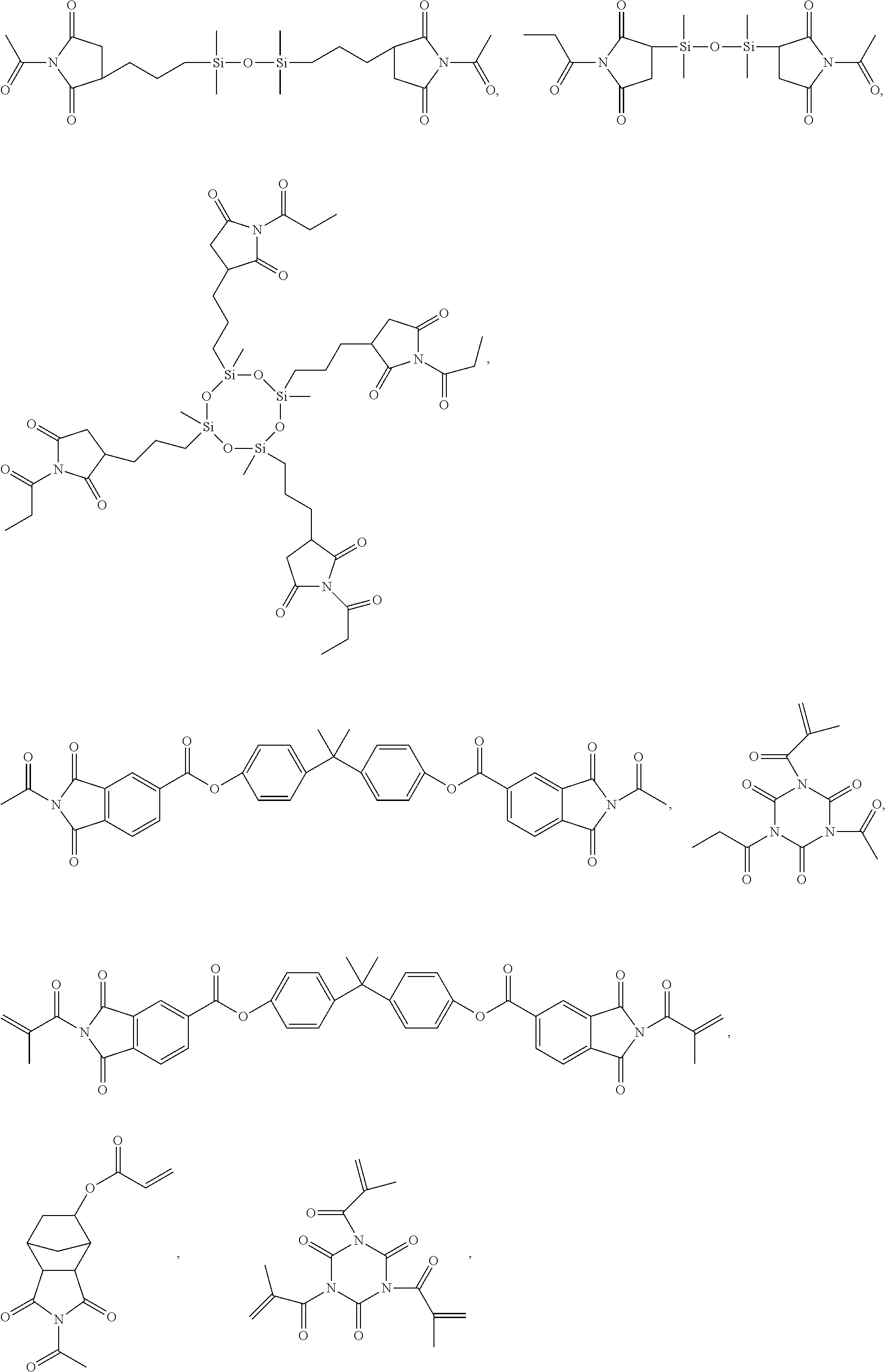 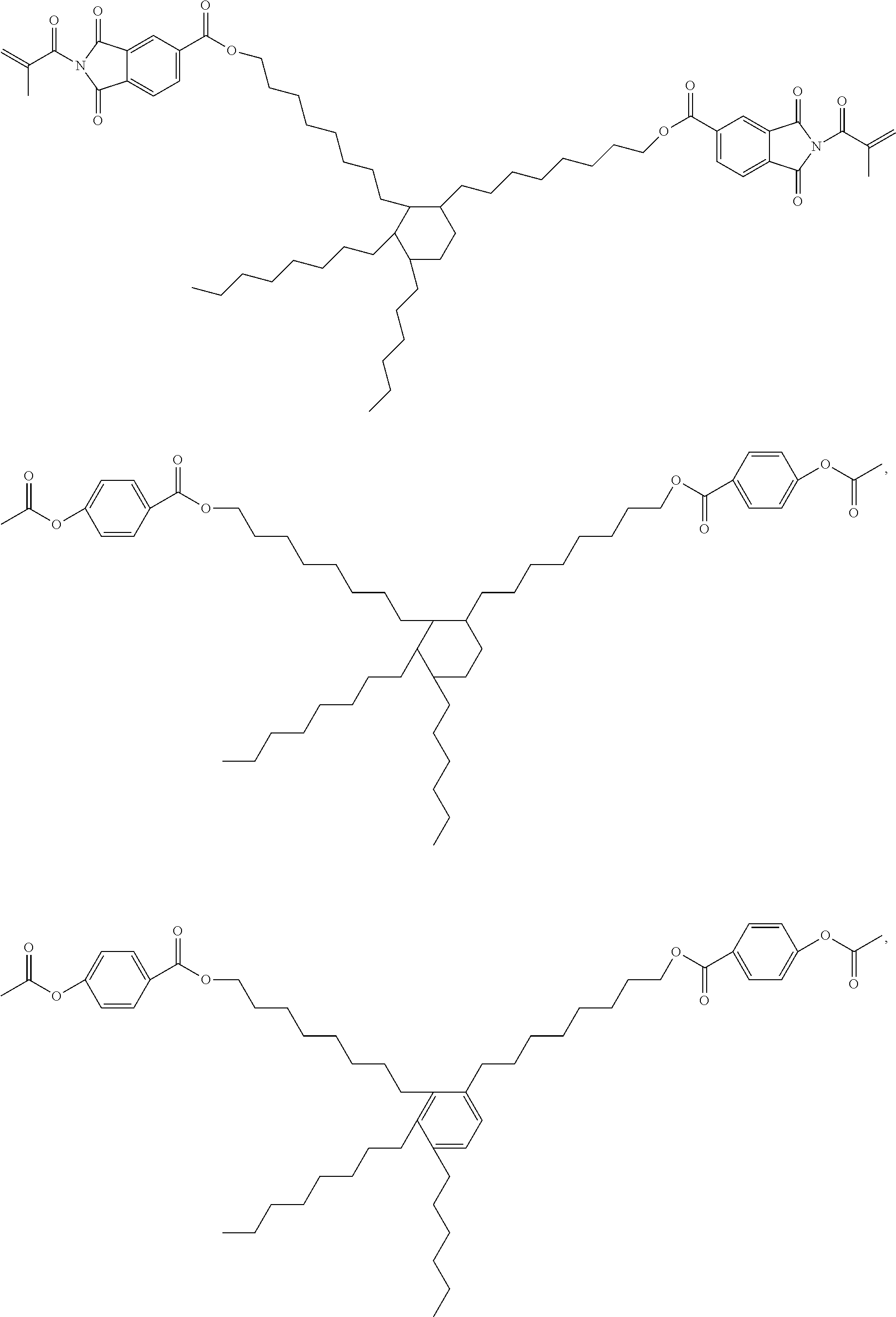 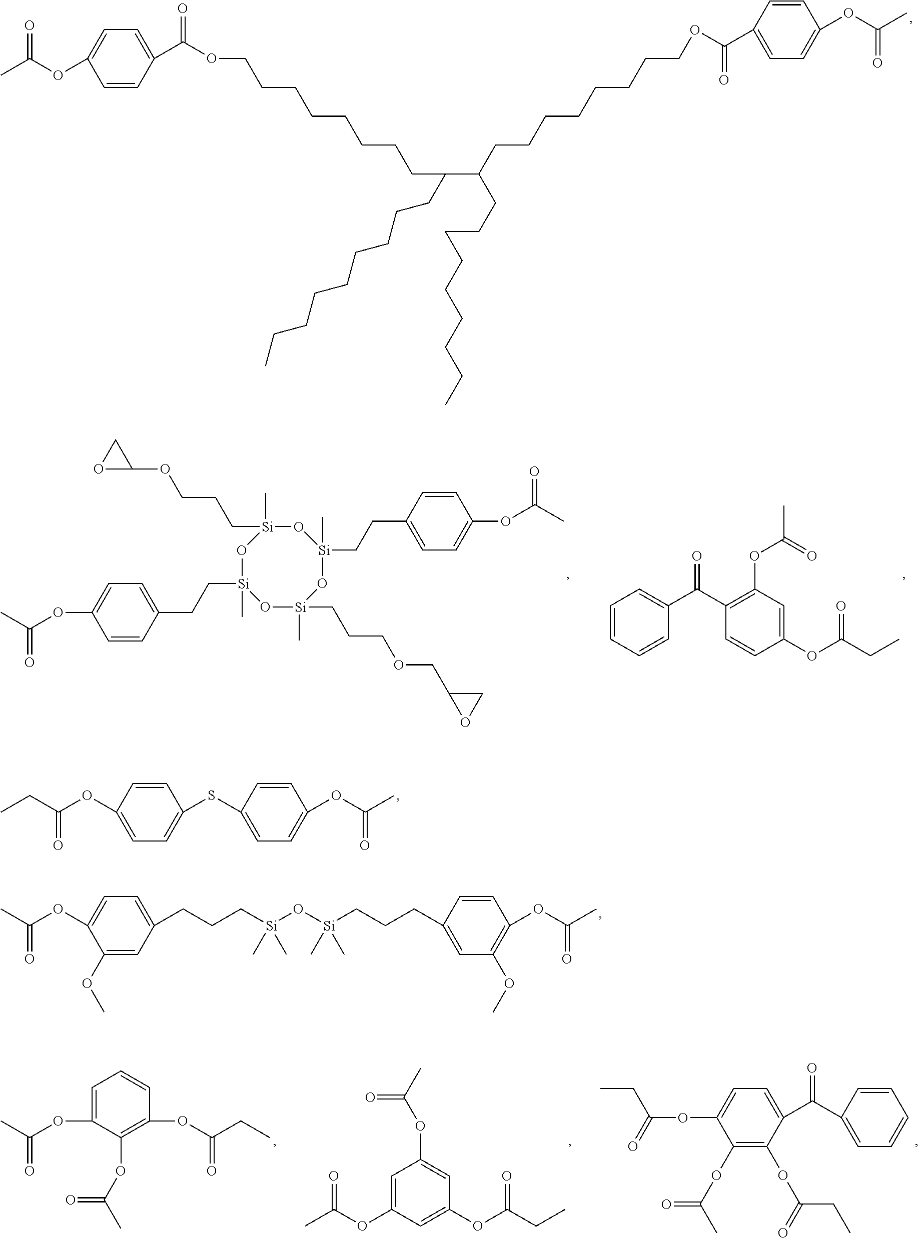 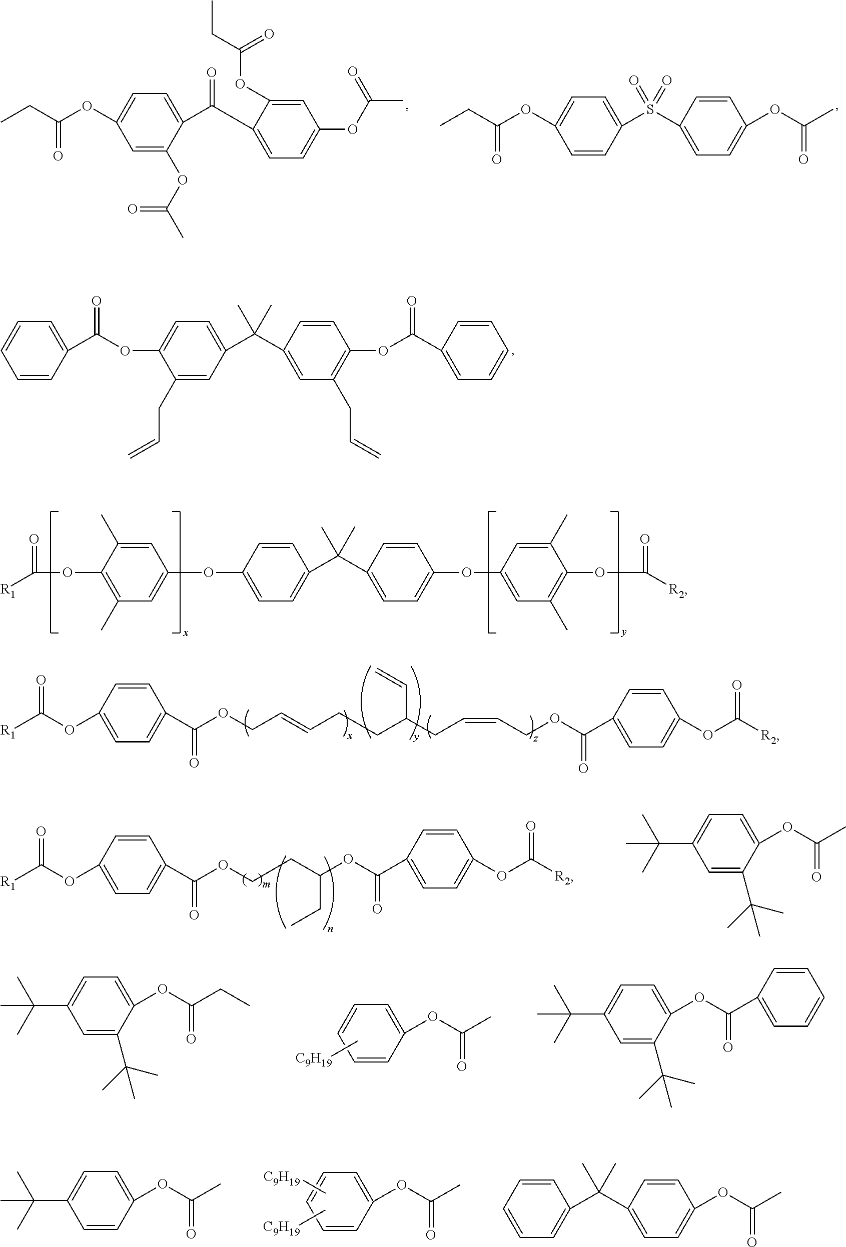 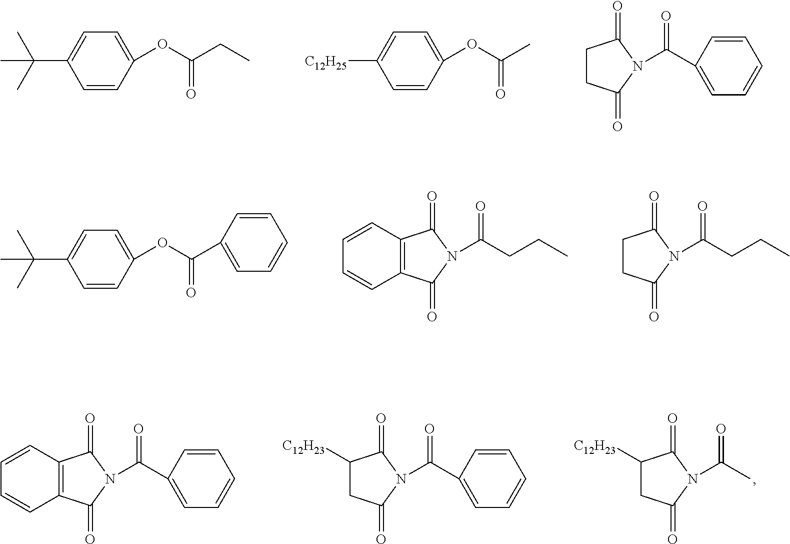
wherein:
each of x, y, z, m and n is an integer;
the sum of x, y and z is equal to, or less than, about 130;
the sum of m and n is equal to, or less than, about 300 and
each of R₁ and R₂ is independently selected from the group consisting of a lower alkyl or a substituted or an unsubstituted aryl
wherein each of n′, x, y and z is an integer, n′ independently having the value between 0 and about 10; each of x and y independently having the value between 4 and about 50; and z independently having the value between 2 and about 40
wherein each n″ and n′″ is an integer independently having the value between 1 and about 10.

10. A composition, comprising:
(a) an epoxy resin or oxetane resin; and
(b) at least one curative having the structure of Formula I or Formula II: 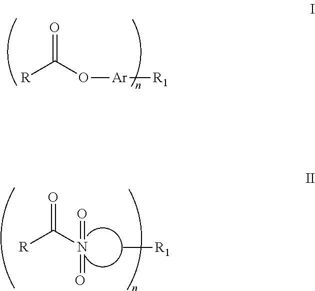
wherein each of R and R₁ is, independently, selected from the group consisting of a substituted or an unsubstituted aliphatic, heteroaliphatic, aromatic, heteroaromatic, siloxane, maleimido, and cinnamyl moieties;
Ar is selected from the group consisting of a substituted or an unsubstituted aryl or heteroaryl having between 6 and about 20 carbon atoms; and
n is an integer having the value between 1 and about 11.

11. The composition of claim 10, wherein the at least one curative is selected from the group consisting of: 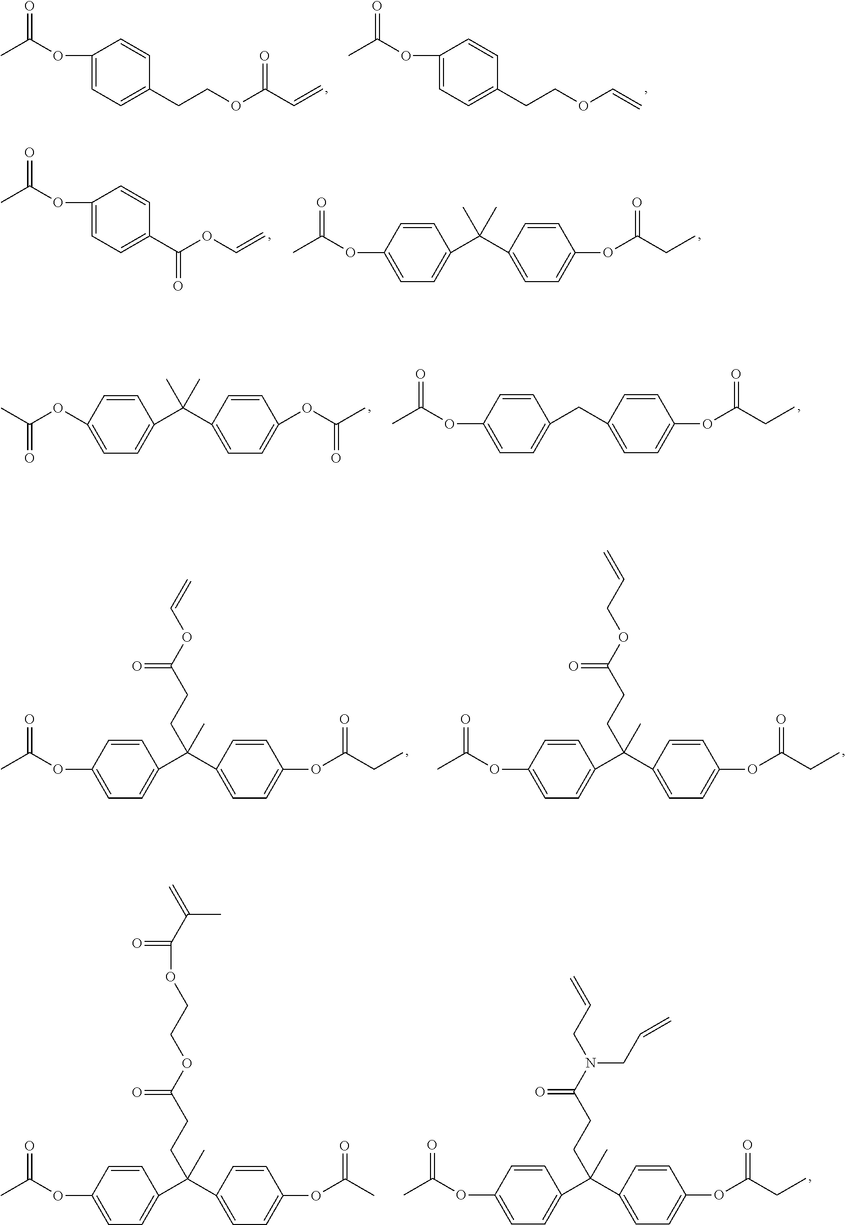 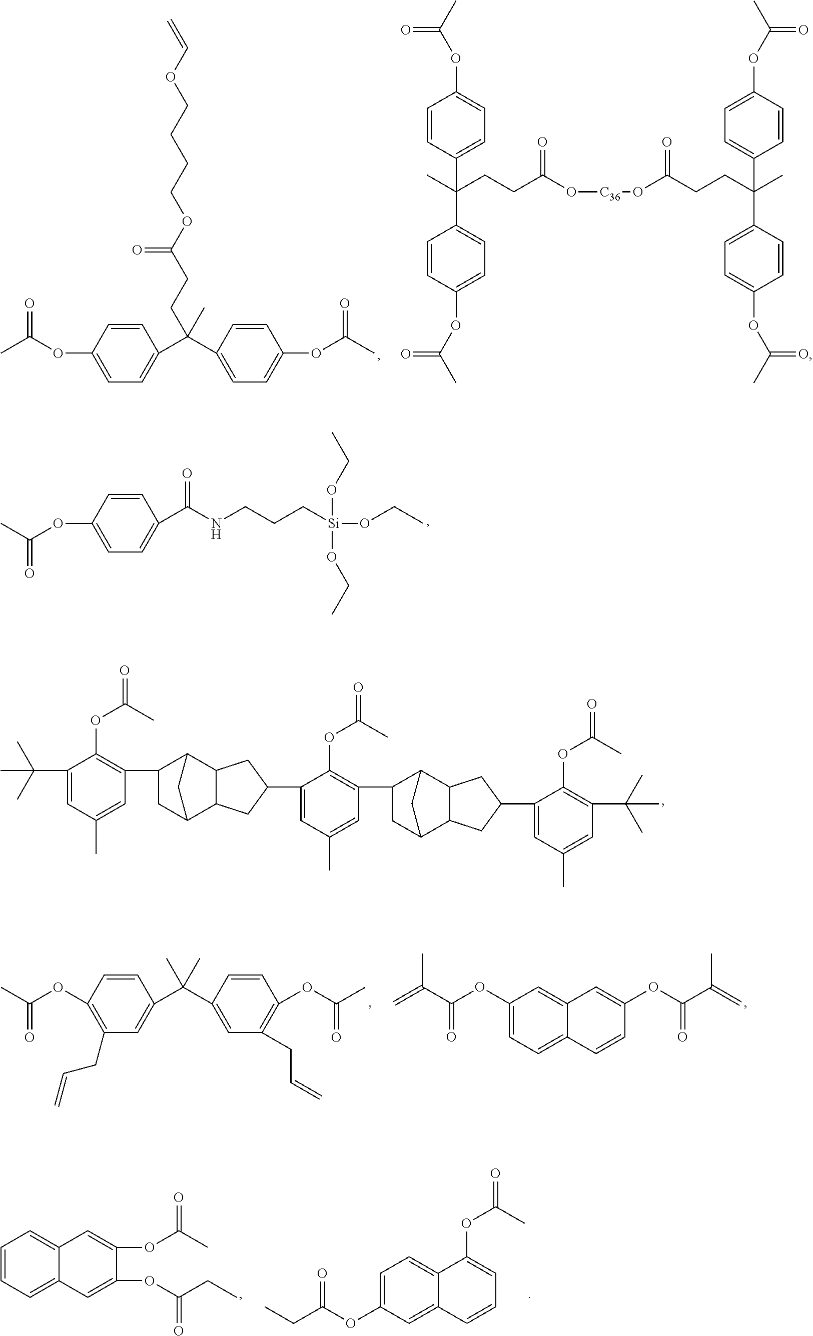 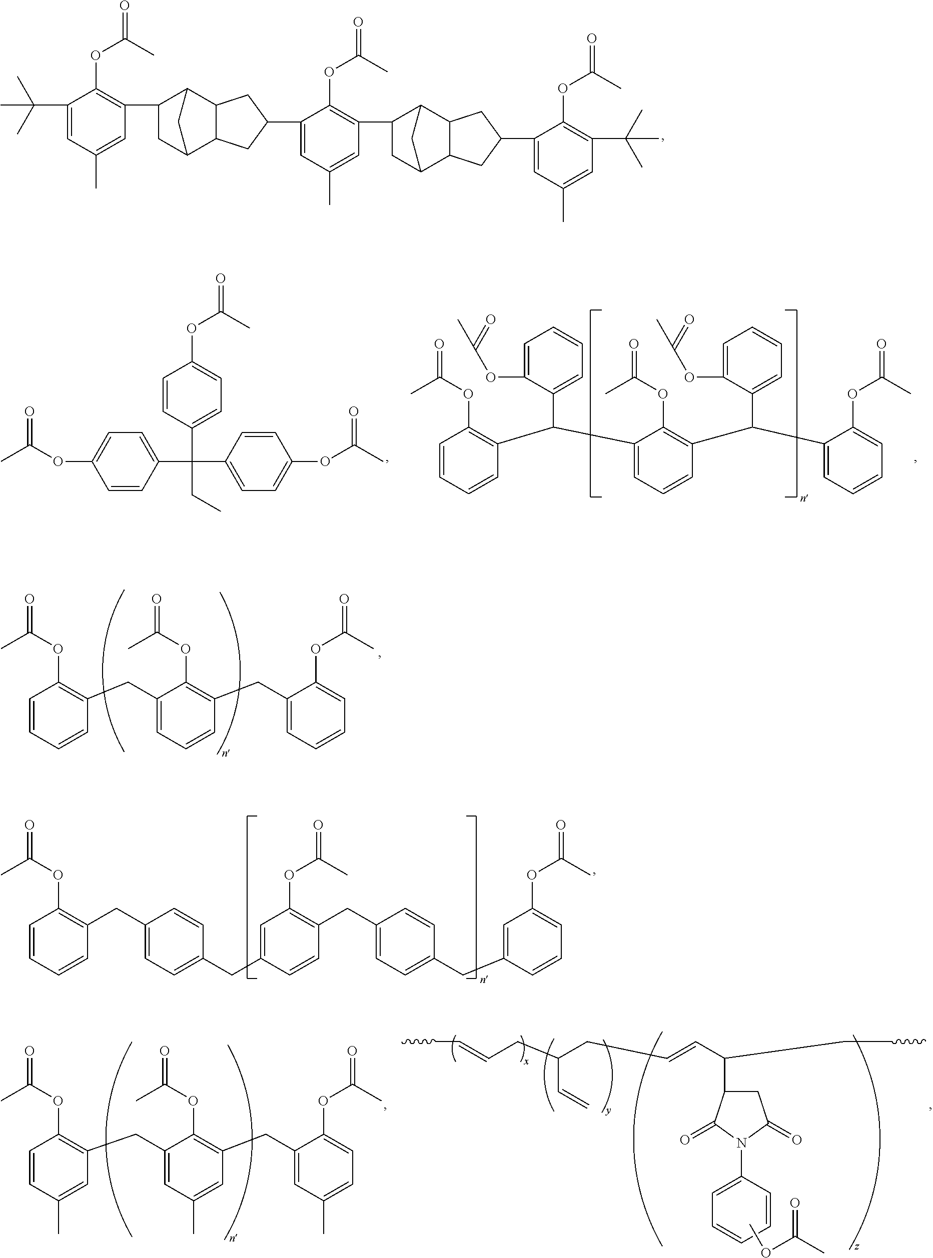 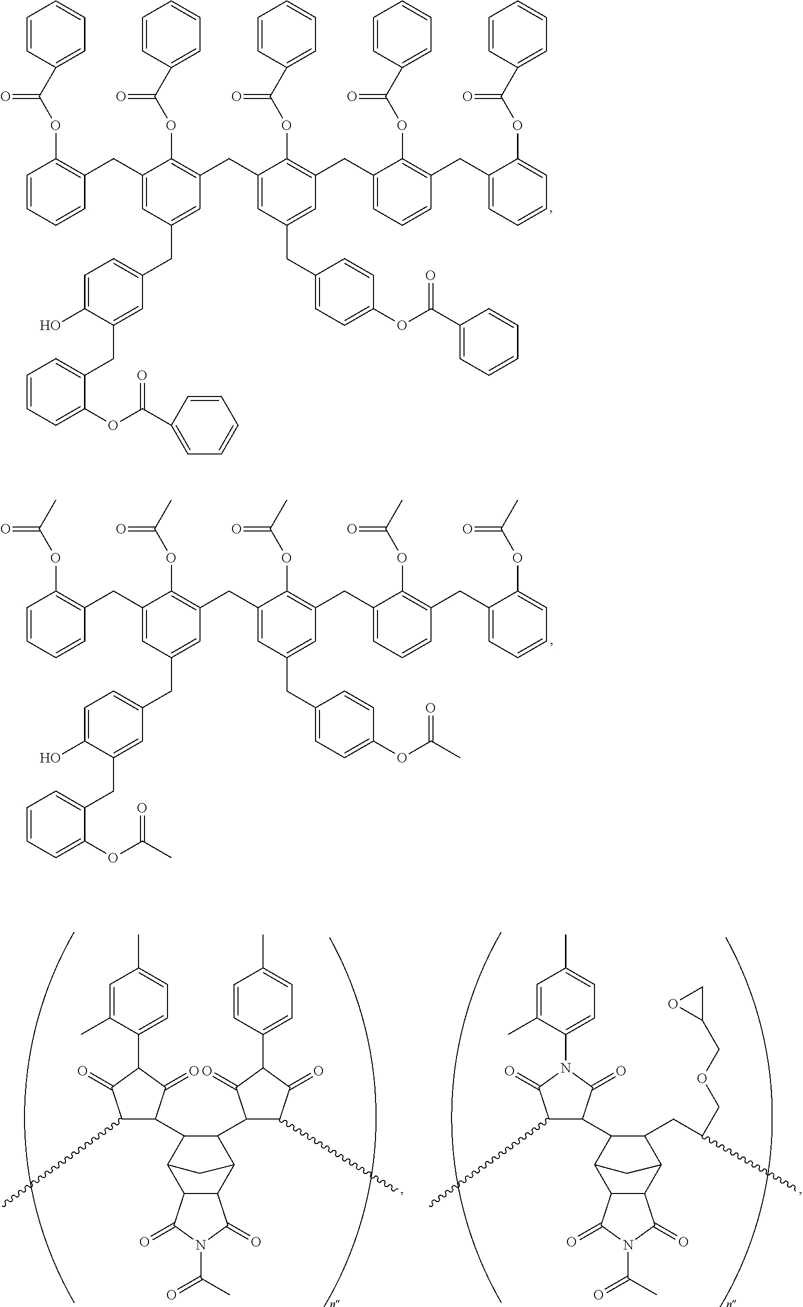 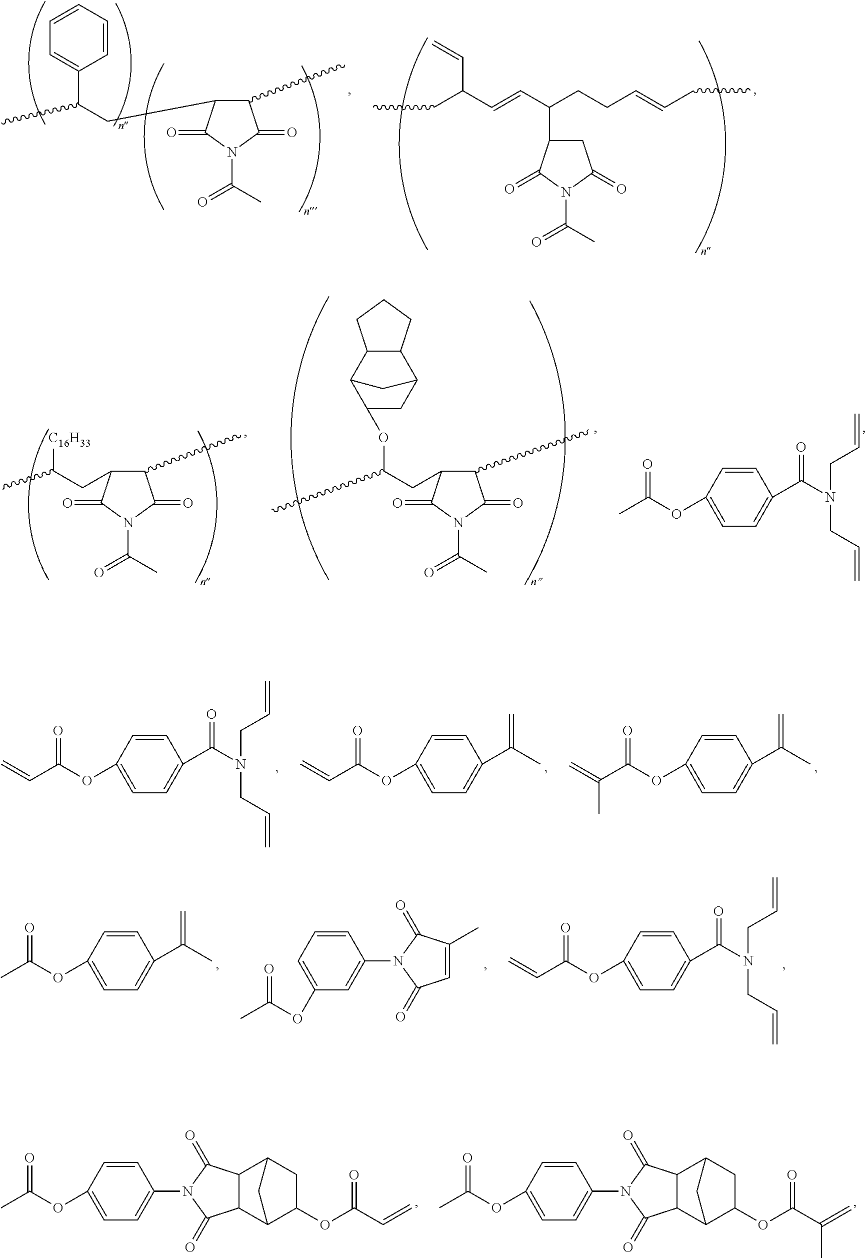 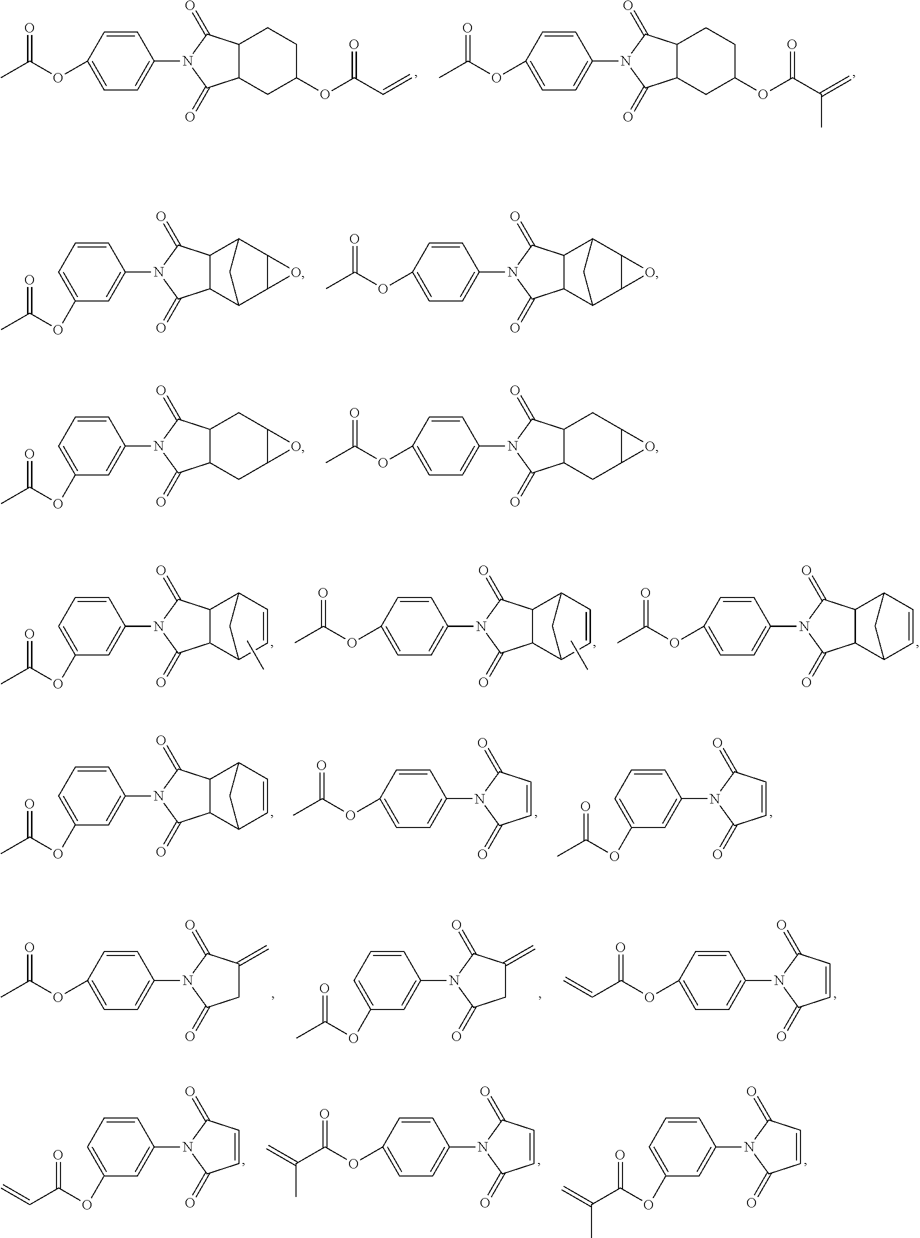 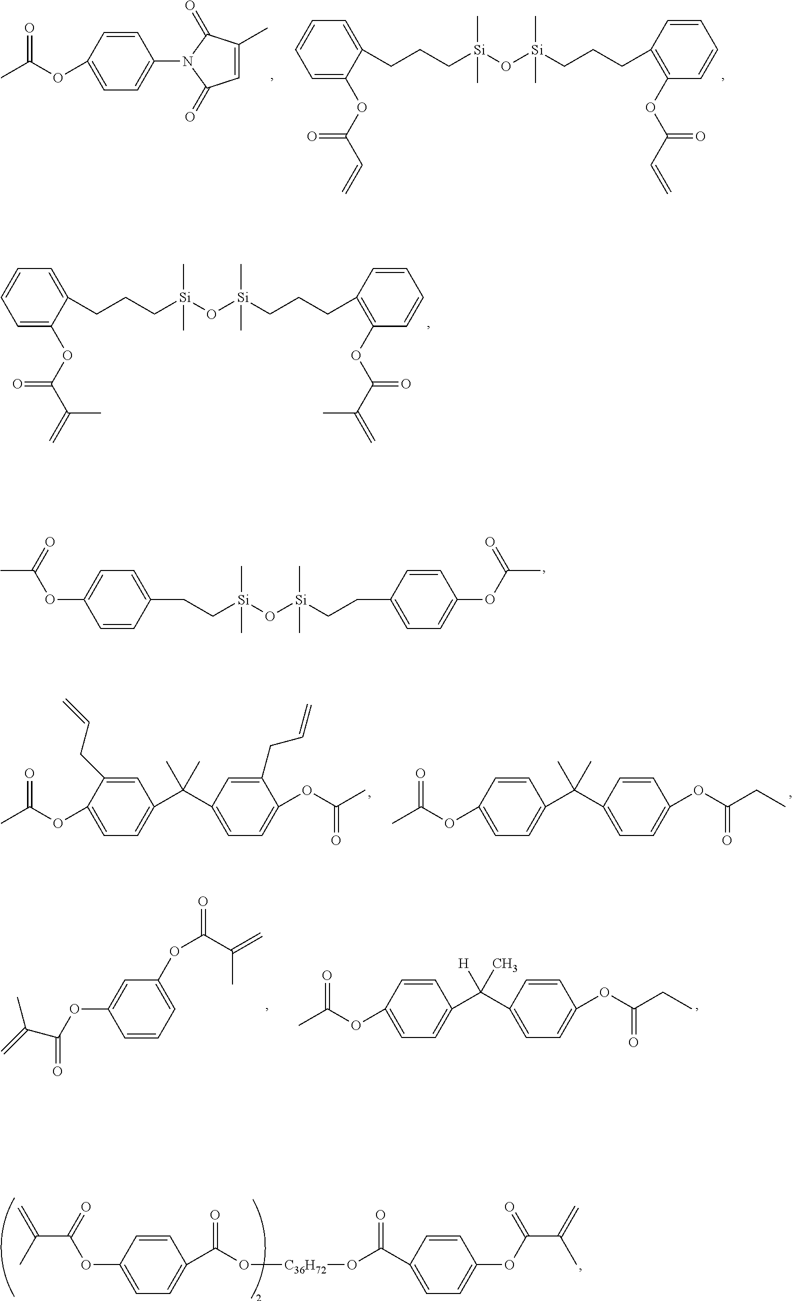 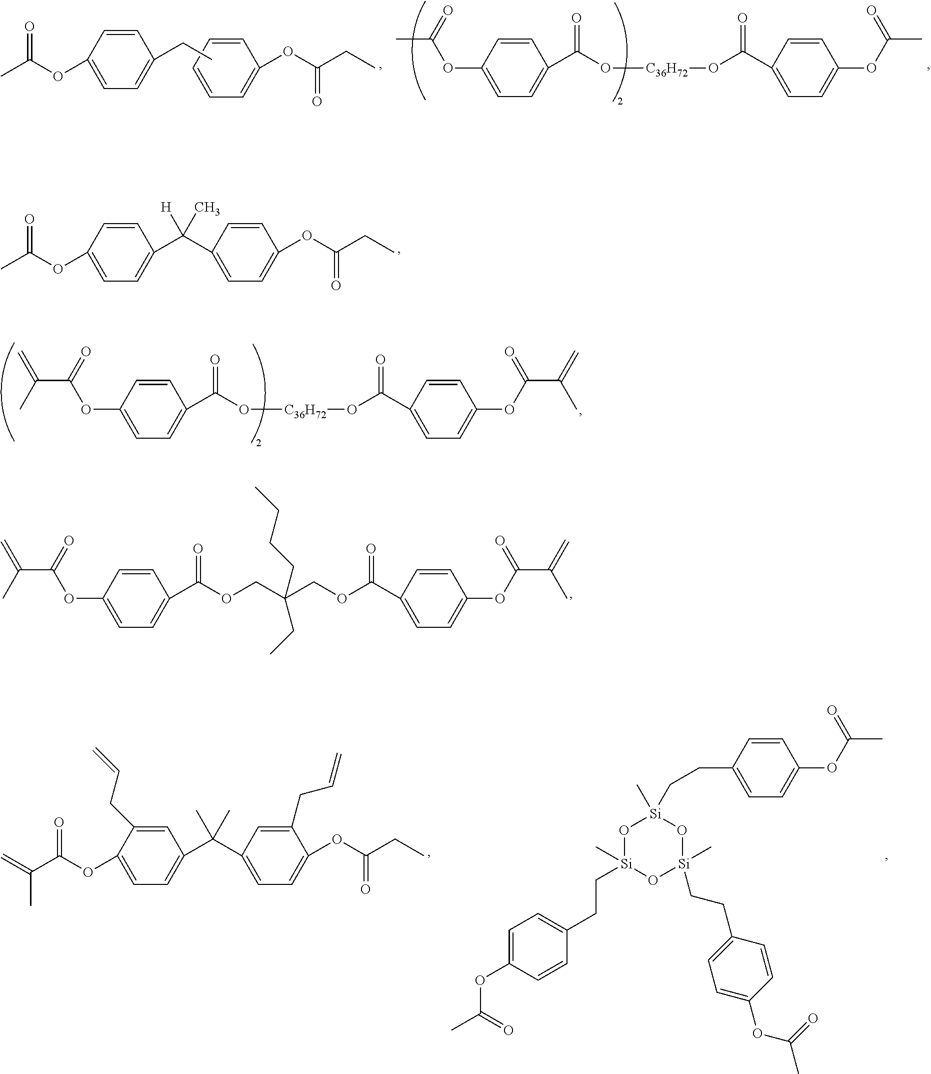 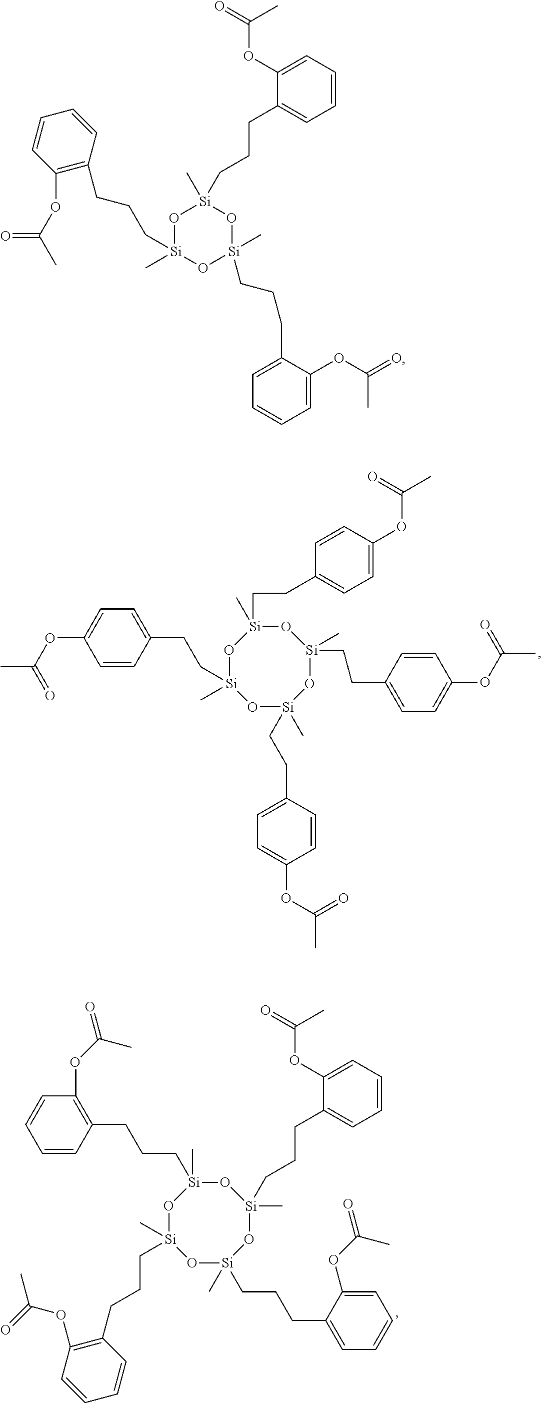 [SMILES: CC(=O)Oc1ccccc1CCC[Si]1(C)O[Si](C)(CCCc2ccccc2OC(C)=O)O[Si](C)(CCCc2ccccc2OC(C)=O)O1 ; CC(=O)Oc1ccc(CC[Si]2(C)O[Si](C)(CCc3ccc(OC(C)=O)cc3)O[Si](C)(CCc3ccc(OC(C)=O)cc3)O[Si](C)(CCc3ccc(OC(C)=O)cc3)O2)cc1 ; CC(=O)Oc1ccccc1CCC[Si]1(C)O[Si](C)(CCCc2ccccc2OC(C)=O)O[Si](C)(CCCc2ccccc2OC(C)=O)O[Si](C)(CCCc2ccccc2OC(C)=O)O1] 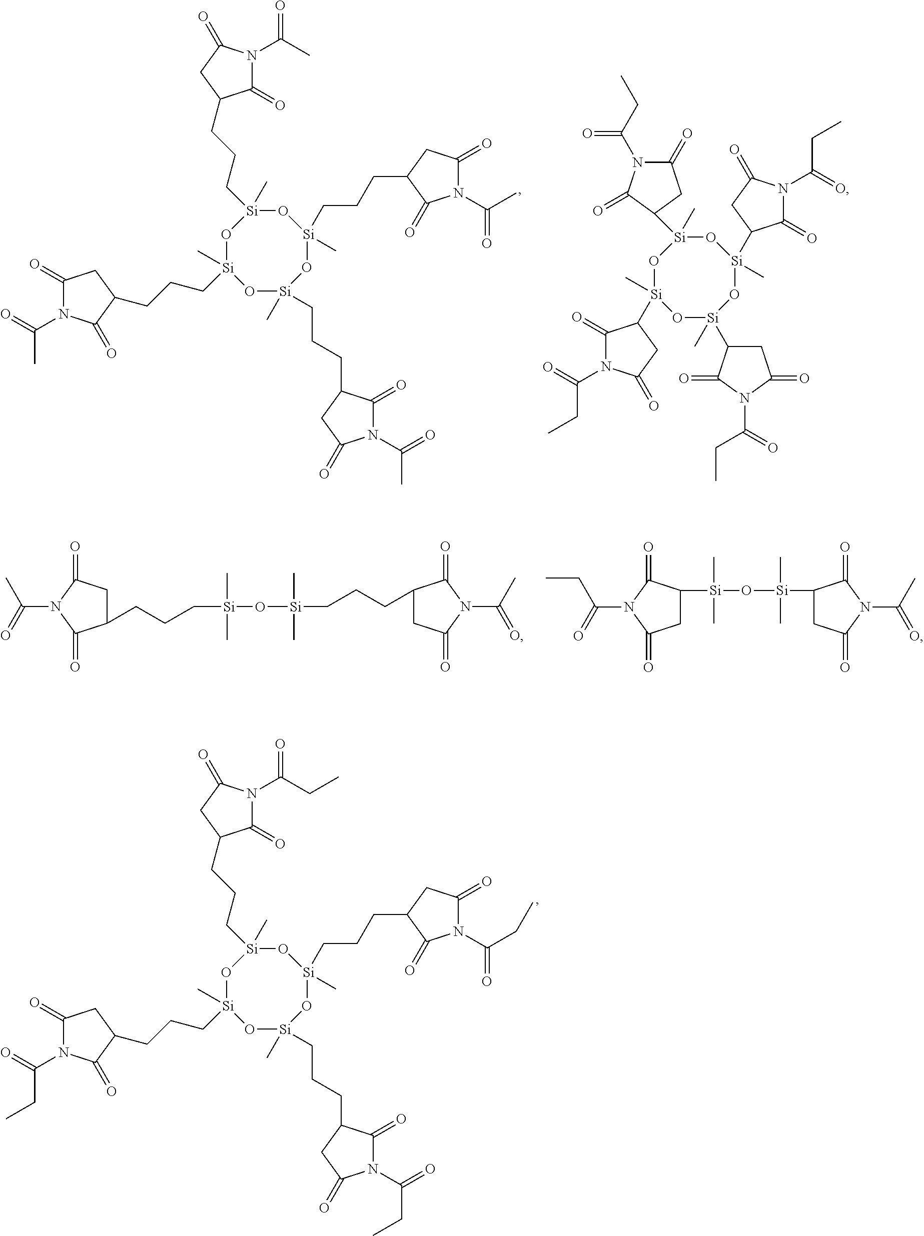 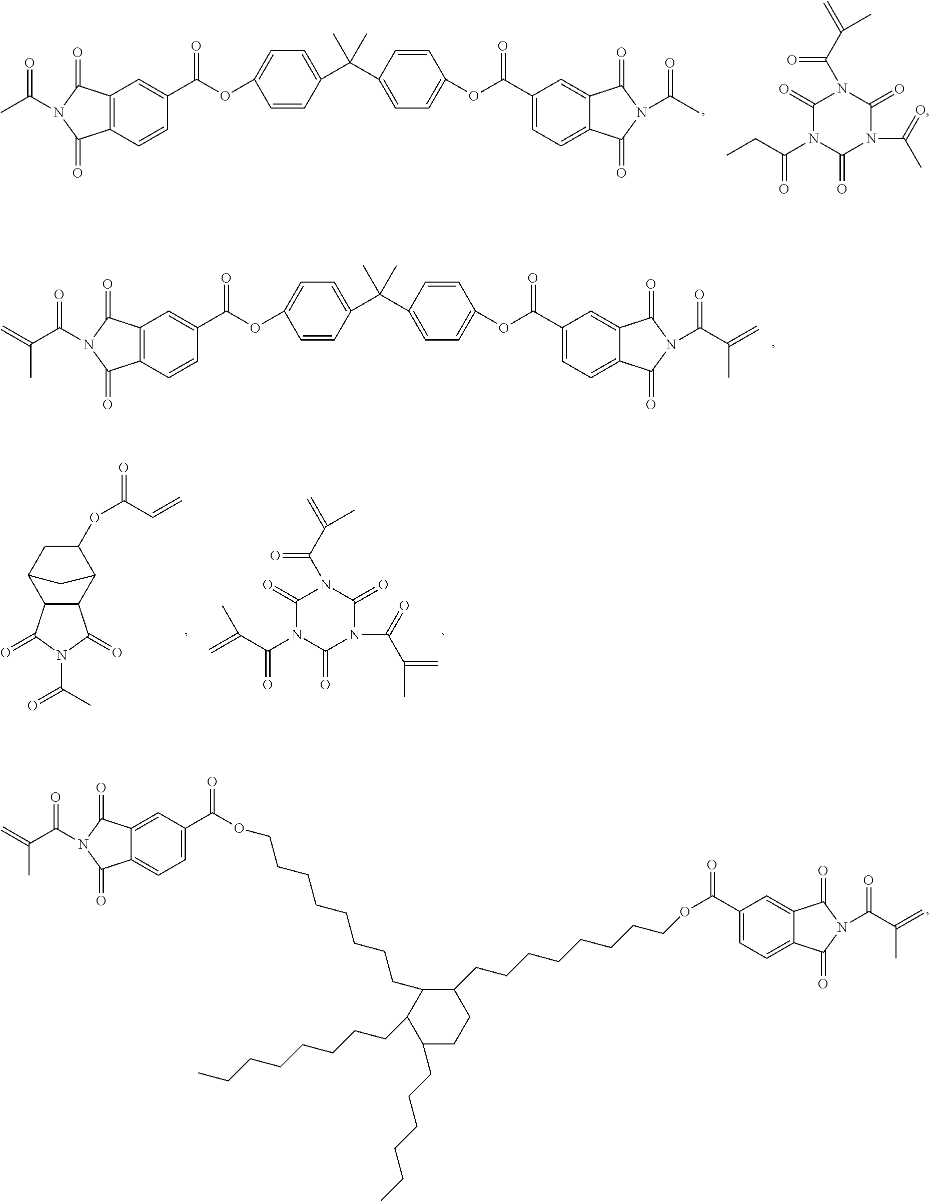 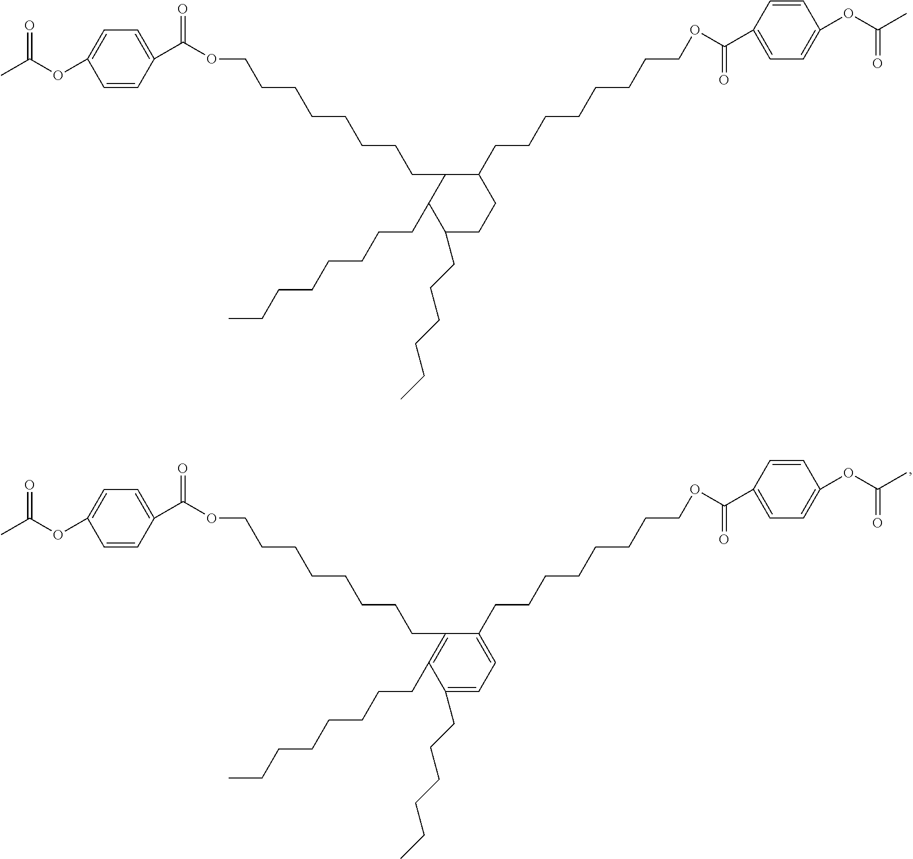 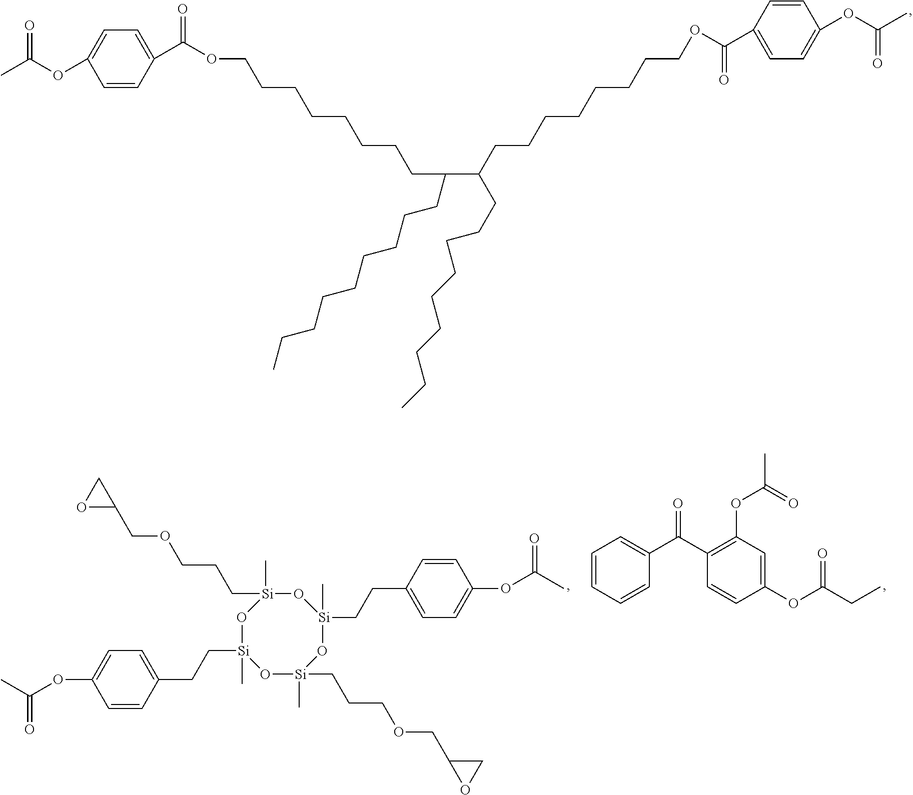 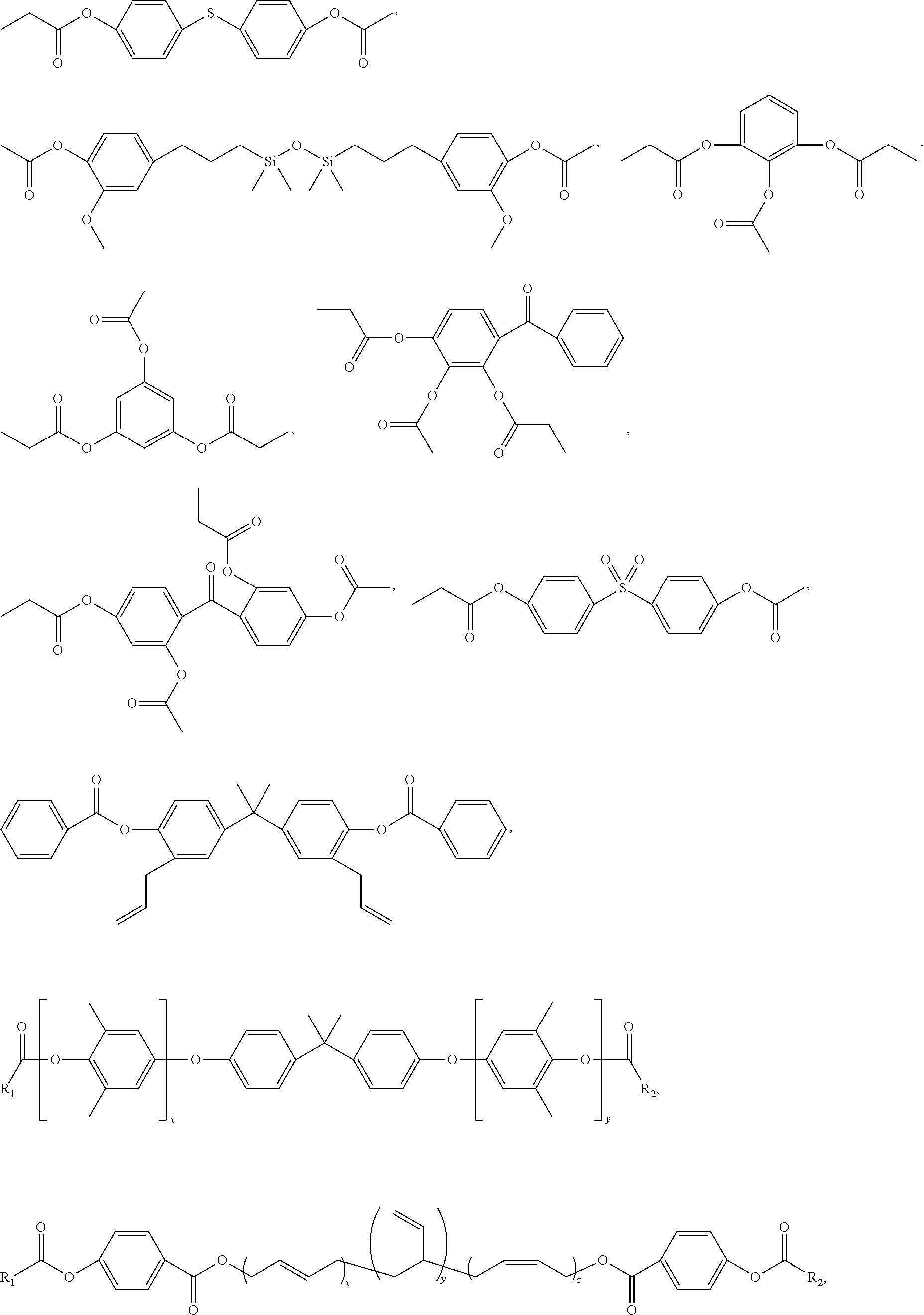 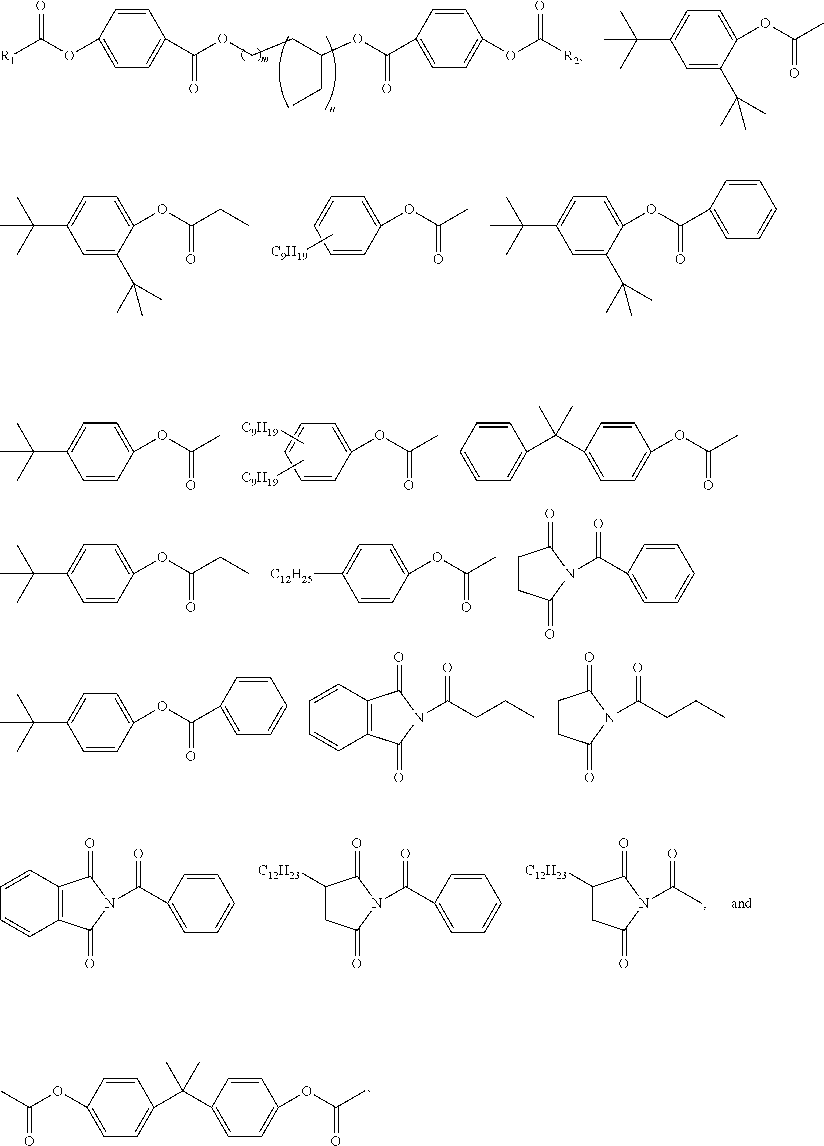
or a combination thereof,
wherein:
each of x, y, z, m and n is an integer;
the sum of x, y and z is equal to, or less than, about 130;
the sum of m and n is equal to, or less than, about 300 and
each of R₁ and R₂ is independently selected from the group consisting of a lower alkyl or a substituted or an unsubstituted aryl
wherein each of n′, x, y and z is an integer, n′ independently having the value between 0 and about 10; each of x and y independently having the value between 4 and about 50; and z independently having the value between 2 and about 40
wherein each n″ and n′″ is an integer independently having the value between 1 and about 10.

12. The composition of claim 10, wherein the epoxy comprises at least one of a glycidyl ether epoxy compound, a cycloaliphatic epoxy compound, or an aliphatic epoxy compound.

13. The composition of claim 12, wherein the glycidyl ether epoxy compound is selected from the group consisting of:
(a) a glycidyl ether of a phenol, an amine, an alcohol, or an isocyanurate;
(b) a trisglycidyl ether of a phenolic compound;
(c) a glycidyl ether of a cresol formaldehyde condensate;
(d) a glycidyl ether of a phenol formaldehyde condensate;
(e) a glycidyl ether of a cresol dicyclopentadiene addition compound;
(f) a glycidyl ether of a phenol dicyclopentadiene addition compound;
(g) a glycidyl ether of a fused ring polyaromatic phenol;
(h) diglycidyl ether;
(i) a glycidyl ether of an aliphatic alcohol;
(j) a glycidyl ether of a polyglycol;
(k) a glycidyl derivative of an aromatic amine; and
an ester linked epoxy compound.

14. The composition of claim 12, wherein the glycidyl ether epoxy compound is selected from the group consisting of:
(a) a phenyl glycidyl ether;
(b) a cresol glycidyl ether;
(c) a nonylphenyl glycidyl ether;
(d) a p-tert-butylphenyl glycidyl ether;
(e) a diglycidyl ether;
(f) a trisglycidyl ether of bisphenol A, bisphenol F, ethylidinebisphenol, dihydroxydiphenyl ether, N,N′-disalicylal-ethylenediamine, triglycidyl-p-aminophenol, N,N,N′,N′-tetraglycidyl-4,4′-diphenylmethane, triglycidyl isocyanurate, bis(4-hydroxyphenyl)sulfone, bis(hydroxyphenyl)sulfide, 1,1-bis(hydroxyphenyl)cyclohexane, 9,19-bis(4-hydroxyphenyl)fluorene, 1,1,1-tris(hydroxyphenyl)ethane, tetrakis(4-hydroxyphenyl)ethane, trihydroxytritylmethane, 4,4′-(1-alpha-methylbenzylidene)bisphenol, 4,4′-(1,3-componentthylethylene)diphenol, componentthylstilbesterol, 4,4′-dihyroxybenzophenone, resorcinol, catechol, or tetrahydroxydiphenyl sulfide;
(g) a glycidyl ether of a dihydroxy naphthalene, 2,2′-dihydroxy-6,6′-dinaphthyl disulfide, or 1,8,9-trihydroxyanthracene;
(h) a diglycidyl ether of 1,4 butanediol;
(i) a diglycidyl ether of diethylene glycol;
(j) a diglycidyl ether of neopentyl glycol; a diglycidyl ether of cyclohexane dimethanol;
(k) a diglycidyl ether of tricyclodecane dimethanol;
(l) a trimethyolethane triglycidyl ether;
(m) a glycidyl ether a trimethyol propane triglycidyl ether;
(n) a glycidyl ether of HELOXY 84™;
(o) a glycidyl ether of HELOXY 32™;
(p) a polyglycidyl ether of castor oil;
(q) polyoxypropylene diglycidyl ether;
(r) HELOXY 71™; and
(s) glycidyl methacrylate.

15. The composition of claim 12, wherein the cycloaliphatic epoxy compound is selected from the group consisting of a cyclohexene oxide, a 3-vinylcyclohexene oxide, vinylcyclohexene dioxide, a dicylcopentadiene dioxide, a tricyclopentadiene dioxide, a tetracyclopentadiene dioxide, a norbornadiene dioxide, a bis(2,3-epoxycyclopentyl)ether, a limonene dioxide, a 3′,4′-epoxycyclohexamethyl-3,4-epoxycyclohexanecarboxylate, a 3′,4′-epoxycyclohexyloxirane, a 2(3′,4′-epoxycyclohexyl)-5,1″-spiro-3″,4″-epoxycyclohexane-1,3-dioxane, and a bis(3,4-epoxycyclohexamethyl) adipate; or the aliphatic epoxy compound is selected from the group consisting of an epoxidized polybutadiene, an epoxidized polyisoprene, an epoxidized poly(1,3-butadiene-acrylonitrile), an epoxized soybean oil, an epoxidized castor oil, a dimethylpentane dioxide, a divinylbenzene dioxide, a butadiene dioxide, and a 1,7-octadiene dioxide.

16. The composition of claim 12, wherein the composition is an adhesive, a coating, a matrix resin or a composite resin.

17. A composition comprising an adhesive of claim 16, wherein the composition is a thermal interface material, die attach adhesive, underfill material or mold compound.

18. The composition of claim 17, wherein the composition further comprises a filler.

19. The composition of claim 16, wherein the matrix resin is an encapsulant, industrial, marine, automotive, airline, aerospace, sporting goods, medical or dental matrix resin.

20. The composition of claim 16, wherein the composite resin further comprises at least one of carbon fiber, fiberglass or silica.

21. The composition of claim 16, wherein the adhesive further comprises at least one compound selected from the group consisting of an acrylate, a methacrylate, a maleimide, a vinyl ether, a vinyl ester, a styrenic compound, an allyl functional compound, a phenol, an anhydride, a benzoxazine, and an oxazoline.

22. A method for decreasing the hydrophilicity of an epoxy resin or an oxetane resin, comprising combining a curative of claim 1 with the epoxy resin or the oxetane resin.

23. A method for adhesively attaching a first article to second article comprising the steps of
(a) applying the adhesive composition of claim 10 to the first article, the second article or both the first and second articles;
(b) contacting the first article and the second article, where the first article and the second article are separated only by the adhesive composition applied in step a); and
(c) curing the adhesive composition applied in step a), thereby adhesively attaching the first article to the second article.

24. A method for curing an epoxy or oxetane comprising combining the epoxy or oxetane with at least one curative having the structure of Formula I or Formula II: 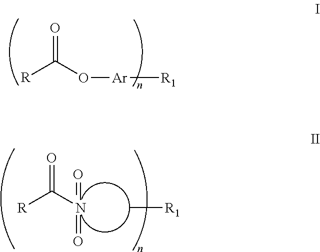
wherein each of R and R₁ is, independently, selected from the group consisting of a substituted or an unsubstituted aliphatic, heteroaliphatic, aromatic, heteroaromatic, siloxane, maleimido, and cinnamyl moieties;
Ar is selected from the group consisting of a substituted or an unsubstituted aryl or heteroaryl having between 6 and about 20 carbon atoms; and
n is an integer having the value between 1 and about 11.

25. The method of claim 24, wherein the at least one curative is selected from the group consisting of: 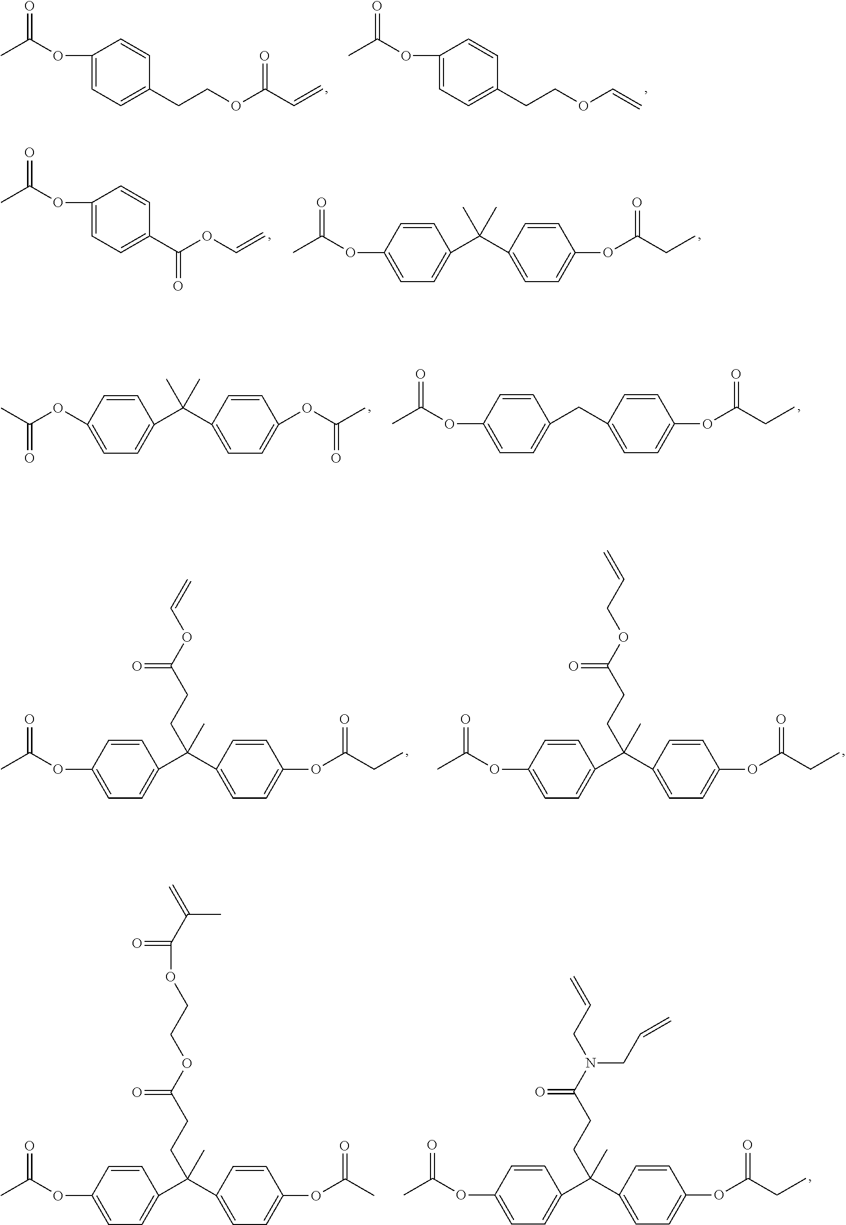 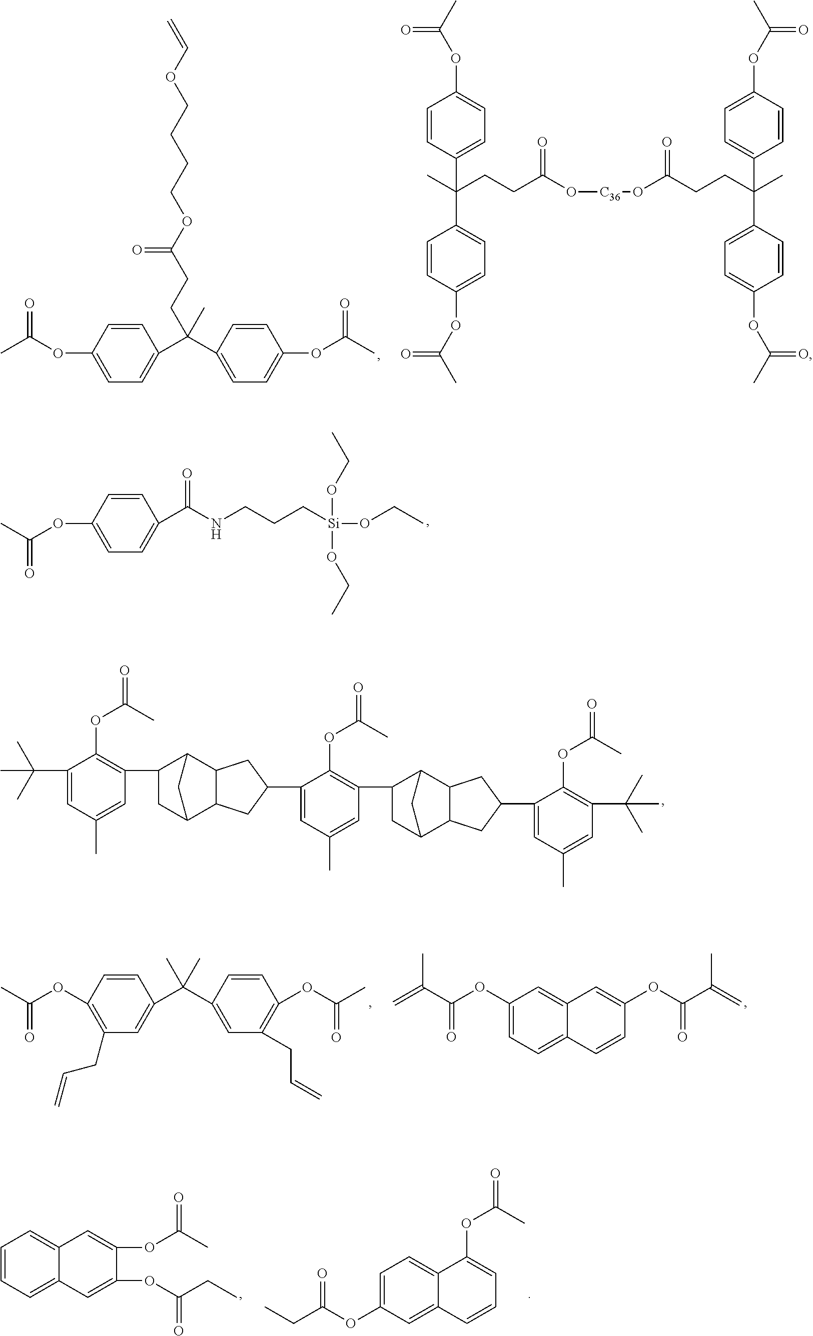 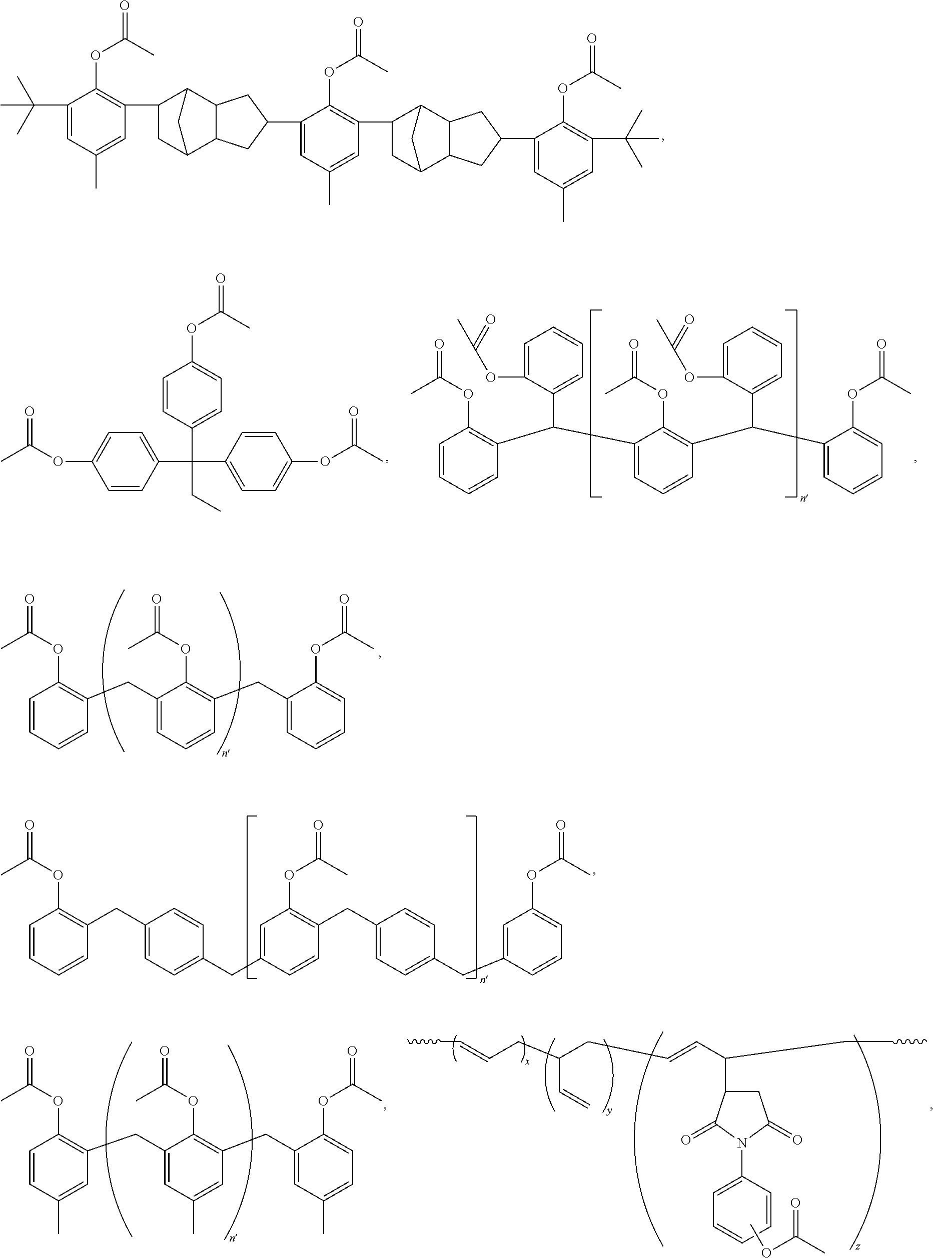 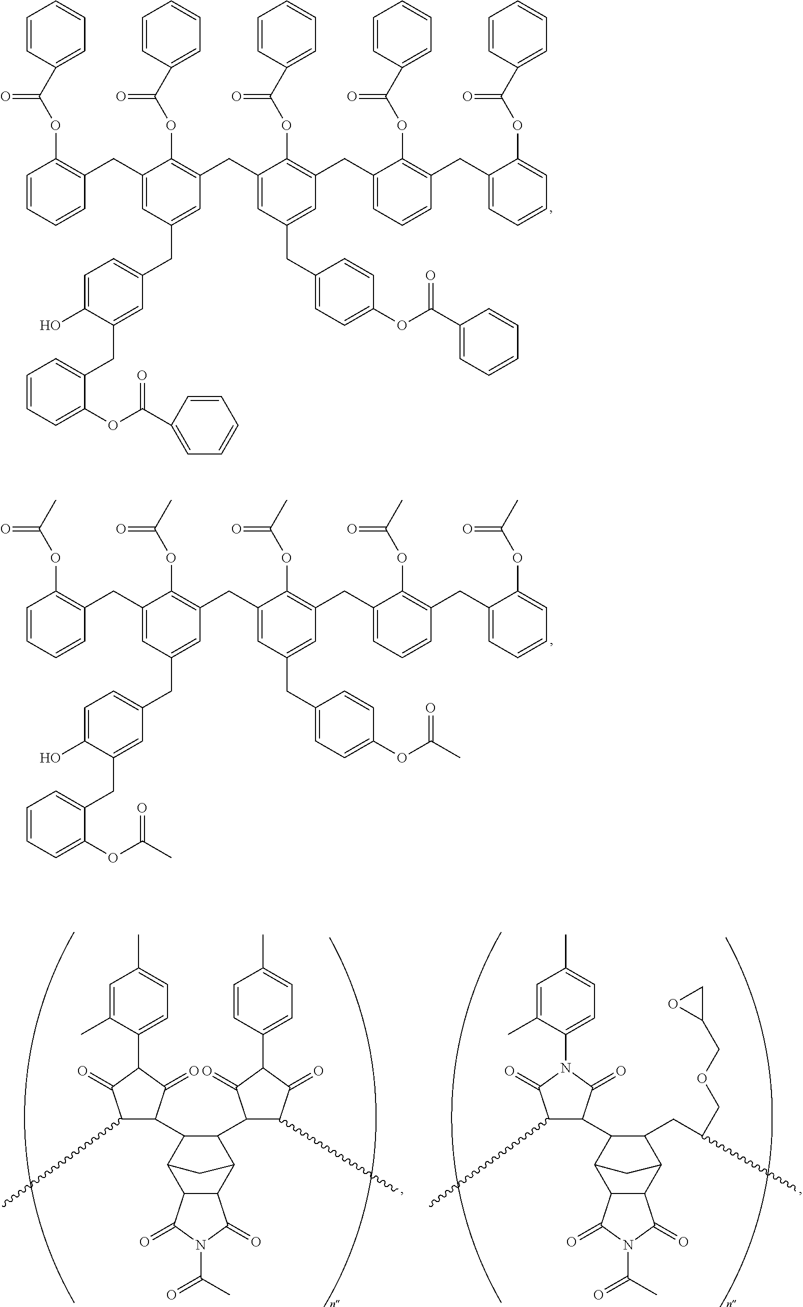 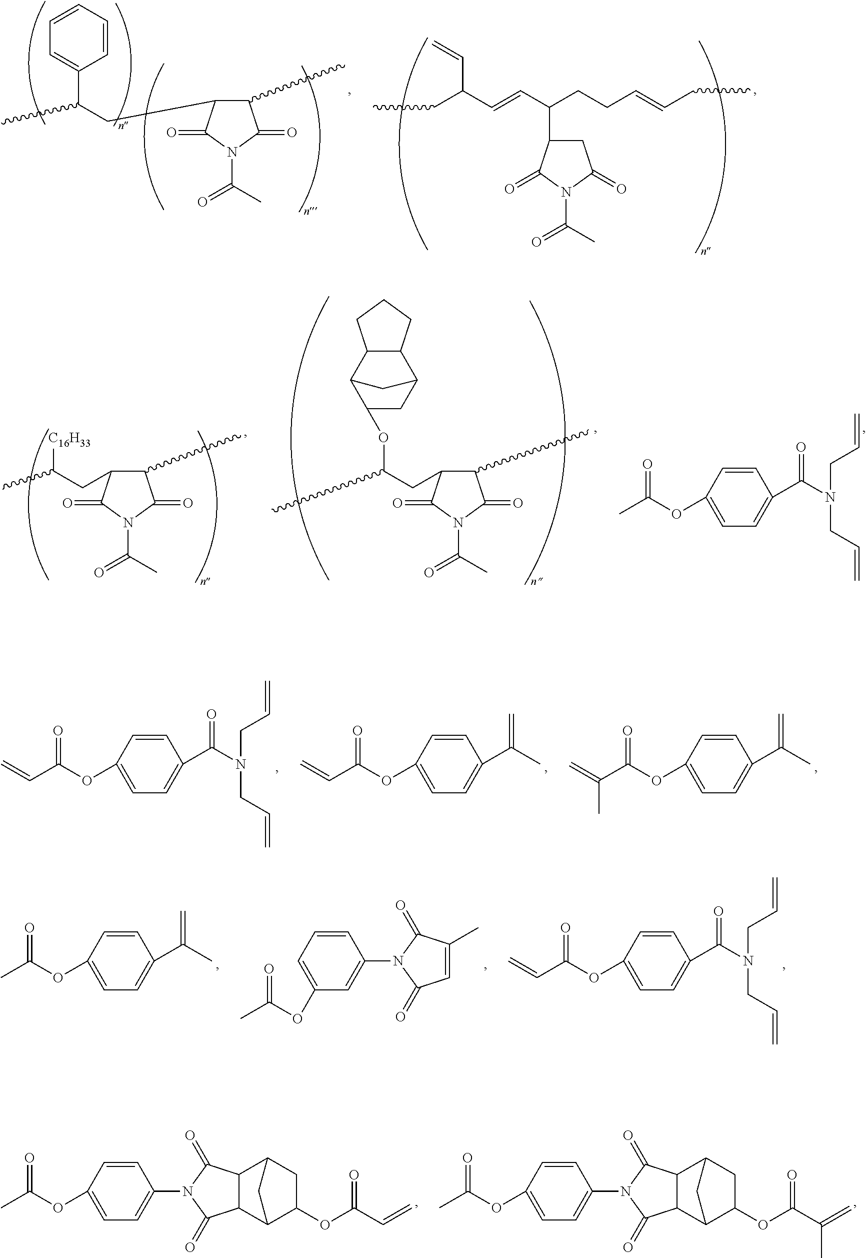 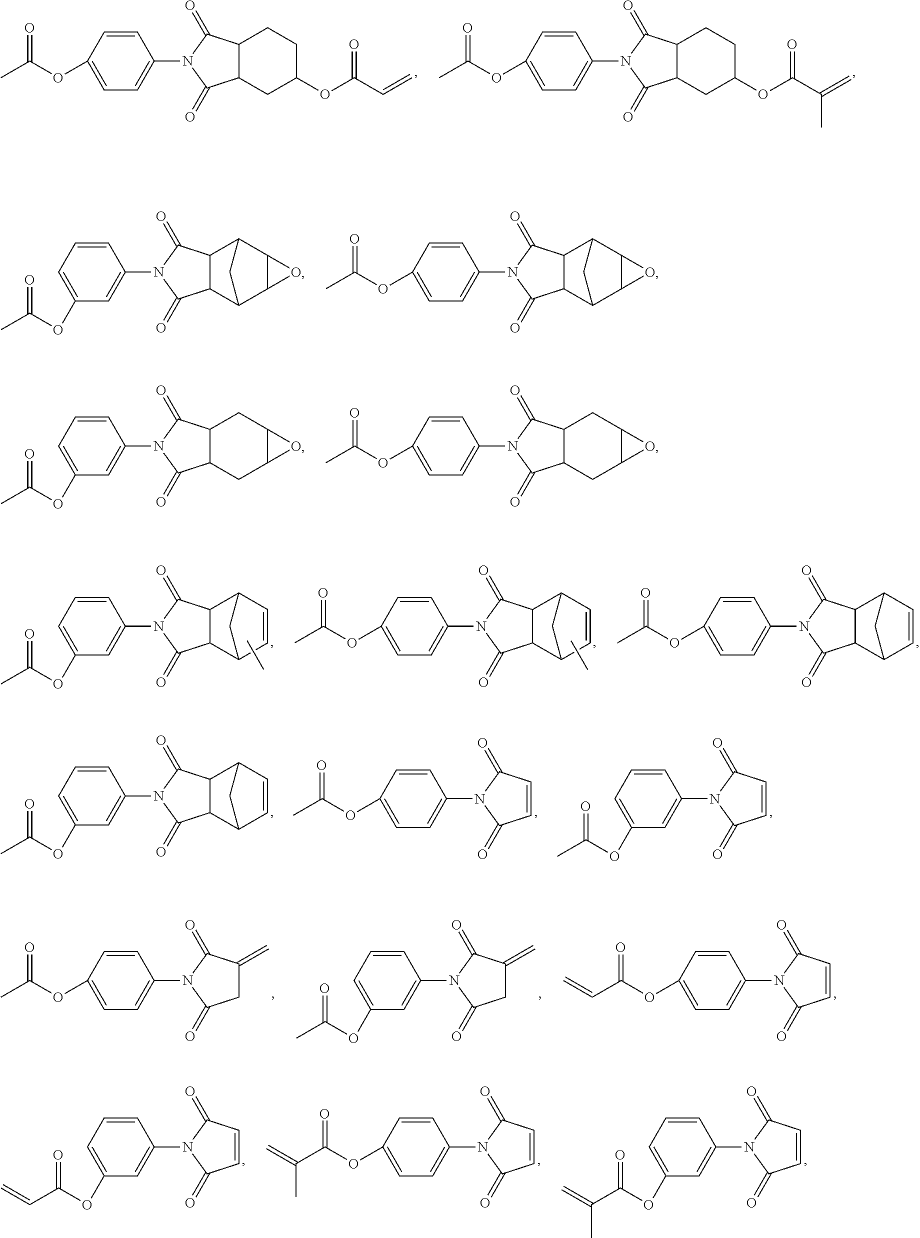 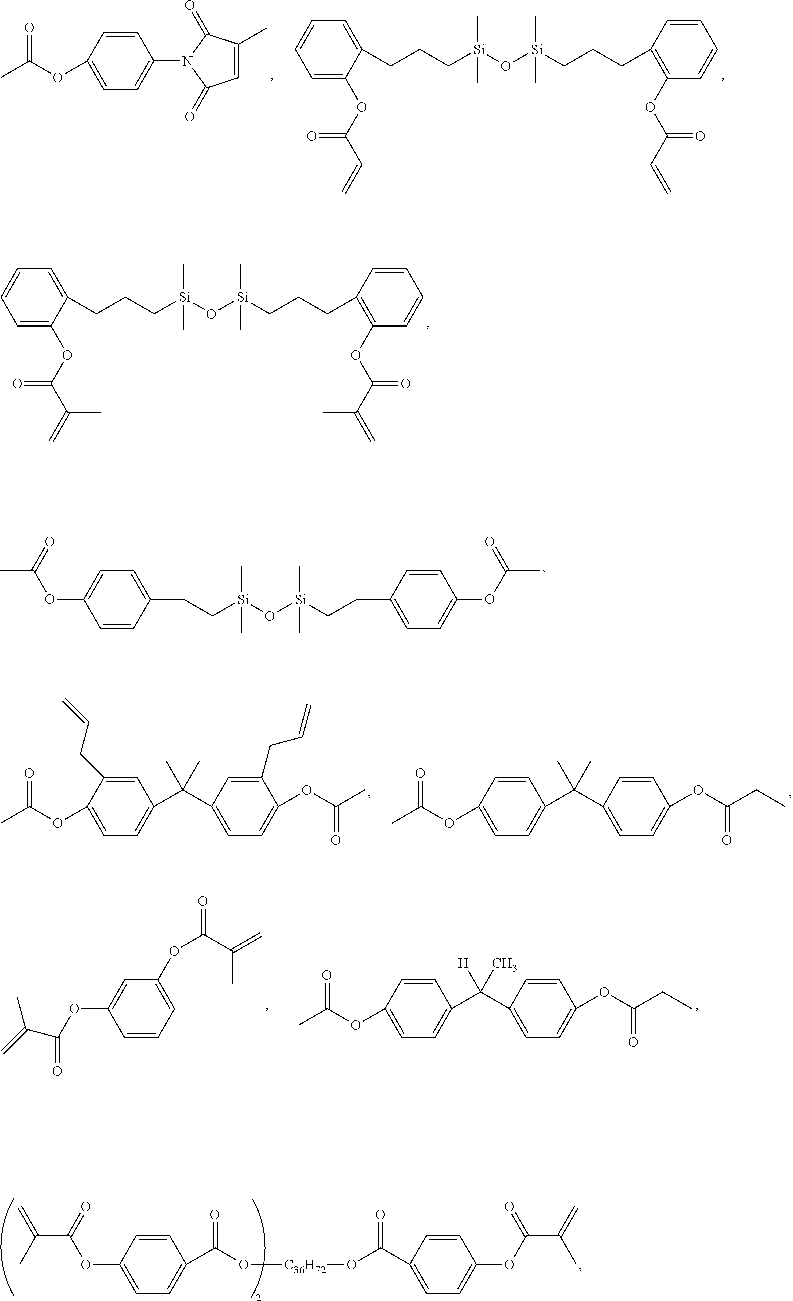 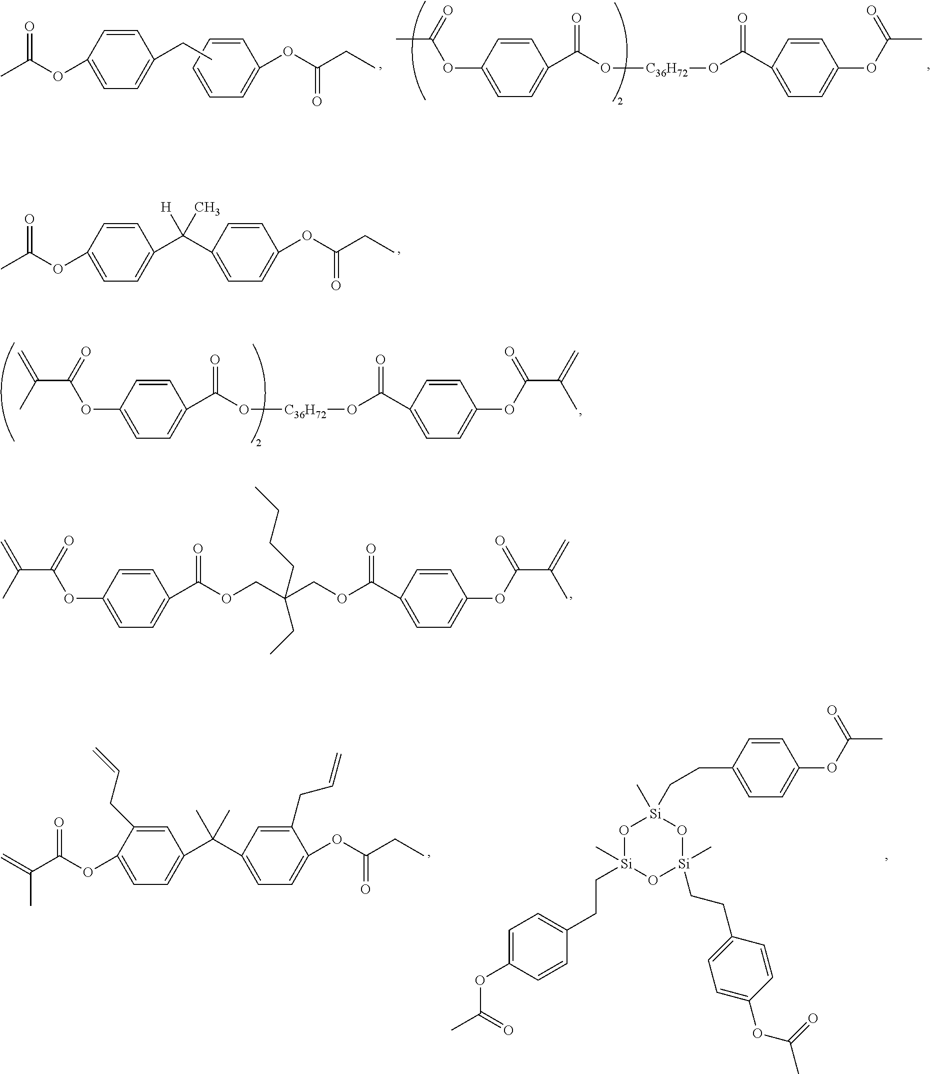 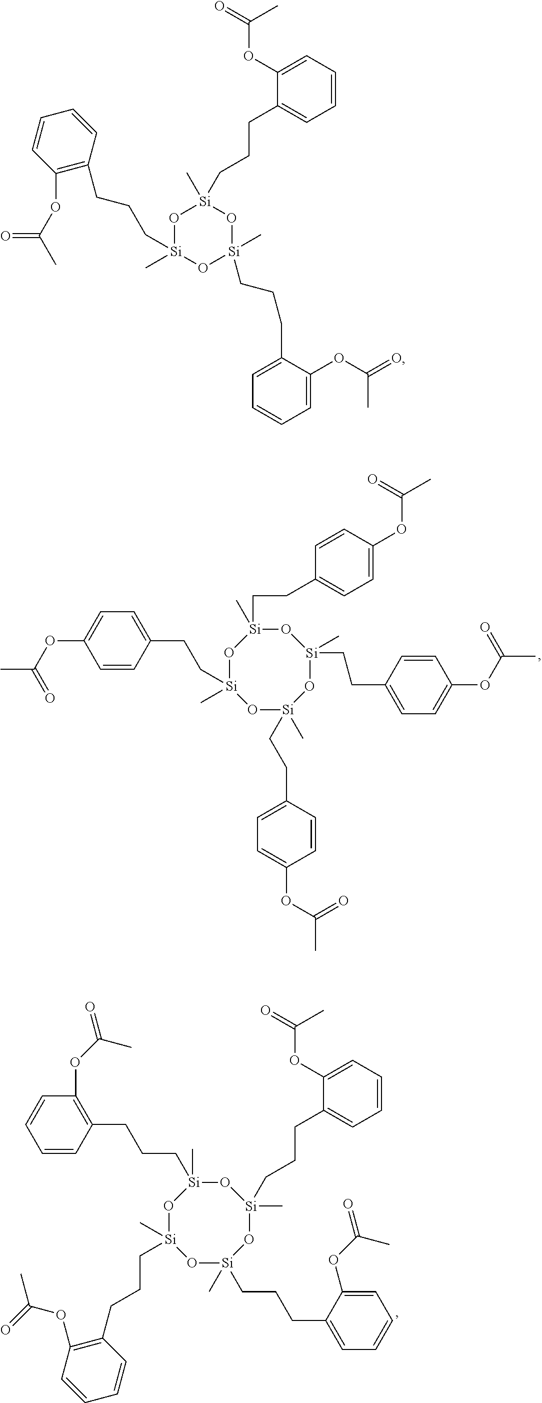 [SMILES: CC(=O)Oc1ccccc1CCC[Si]1(C)O[Si](C)(CCCc2ccccc2OC(C)=O)O[Si](C)(CCCc2ccccc2OC(C)=O)O1 ; CC(=O)Oc1ccc(CC[Si]2(C)O[Si](C)(CCc3ccc(OC(C)=O)cc3)O[Si](C)(CCc3ccc(OC(C)=O)cc3)O[Si](C)(CCc3ccc(OC(C)=O)cc3)O2)cc1 ; CC(=O)Oc1ccccc1CCC[Si]1(C)O[Si](C)(CCCc2ccccc2OC(C)=O)O[Si](C)(CCCc2ccccc2OC(C)=O)O[Si](C)(CCCc2ccccc2OC(C)=O)O1] 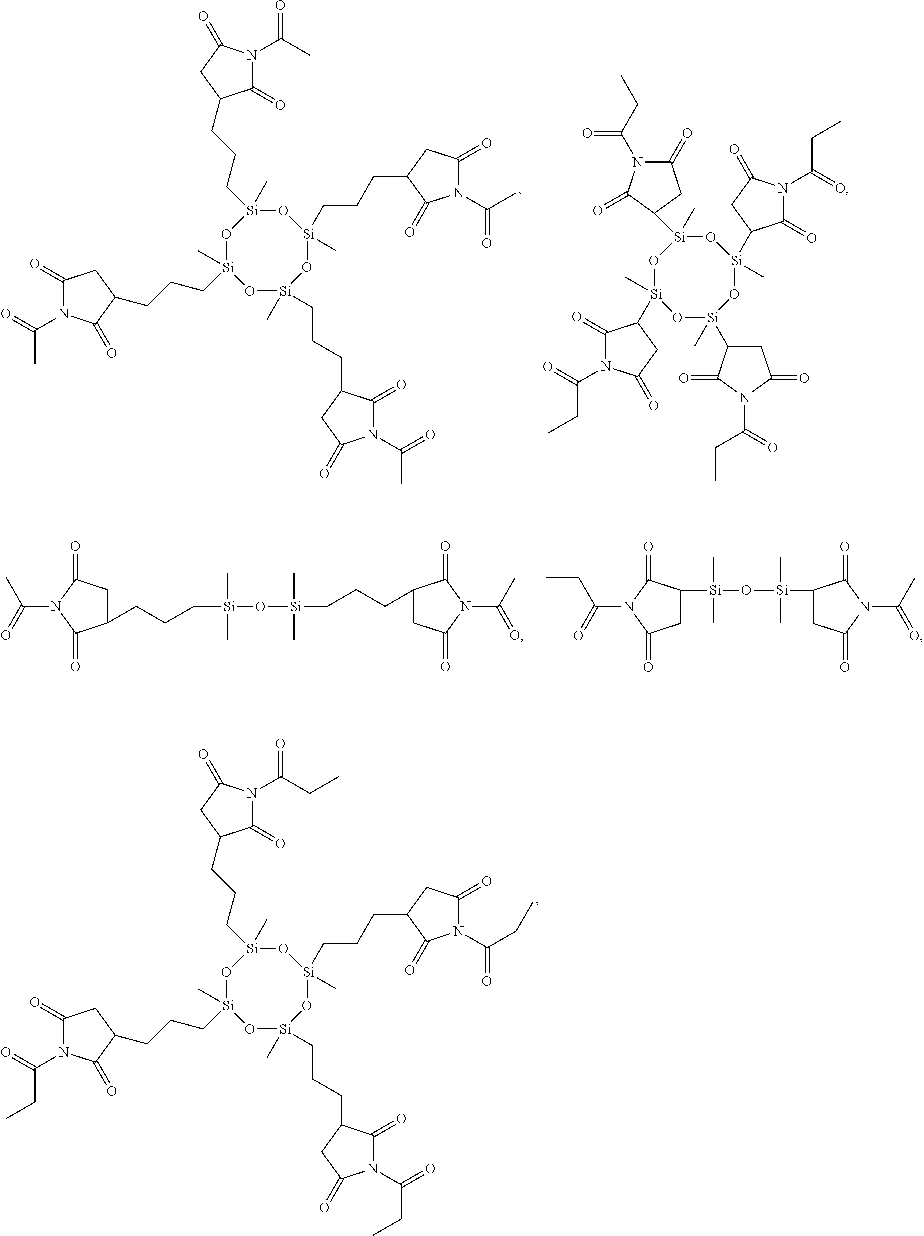 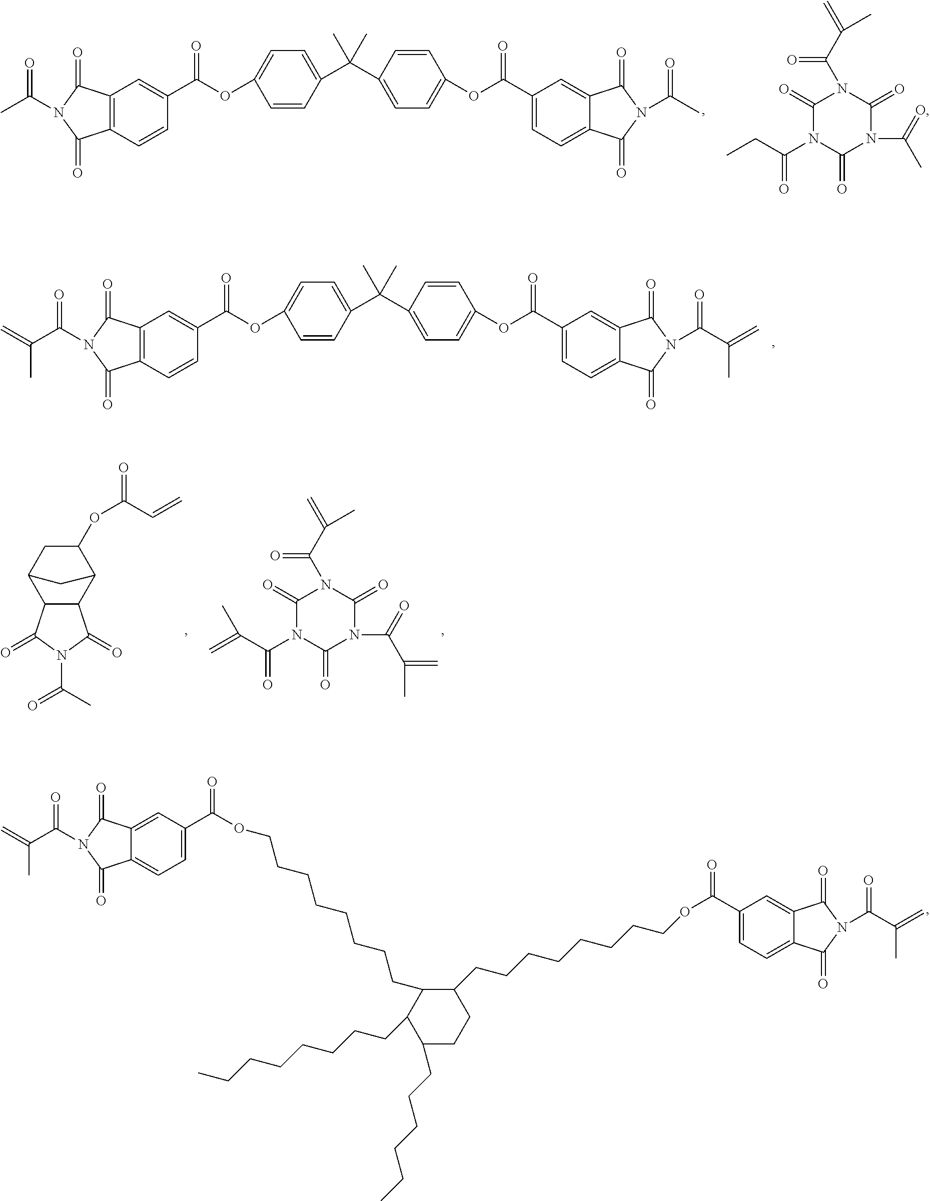 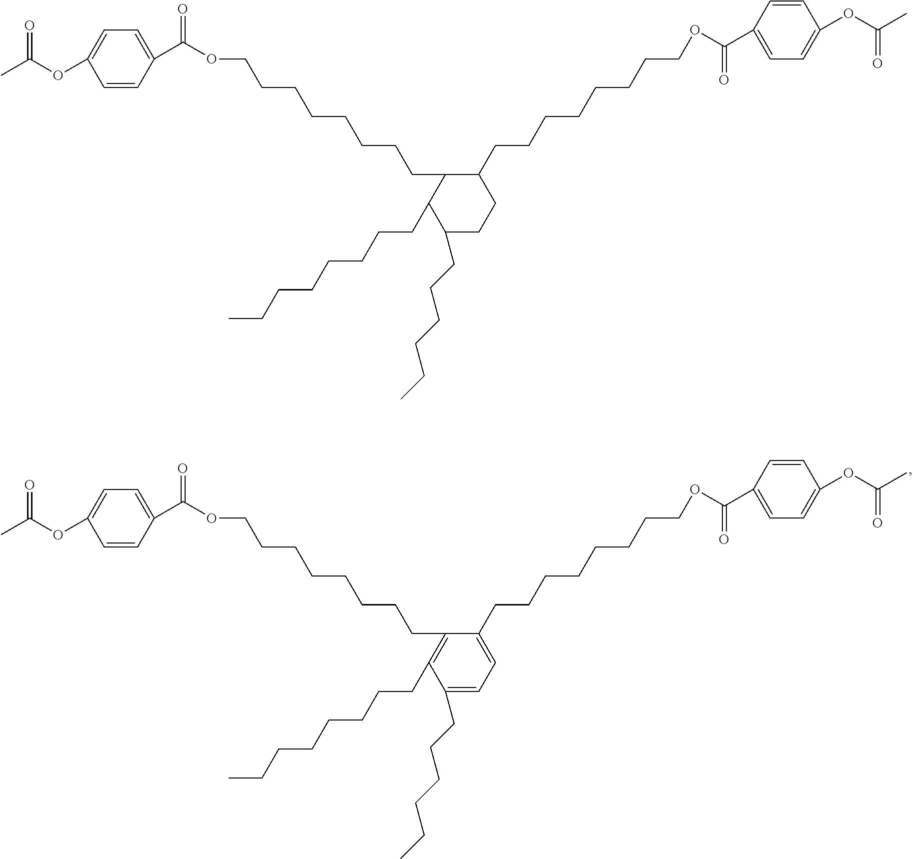 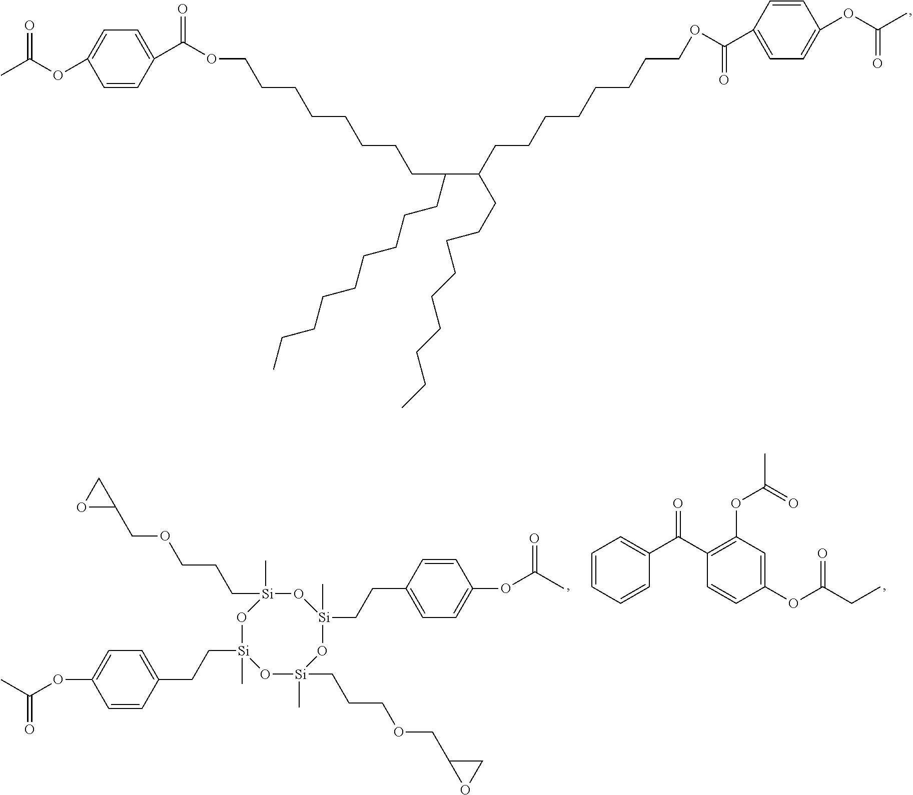 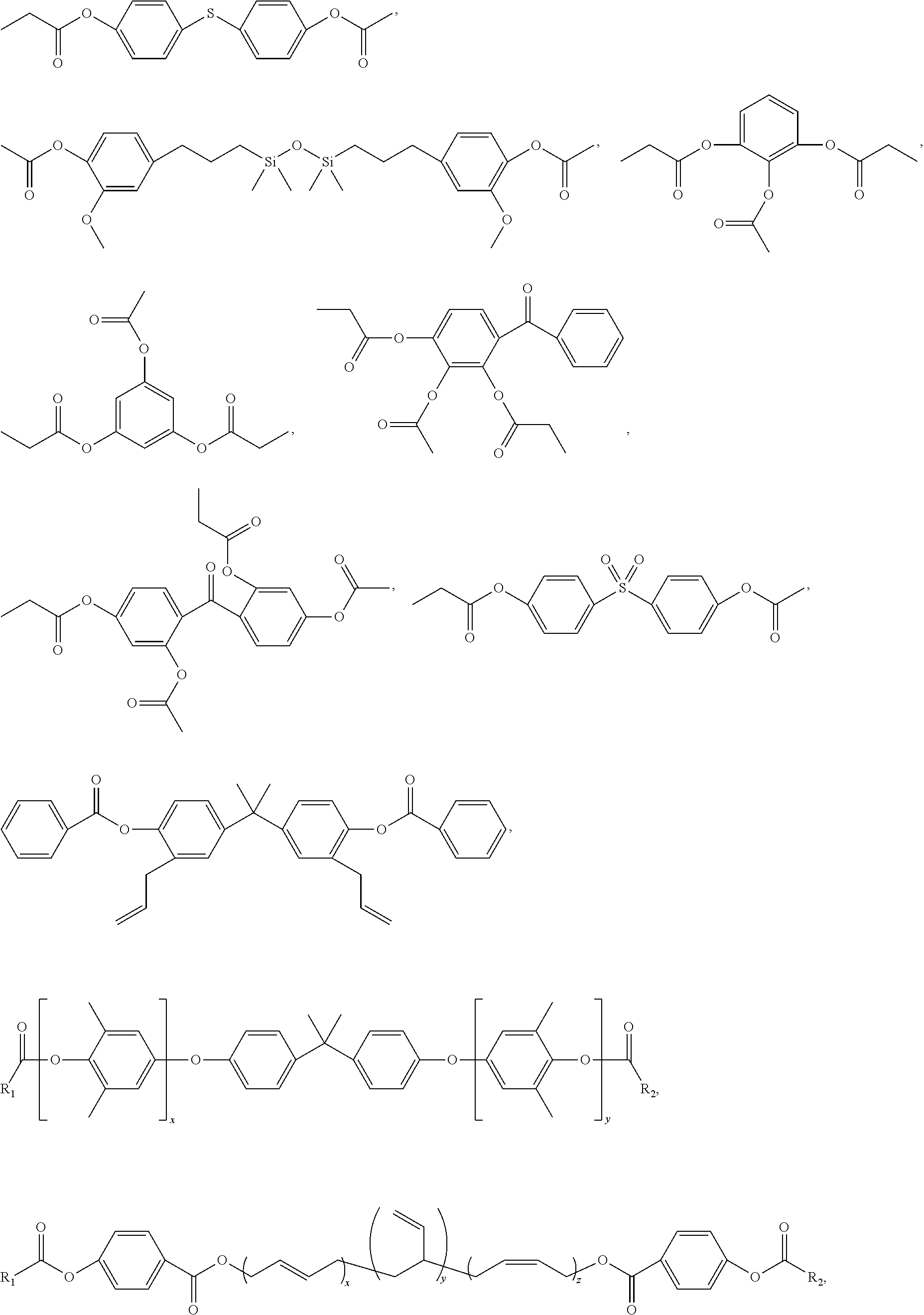 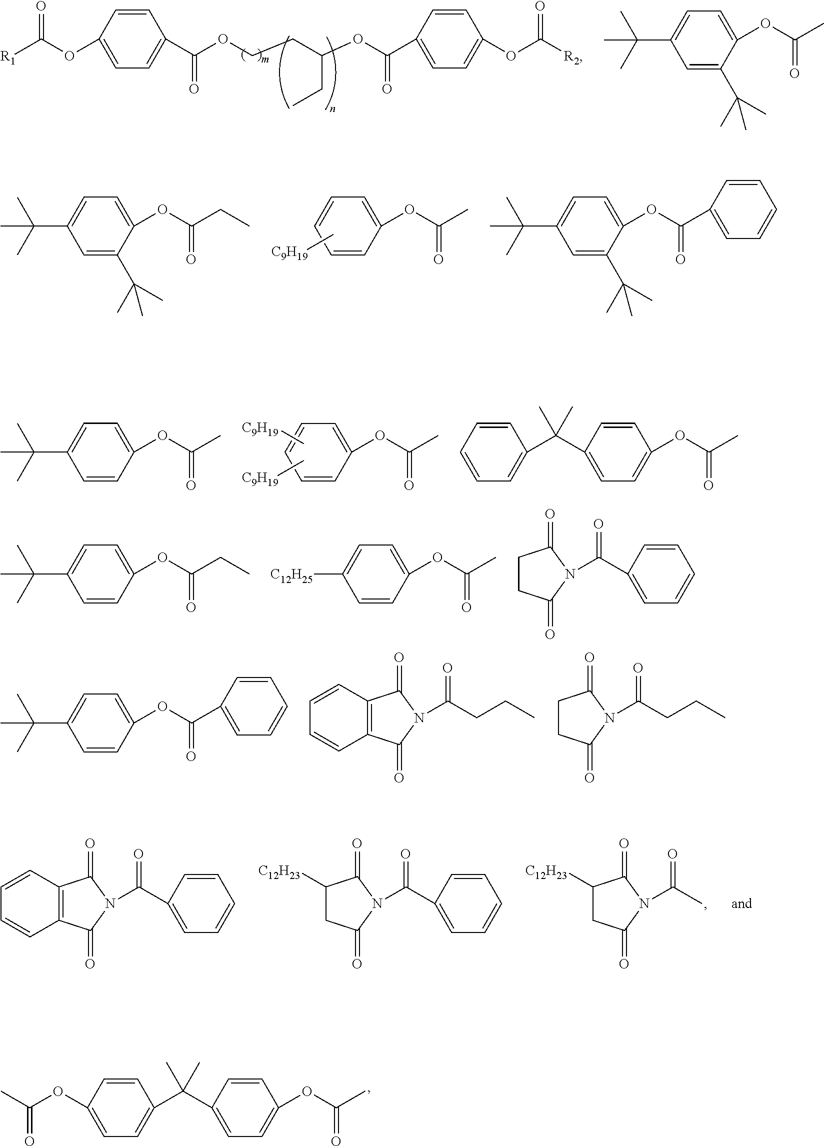
or a combination thereof,
wherein:
each of x, y, z, m and n is an integer;
the sum of x, y and z is equal to, or less than, about 130;
the sum of m and n is equal to, or less than, about 300 and
each of R₁ and R₂ is independently selected from the group consisting of a lower alkyl or a substituted or an unsubstituted aryl
wherein each of n′, x, y and z is an integer, n′ independently having the value between 0 and about 10; each of x and y independently having the value between 4 and about 50; and z independently having the value between 2 and about 40
wherein each n″ and n′″ is an integer independently having the value between 1 and about 10.
